(19) United States
(12) Patent Application Publication
(10) Pub. No.: US 2026/0199902 A1
(43) Pub. Date: Jul. 16, 2026

(54) SYSTEM AND APPARATUS FOR THE HAND-HELD AMPLIFICATION AND DETECTION OF NUCLEIC ACIDS

(71) Applicant: Darwin Biosciences, Inc., Boulder, CO (US)

(72) Inventors: Nicholas R. Meyerson, Boulder, CO (US); Amy B. Emerman, Boulder, CO (US); Philip D. Fox, Boulder, CO (US); Joshua R. Dye, Boulder, CO (US); Stephen K. Clark, Boulder, CO (US); Rebecca L. Blackwood, Boulder, CO (US); Andrew F. Charlton, San Diego, CA (US); David E. Charlton, San Diego, CA (US); Hong Law, San Diego, CA (US); Jon E. Avila, San Diego, CA (US); Robert E. Klepper, San Diego, CA (US)

(21) Appl. No.: 19/136,845

(22) PCT Filed: Dec. 6, 2023
(86) PCT No.: PCT/US2023/082792

§ 371 Date: Jun. 6, 2025

Related U.S. Application Data
(60) Provisional application No. 63/430,631, filed on Dec. 6, 2022.

(51) Int. Cl. B01L 7/00; B01L 3/00

(52) U.S. Cl. CPC B01L 7/52; B01L 3/5023; B01L 2200/0631; B01L 2200/0689; B01L 2200/10; B01L 2200/16; B01L 2300/0825; B01L 2300/1855

(57) ABSTRACT

The present invention is directed to novel systems, methods, and apparatus for a non-powered, point-of-need diagnostic device for early detection and amplification of nucleic acids in a sample.

### CROSS-REFERENCE TO RELATED APPLICATIONS

This International PCT application claims the benefit of and priority to U.S. Provisional Application No. 63/430,631, filed Dec. 6, 2022, the specification, claims and drawings of which are incorporated herein by reference in their entirety.

### TECHNICAL FIELD

The present invention is directed to the field of diagnostic devices, and in particular systems, methods, and apparatus directed to a novel non-powered, handheld device for amplification and detection of nucleic acids. In one preferred embodiment, the invention includes systems, methods, and apparatus directed to a novel non-powered, handheld device for early pathogen-agnostic detection of infectious disease.

### BACKGROUND

Early detection of pathogenic infection is vital for proper treatment and positive clinical outcomes. However, infected individuals may remain asymptomatic for several days post-infection while actively transmitting the pathogen to others. Traditional pathogen detection systems are often not effective at detecting the infection until after the onset of symptoms. Traditional pathogen testing includes serology or antibody-based tests, bacterial/viral/fungal growth cultures, and nucleic acid-based detection such as PCR (polymerase chain reaction). Such traditional tests are often time and labor intensive and are only effective after a patient has begun to show symptoms of the infection. Additionally, traditional diagnostic tests require clinical suspicion for a specific pathogen, expensive laboratory equipment, trained personnel, and have increased upstream and end-user costs.

For example, in a typical infection course exposure to an unknown pathogen occurs at day zero and then progresses through subsequent clinical stages of infection. As the pathogen replicates within the infected person, standard diagnostic tests are typically designed to work after the onset of symptoms, when people know there is something wrong and seek healthcare and diagnosis. However, at that point the person may have been contagious to others for days or even weeks. The opportunity to implement early quarantine and limit destructive downstream effects of unimpeded pathogen transmission has passed. This time delay to diagnosis can result in poorer patient outcomes and ongoing disease transmission before patients know they are contagious.

As opposed to the specialized, and later developing adaptive immune response, a host's first line of defense against pathogenic microorganisms is the “innate immune” response. The body's innate immunity is a self-amplifying and non-specific physiological response that occurs within hours of infection. As such, the ability to detect the presence of molecules produced by a host's innate immune response may provide the ability to rapidly detect infection at the earliest stages while a patient is still asymptomatic. Such advancement would allow for more effective quarantine protocols, as well as improved treatment and clinical outcomes. As such, there exists a long-felt need for a diagnostic device for early pathogen-agnostic detection of infectious disease. As described below, the diagnostic device of the invention is adapted to detect RNA biomarkers that are upregulated in biological samples, such as saliva, upon exposure to a pathogen to provide early, pathogen-agnostic identification of infected individuals.

Additionally, detection of nucleic acids in other samples, such as environmental and pharmaceutical samples can have both clinical as well as industrial importance. However, again the time and expense required to retrieve, transport and process samples can be prohibitive. As a result, there is a need for a simple, inexpensive, portable, and technically reliable device for the amplification and detection and nucleic acids.

### SUMMARY OF THE INVENTION

The inventive technology described herein the inventive technology may include systems, methods and compositions for the amplification and detection of nucleic acids in a sample. In a preferred embodiment, the sample of the invention may include an environmental, biological or pharmaceutical sample containing a quantity of nucleic acids. In another preferred embodiment, the invention include novel systems, methods and compositions for the amplification and detection of nucleic acids in a sample using amplification pad, seeded with reagents, and preferably lyophilized reagents, necessary for amplification of nucleic acids, such as DNA or RNA.

In other embodiments, the detection of nucleic acids includes the detection of nucleic acids containing somatic or genetic variant, nucleic acids that have been exposed to radiation and/or exhibit radiation induced mutations/damage, detection of bacterial or viral pathogen nucleic acids in a sample, detection of nucleic acids that include genetic biomarkers, variants, or mutations indicative of a disease state or a predisposition to a disease state, detection of nucleic acids from an environmental sample, and detection of nucleic acids from an agriculture or plant sample.

In a preferred aspect, the amplification products produced by an amplification pad of the invention may be in fluid communication with an assay, such as a lateral strip assay. In this embodiment, the sample may include a liquid sample that provides sufficient capillary action through the device, and amplification pad to transmit the amplification products produced in the pad to the assay portion of the device.

In a preferred aspect, the invention includes a nucleic acid amplification device. In a preferred aspect, the device of the invention includes a collection handle configured to collect a sample containing a nucleic acid, a sample processing assembly in fluid communication with an amplification assembly, and a heater assembly thermally coupled to the amplification assembly and responsive to a heater activation assembly. In another preferred aspect the device may further include a lateral flow assay configured to receive amplification products from amplification assembly.

In another specific aspect, the inventive technology may include systems, methods and compositions for the efficient lysis of cell that may be present in a sample, such as a biological sample. In this aspect, a lysis pad embedded with buffers and/or reagents sufficient to lyse the cells in the sample may be positioned within the device thereby releasing the nucleic acids. In another specific aspect, the inventive technology may include systems, methods and compositions for the efficient filtering of the lysed cell. In this aspect, a filter, and preferably filter stack as described herein may filter the liquid sample while preventing unwanted inhibitors of later nucleic acid amplification, for example through a chelating material.

In another specific aspect, the inventive technology may include systems, methods and compositions for the early detection of pathogens and/or infection in an asymptomatic subject through a novel diagnostic device, which in a preferred embodiment may include a lateral flow assay configured to detect one or more oligonucleotide transcript biomarkers produced by a subject's innate immune system in response to a pathogen or infection and present in saliva.

Additional aspects of the invention may include one or more of the preferred embodiments set forth in the claims. Still further aspects of the invention may be evidenced from the specification, claims, and figures provided below

### BRIEF DESCRIPTION OF THE FIGURES

FIGS. 1A-C. (A) Exemplary model of assembled diagnostic device of the invention in one embodiment thereof. (B) Exploded model of assembled diagnostic device in one embodiment thereof. (C) Cross section of assembled diagnostic device of the invention in one embodiment thereof.

FIGS. 2A-B. Absorption volume of tested collection materials and dimensions. Values presented were calculated by subtracting pre-collection mass from post-collection mass. Mass measured to approximate sample volume. (A) Max collection volume of collection pads dipped in PBS (30×8 mm Porex collection pad n=11, all other pad sizes n=1). Collection pads were attached to the diagnostic device collection handle and dipped in PBS to full saturation. (B) Average max oral collection volume of saliva (Porex n=8; SalivaBio n=4). Collection pad was attached to diagnostic device collection handle and placed in mouth until pad reached saturation.

FIGS. 3A-D. Optimizing and measuring RNase inhibition by murine RNase Inhibitor (mRI). (A) Diagram of the RNase Alert assay. A quenched fluorescent ssRNA probe reports RNase activity when the quencher and fluorophore are physically separated by RNase degradation. Data is collected immediately after saliva is added to the assay and the RNase activity is calculated from a linear slope of the first 90 second of measurements. (B) RNase activity in five individual saliva samples with or without addition of 4 U/μl mRI. (C) RT-qPCR data for a panel of 12 biomarkers indicating the relative abundance of each biomarker at the indicated time after lysis. Each timepoint is from a pooled saliva sample run through a separate device. Delta Ct values were normalized to the 0 second timepoint. Horizontal bars are mean+/−standard deviation. (D) RNase activity in four saliva samples before and after rehydrating an amplification pad containing 4 U/μl of lyophilized mRI. Saliva in rehydrated pads went through a 20-minute RPA incubation at 39° C. prior to addition to the RNase Alert assay showing that RNase inhibition is long-lived. Ct=Cycle Threshold.

FIGS. 4A-D. Chelex-100 treatment of saliva optimization. (A) Saliva inhibition of RPA. Titration of pooled saliva was used to reconstitute lyophilized RPA reactions in the presence or absence of cDNA template, identifying inhibition of RPA by >25% (v/v) saliva. (B) Removal of saliva inhibitors by Chelex-100. Pooled saliva was treated with 20%, 5%, and 0% (w/v) Chelex-100 in a liquid format before addition to RPA at 95% (v/v) final concentration, with cDNA template (+) or no template (−). (C) Comparing 30 minute in-solution vs. direct, column-like Chelex-100 treatment of saliva. Saliva treated in liquid format at 0% and 5% (w/v) or column-like treatment at 5% and 20% (w/v) before addition to RPA at 95% (v/v) final concentration with cDNA template (+) or no template (−). (D) Identification of persistent RT-specific inhibitors in saliva after Chelex-100 treatment. Saliva was treated with 20% (w/v) Chelex-100 for one minute before addition to RT-RPA with cell line cDNA, RNA, or no template (−). All reactions contain 4 U/μl RNase inhibitor and 0.0625 U/μl Transcriptor RT.

FIGS. 5A-D. Optimization of filter stack height, diameter, and material composition. Mass measured to approximate saliva volume. (A) Collection pad expression mass and lysis pad retention mass. 35.5 mm×10 mm Porex collection pad used with 10 mm diameter lysis pads of varying height. (B) Sample mass expelled downstream of lysis pad. 35.5 mm×8 m m Porex collection pad used with 10 mm diameter lysis pads of varying height. (C) Collection pad expression mass and lysis pad retention mass. 30 mm×10 mm SalivaBio collection pad used with lysis pads of varying dimensions or material densities. (D) Sample mass expelled downstream of lysis pad. 30 mm×10 mm SalivaBio collection pad used with lysis pads of varying dimensions or material densities. (A/C) Collection pad expression mass calculated by subtracting the pre-collection mass from post-collection mass. Lysis pad retention mass calculated by subtracting the dry lysis pad mass from wet pad mass. (B/D) Downstream sample expression mass calculated by subtracting lysis pad retention mass from collection pad expression mass.

FIG. 6. Tracking dye front through diagnostic device. Xylene cyanol dye was dried into 11×10 mm lysis pads before assembly in the device. SalivaBio 30×10 mm collection pads were saturated with 1.2 mL of PBS and expressed through the device. Sample flows through the lysis pad, reconstituting and washing off the xylene cyanol dye, then saturates the transfer and amplification pad. Device (top), transfer pad, and amplification pad (bottom) were imaged before (left) and after (right) addition of PBS to the device.

FIG. 7. Evaluation of optimized sample treatment and lysis buffer components. (A) RT-RPA efficiency in the presence of Buffer 20 and Buffer 21, using cell line RNA as (+) template and (−) no template control. (B) Optimized early/pre-infection diagnostic sample treatment and lysis tested on 5 individuals. −RT=no reverse transcriptase was included in the RT-RPA reaction, +RT=Superscript IV was added to the RPA reaction at a final concentration of 1 U/μl.

FIG. 8. Comparison of RT resistance to saliva inhibition. 50 μl of RT-RPA reactions were prepared with SuperScript IV (1 U/μl), NxtScript (1 U/μl), NxtScript 2G (1 U/μl), or MMLV HP (5 U/μl), then lyophilized into amplification pads. MMLV HP was tested at 5 U/μl, which is equivalent in cost to the other RT enzymes at 1 U/μl. Water and saliva samples were processed in the diagnostic device with a collection pad, buffer 21 lysis pad, 10 μm filter, 75 mg Chelex-100, and 1 μm filter. Samples combined with cell line RNA (+) or water (−) and used to reconstitute RT-RPA amplification pads. LFA signal in reactions without cell line RNA (−) indicate amplification of endogenous CXCL8 RNA in saliva (red boxes). “No chelex saliva” was processed through diagnostic device without Chelex-100.

FIG. 9. Comparison of pad density impact on reaction efficiency. (A) Pad-driven RPA reactions were run on amplification pad materials of three densities. Reactions were then diluted 10-fold and run on lateral flow strips. High density=0.25 g/cc, Medium density=0.16 g/cc, Low density=0.07 g/cc.

FIGS. 10A-B. Host biomarker limit of detection (LoD) studies in RPA. Heatmap of CALR LoD across a range of temperatures (X-axis). Dilution series of starting template concentrations (Y-axis) were assayed in RPA for 20 minutes at temperatures ranging from 29° C. to 43° C. Results were measured by amplicon flourescent intensity (AU=Arbitrary Units) from agarose gel electrophoresis (B) Double stranded CALR biomarker PCR product dilution series was run in liquid RPA reactions using the TwistDx TwistAmp Basic RPA kit. Reactions were incubated at 37° C. for 20 mintes. (C) Double stranded CXCL8 biomarker PCR product dilution series was run in Pad-Driven RPA reactions. Reactions were incubated at 44° C. for 20 minutes.

FIG. 11. Integration of RT-RPA amplification (A) Integration of pad material into amplification apparatus, also referred to as an amplification assembly. T1 and T2=transfer pad material, Porex HRM PP/PE blend, 0.16 g/cc, blocked with 1% PEG20K and 0.2% Tween-20. Amp pad is the same HRM PP/PE blended material with RT-RPA reagents lyophlized with 0.1% Tween-20, 2% sucrose, and 1% mannitol. (B) Amplification performance using the setup shown in A. Template was wicked through the pad material for a total of 107 copies of in vitro transcribed CXCL8 RNA reaching the amplification pad. The amplification assembly was incubated for 20 min in an incubator set to 44° C., then amplicons were visualized on a lateral flow strip. (C) Integration of pad material into the full diagnostic device. (D) Whole-device amplification using the setup shown in C. Template was absorbed into the collection pad and then expressed within the device. Sample passed through a blank lysis pad (no lysis buffer embedded), then passed through the 10 μm filter, 75 mg of Chelex-100, and 1 μm filter, then wicked through the pad material towards the amplification pad. Double-stranded DNA template was added to deliver 104 copies of template to the amplification pad. The full diagnostic device was incubated for 40 min in an incubator set to 44° C., then amplicons were visualized on a lateral flow strip.

FIG. 12. Vertical strip embodiment of diagnostic device. Additional subcomponents were integrated into a final design that included a collection pad, filtration stack, filter housing, amplification pad, and lateral flow strip. An incubation film is shown that inhibits amplification products from flowing onto the lateral flow strip. Once the reaction is complete, the incubation film can easily be pulled away to a contact between the amplification pad and the conjugation pad of the lateral flow strip.

FIG. 13. Alternative designs for diagnostic device. CAD model of changes made to the collection handle and assembled SLA device from version 1.0 (left/green) to version 1.4 (right/blue). Model changed to accommodate design limitation in low production molding. Assembled SLA device shown with and without ghosted housing and strip cover.

FIG. 14. Amplification assembly and baseplate to relocate pressure relief holes. Original injection mold design (left) with three pressure relief holes at the front of the amplification assembly. Alternative embodiments included a re-designed amplification assembly and baseplate shown expanded (middle) or mated (right). Orange circles highlight pressure relief holes.

FIGS. 15A-B Time-course study of CALR amplification in RPA. Dilution series from 10⁶ to 10 input copies (Y-axis) were incubated at 34° C. in RPA reactions for the indicated amount of time (X-axis) and reactions visualized by agarose gel (A) and on lateral flow strips (B). The expected size of the CALR amplicon is indicated to the left of the gels in panel A.

FIGS. 16A-B. Characterization of CXCL8 (A) and DDX58 (B) biomarker amplification across temperatures (X-axis) and template concentrations (Y-axis). Relative band intensity of amplicons (in arbitrary units) was determined by quantifying bands on an agarose gel (left). Select reactions were also assayed on lateral flow strips (right).

FIGS. 17A-B. Time-course study of CXCL8 (A) and DDX58 (B) amplification in RPA. Dilution series from 10⁶ to 10 input copies were incubated at 34° C. in RPA reactions for the indicated amount of time and reactions visualized by agarose gel and on lateral flow strips. The expected size of the target amplicon is indicated to the left of the gels.

FIGS. 18A-B. Preliminary LoD studies in RT-RPA at various temperatures. RT-RPA reactions using CALR (A) and CXCL8 (B) IVT template dilutions were incubated for 15 minutes at the indicated temperatures, then were visualized on an agarose gel. The expected size of the CALR and CXCL8 amplicons are indicated to the left of the gels in panels A and B, respectively. Results were also visualized using lateral flow strips (C).

FIGS. 19A-B. Comparison of reference (A) and infection (B) test line LoDs on lateral flow strip. Dilutions of mimic concentration ranging from 5 ng to 0.1 ng were run on lateral flow strips for 15 minutes at room temperature before imaging.

FIG. 20. Exemplary Oligo modifications for detection of RT-RPA amplicons on a lateral flow strip. Reference/control biomarkers are amplified with FITC-modified forward primers and biotin-modified reverse primers for detection by polystreptavidin on the lateral flow strip. Infection biomarkers are amplified with FITC-modified forward primers and DIG-modified reverse primers for detection by anti-DIG on the lateral flow strip. Gold-conjugated anti-FITC binds to amplicons and are then immobilized at detection zones on the strip to yield a signal at the infection or reference line. An excess gold line monitors flow of gold on the strip and detects gold-conjugated anti-IgY (raised in rabbit) with an anti-rabbit antibody. Anti-DIG and anti-FITC are mouse monoclonal antibodies.

FIG. 21. Example of an initial wet-lab primer screen. 8 primer sets for the same target (RACK1) were screened in RPA using cell line cDNA (+) as a template or no template controls (−). 20 μl TwistDx Basic kit reactions were incubated for 20 minutes at 39° C. Reactions were analyzed on a 2% agarose gel.

FIG. 22. Multiplexing with control and reference biomarkers in RT-RPA. A reference biomarker (CALR) and infection biomarker (IFIT2) were assayed individually or multiplexed together in RT-RPA reactions with RNA isolated from a human lung cell line (+) or no template controls (−). Each oligo was at a final concentration of 240 nM and Transcriptor Reverse Transcriptase (3531287001; Millipore Sigma) was added to a final concentration of 0.0625 U/μL. Reactions were incubated for 15 minutes at 39° C. and analyzed on a lateral flow strip.

FIGS. 23A-B. Examples of quadruplex and quintuplex RT-RPA reactions. (A) Multiplexed RT-RPA reactions were performed on RNA isolated from a human lung cell line (+) or no template controls (−) for 15 minutes at 39° C. and analyzed on a 4% agarose gel. Each oligo was at a final concentration of 180 nM. Expected amplicon sizes for each target are shown to the right of the gel. Note that DDX58 and CALR have very similar amplicon sizes and can't be distinguished on a gel. (B) Multiplexed RT-RPA reactions with and without RNA template analyzed on lateral flow strips.

FIG. 24. Effect of oligo concentrations on lateral flow strips. Multiplexed RT-RPA reactions were performed on RNA isolated from a human lung cell line (+) or no template controls (−) for 15 minutes at 39° C. and analyzed on lateral flow strips. Relative and absolute concentrations of primers were varied, as indicated above strips. Infection primers=CXCL8, DDX58, OAS2, IFIT2.

FIG. 25. Expanded view of infection diagnostic saliva processing subcomponents. Saliva is collected and transferred to the device using the collection pad, which also reduces sample viscosity and removes large particles from saliva. The lysis pad contains a lyophilized buffer for the lysis of human cells and inactivation of saliva RNases. The debris filter removes cellular debris and remaining large saliva particles before biomarker amplification. The RT-RPA amplification pad contains a lyophilized reaction buffer and enzymes for the amplification of human biomarkers of infection.

FIG. 26. Interference of saliva in RT-RPA amplification. cDNA and 500 or 50 μg of RNA were used as template in RT-RPA reactions targeting the CXCL8 biomarker. Saliva (0 μl, 5 μl, 1 μl, 0.1 μl) was added to the reactions to test for interference in RT-RPA. Reactions labeled in red contain no reverse transcriptase. The expected size of the CXCL8 amplicon is indicated to the left of the gel.

FIG. 27. Example of saliva RNase activity assays assayed on TapeStation High Sensitivity RNA ScreenTapes (5067; Agilent). Results from three independent assays are shown. Lanes 1-3 (left to right) are experimental controls including 500 μg RNA in RNase free water, untreated saliva without added cell line RNA, and untreated saliva incubated with cell line RNA. Lanes labeled “Incomplete RNase Inactivation” contain no ribosomal RNA bands, indicating RNase activity is present. Lanes labeled “Sufficient RNase Inactivation” contain sharp ribosomal bands (similar to RNA in water), indicating RNases have been inactivated. gDNA=genomic DNA.

FIG. 28. Reagent interference testing in RT-RPA. Lysis and RNase inhibitor reagents tested in RT-RPA using cDNA and RNA templates. RT-RPA reactions were prepared with varying concentrations of reagents, as labeled above (final concentrations in a 20 μl RT-RPA reaction are reported). Amplification products were run on a 2% agarose gel and band intensities were compared to control (No added reagent) reactions. Reactions labeled in red contain no reverse transcriptase. The expected size of the CXCL8 amplicon is indicated to the left of the gel. GuHCI=Guanidine hydrochloride, Triton=Triton X-100.

FIG. 29. Crude saliva extract amplified in RT-RPA. Saliva collected from seven individuals using the selected saliva collection pad. Saliva was extracted from pads using a 3 ml syringe and treated with the optimized lysis buffer. 5 μl of treated saliva was used as template in RT-RPA reactions amplifying the human RNA biomarker CXCL8. Reaction products were run on infection diagnostic lateral flow strips (shown above). Five out of seven extractions gave successful amplification as indicated by a line on the lateral flow strip for the CXCL8 amplicon. Samples 1 and 6 failed to produce an amplified product.

FIG. 30. Pad driven amplification-wet reagents. A porous 3 mm×3.5 mm×12 mm pad was fully saturated with an RPA liquid reaction. After incubation, the reaction was expressed from the pad using a syringe and diluted 50-fold in PBS before being applied to a lateral flow strip. NTC=no template control.

FIG. 31A-B Lyophilization of RPA reactions with and without glycine and trehalose. (A) Lyophilization of original RPA ingredients and associated lateral flow signal after rehydration and amplification. (B) Lyophilization of reformulated RPA ingredients with glycine and trehalose and associated lateral flow signal after rehydration and amplification.

FIG. 32 Amplification of NCL (a reference biomarker) and OAS2 (an infection biomarker) primers with full pad RPA. Pads were fully saturated with RPA reaction reagents and lyophilized using our optimized conditions. Lyophilized pads were then rehydrated with water containing a cDNA template, incubated at 39° C. for 20 minutes, and then applied to a lateral flow strip. Experiments were conducted in duplicate. NCL and OAS2 amplicons bind distinct locations on the lateral flow strip. NTC=no template control.

FIG. 33 RACK1 (a reference biomarker) primers amplified in the current diagnostic device in one embodiment thereof. A diagnostic device with all subcomponents integrated was used to carry out pad-driven amplification. In this preliminary experiment, a solution containing a cDNA template was added to the device, which was then incubated at 39° C. for 20 minutes. After incubation, the pull tab was removed to allow amplification products to flow onto the lateral flow strip. RACK1 amplicons were detectable on the lateral flow strip, albeit at low levels. This integrated prototype will be used in subsequent experiments to further optimize other aspects of the device from saliva collection to amplification efficiency.

FIG. 34. A cross-section of alternative diagnostic device in one embodiment thereof.

FIG. 35. Amplification in the fully integrated device. (A) Amplification of an RNA template diluted in water. 10⁵ copies/μl of RNA template in water or water alone (No Template) was absorbed into a collection swab secured to the Collection Handle, then the sample was expressed into the Reaction Cartridge by insertion of the Collection Handle. Devices were placed in an incubator at 45° C. for 20 minutes. After 20 minutes, the pull tab was removed to release reactions onto the lateral flow strip. Results were read through the strip cover window 15 minutes after removing the pull tab. Devices with two lines (Control and Test) indicates a positive result, while devices with one line (Control only) indicates a negative result. Three replicates with each template amount are shown. (B) Amplification of DNA template diluted in saliva. Saliva was collected from three individuals, then DNA template was spiked into each saliva sample for a final concentration of 10⁵ copies/μl. Saliva samples with DNA template were assayed in Reaction Cartridges as described in A. Three replicates with each saliva sample are shown. (C) Amplification of endogenous RNA from saliva samples. Saliva samples were collected from individual donors by holding the collection swab in the mouth. Following absorption, samples were expressed in the Reaction Cartridge by insertion of the Collection Handle, then samples were assayed as described in A. An RNA template present in saliva can be detected in four out of six of the samples shown.

FIG. 36. Schematic of reaction cartridge. Visible components of the reaction cartridge are annotated.

FIG. 37. Cross-section of the reaction cartridge showing device subassemblies.

FIG. 38. Exploded-view of reaction cartridge.

FIG. 39. Exploded-view of heater activation assembly in context of the reaction cartridge.

FIG. 40. Exploded-view of heater subassembly in context of the reaction cartridge.

FIG. 41. Exploded-view of saliva processing subassembly in context of reaction cartridge.

FIG. 42. Exploded-view of lateral flow assay subassembly in context of reaction cartridge.

FIG. 43. Cross-section schematic of the rection cartridge. All components within each subassembly are annotated.

FIG. 44. Schematic of saliva collection device. Key features of device design are annotated.

FIG. 45. Cross-sectional schematic of saliva collection device. Key features of device design are annotated.

FIG. 46. Exploded-view of saliva collection device. Key features of device design are annotated.

FIG. 47. Implementation of a saliva sufficiency indicator for normalized sample volumes across individuals. (A) Schematic of the saliva sufficiency indicator. Sufficiency indicator viewing window appears white before sample collection and turns dark blue once enough sample has been collected. (B) Sample collection volume using a 1-minute saliva collection across individuals with various saliva collection swab materials. Each swab material varies in density, diameter, length, and maximum sample collection volume. Blue line represents minimum sample volume required to run the device. (C) Sample collection volume (left, n=31) and time (right, n=31) when utilizing a saliva sufficiency indicator across individuals. Blue line represents minimum sample volume required to run the device.

FIG. 48. Thermal profiles of various chemical reactions considered for use in device. A) Galvanic corrosion between magnesium-iron alloyed powder and sodium chloride solution. B) Calcium oxide dissolution reaction in water. C) Copper sulfate hydration reaction with water. D) Iron filing oxidation reaction. E) Sodium acetate crystallization reaction. Temperature probes were placed inside of a reaction carried out in a PCR tube.

FIG. 49. Modification of magnesium-iron fuel source reaction to achieve isothermal conditions. A) Thermal effect of varying total volume of 1% NaCl solution used to rehydrate a fixed amount of magnesium-iron powder. B) Thermal effect of varying concentration of NaCl solution used to rehydrate a fixed amount of magnesium-iron powder. C) Thermal profile of a phase change material that melts at 42° C. being heated by a magnesium-iron fuel source. D) Thermal profile of a custom chemical heater composed of three annular cylinders. Outermost cylinder contains the fuel (magnesium-iron mixed with sand), middle cylinder contains a phase change material (melts at 42° C.), and the innermost cylinder is a liquid amplification reaction chamber. Thermal profiles of four different temperature probes are shown: two in different regions of the fuel source, one in the phase change material, and one in the amplification reaction chamber.

FIG. 50. Chemical heater design and functional testing. A) Diagram of concentric ring design used to house three distinct chambers: 1. Chemical fuel and filler 2. phase change material (PCM), and 3. amplification reaction. B) Image of a proof-of-concept prototype chemical heater. A 3D-printed housing was used to separate chambers consisting of 1. Fuel (38 mg Mg—Fe alloy) and filler (100 mg of vermiculite), 2. PCM (800 μL of Rubitherm RT44HC), 3. A reaction chamber containing 100 μL of water. Thermal probes (yellow) were inserted to monitor temperature at each position. C) Example thermal profiles of the chemical fuel, PCM, and reaction chamber upon activation with 300 μL of 10% sodium chloride, as recorded by thermo-couple probes at the indicated positions. Green region of the graph represents the temperature range at which RT-RPA amplification can occur. D) Thermal profiles of the reaction chambers of three independently built chemical heaters compared to the thermal profile of a BioRad T100 thermocycler (TC) set to 42° C. Green region of the graph represents the temperature range at which RT-RPA amplification can occur. E) LFA results of RT-RPA amplification of the indicated template concentrations in a 20 μL reaction using either a T100 thermocycler (TC) or chemical heater as the heat source. Presence of a red band at the position labeled “Amplicon Detection” indicates successful amplification of the template. NTC=no template control.

FIG. 51. Integration of heater element into current platform prototype. A) Schematic of heater subassembly placement in full device. A fluid capsule that holds an activator solution is shown that is delivered to the heater assembly containing the chemical fuel, phase change material, and isothermal amplification reaction. B) Thermal profiles of three devices with integrated heaters compared to the thermal profile of a thermal cycler (TC). C) Detection of RNA template multiplexed amplification (control and test biomarkers) on a lateral flow strip. Amplification reaction was carried out in a fully integrated device containing an active heater element.

FIG. 52. Isothermal amplification and detection of RNA derived from capillary blood. A) 200 microliters of capillary blood was collected using a finger stick lancet. RNA from the sample was purified using a column purification kit, eluted in 50 microliters, and yielded a total of approximately 1.5 micrograms of RNA. The nanogram amounts shown were added to a 20 minute RT-RPA reaction and amplicons of a host biomarker (CXCL8) were resolved on a lateral flow strip. The top red indicator line is a lateral flow control line. B) RT-RPA reactions using 2.8 ng of RNA were carried out as in A) with increasing concentrations of hemoglobin and amplification products were resolved on a lateral flow strip. NTC=no template control.

FIG. 53. Isothermal amplification and detection of endogenous RNA from crude extracted blood. A) 50 microliters of capillary blood was collected using a TAP Microselect Device and diluted at various concentrations in DEPC treated water. 1 μL of each dilution was then added to a 20 μL RT-RPA reaction with and without a 10 ng RNA template spike to observe potential inhibition from blood. No inhibition was observed in any reaction with the spiked RNA template. At a 10% blood in water dilution, endogenous amplification of a host biomarker (RACK1) was observed on a lateral flow strip. The top red indicator line is a lateral flow control line. B) Lyophilized reagents for RT-RPA reactions resuspended in 10% blood dilution such that the final reactions consisted of either 50% or 100% diluted blood with no additional template spikes. No inhibition was observed from the increased reaction concentrations of blood. Instead, stronger endogenous amplification of host biomarkers (CXCL8 and RACK1) was observed on the later flow strips. NTC=No Template Control.

FIG. 54. Comparison of RNA expression in venous and capillary blood. A) Equivalent amounts of RNA purified from either venous or capillary blood from 6 donors was subjected to an RT-qPCR panel to measure the indicated human RNA biomarkers. B) RNA from 50 microliters of capillary blood from 3 donors was prepared using either a crude extraction method (ten-fold dilution in water, centrifuged to collect cell pellet, resuspension of pellet in 20 microliters of water) or spin column purification. RNA samples were subjected to an RT-qPCR panel to measure the indicated human biomarkers. Data is represented in box plot format.

FIG. 55. Prototyping and conceptualization of capillary blood collection handle. A) Capillary tube being used to collect a contrived capillary blood specimen (water with blue dye). The indicator line (black) on the capillary tube represents a sample sufficiency line at 20 microliters. B) Capillary tube containing the contrived specimen attached to a syringe with lysis buffer that would be mixed with the sample when being expelled into the device. C) Description of a capillary blood collection handle and its compatibility with the current device prototype.

FIG. 56. Diagram showing sequential two-stage sample amplification and delivery to lateral flow assay in one embodiment thereof.

FIG. 57. (A) shows a fluid injection assembly having an injector configured to pass a fluid, such as a buffer through a collection pad into the sample processing assembly; (B) shows a fluid injection assembly having a fluid, such as a buffer positioned within the reservoir and responsive to a collection handle and configured to inject a fluid into the sample processing assembly in response to the first action of a collection handle.

FIG. 58. Shows a cross-sectional view of a check valve positioned between the sample processing assembly and the amplification assembly in one embodiment thereof.

FIG. 59. Integration of a magnesium transfer pad. A) Cross-sectional schematic of the amplification apparatus subassembly showing the location of the magnesium transfer pad sitting atop the amplification pad. B) A water sample either spiked with nucleic acid template (+) or not (−) containing 14 mM magnesium (liquid, blank transfer pad) or not (magnesium in transfer pad). Samples were processed through the device and amplification reactions were run in the device. Two amplification products (healthy line and infection line) were resolved on a lateral flow strip. C) Experiment carried out as in B) except the sample used was pooled, boiled saliva.

### DETAILED DESCRIPTION OF THE INVENTION

The present invention is directed to novel systems, methods, and apparatus for the amplification and detection of nucleic acids in a sample. In one preferred example, the present invention is embodied by novel a system, method, and apparatus for early pathogen-agnostic detection of infectious disease. In a preferred embodiment, the invention includes diagnostic device (100) adapted to amplify nucleic acids in a sample, such as an environmental, biological, pharmaceutical, and/or diagnostic sample and the like. As described by Sawyer et al., in PCT/US2020/049290 (incorporated herein by reference), exemplary nucleotide transcript biomarkers, and preferably coding or non-coding RNA oligonucleotides produced by a subject's innate immune system in response to a pathogen or infection can be present in a biological sample, such as saliva. Notably, specific target RNA transcripts or biomarkers produced by a patient's immune response (generally innate immune response or any other cellular pathway upregulated upon infection) are found in saliva may be indicative of early infection. As a result, one embodiment of the inventive technology includes systems, methods, and compositions for the detection of these target oligonucleotides, such as target RNA transcripts, which may act as biomarkers for early-infection in a subject. However, as noted above, target RNA transcript biomarkers present in a typical fluid sample provided by, in this embodiment a human subject, are generally present at low concentrations and require amplification to be detected. To overcome this physical limitation, the present invention include systems, methods and apparatus for the isothermal amplification of the same.

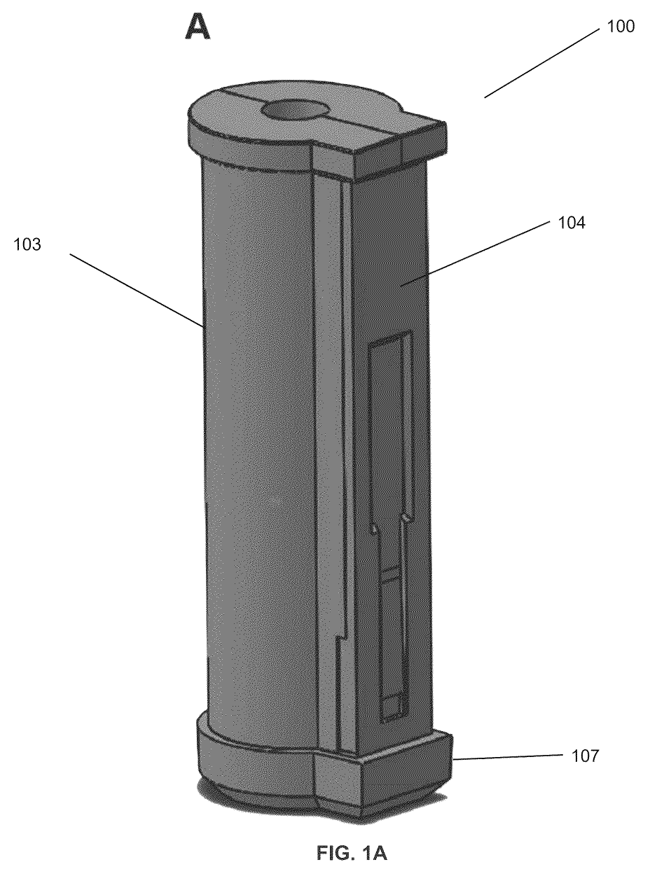

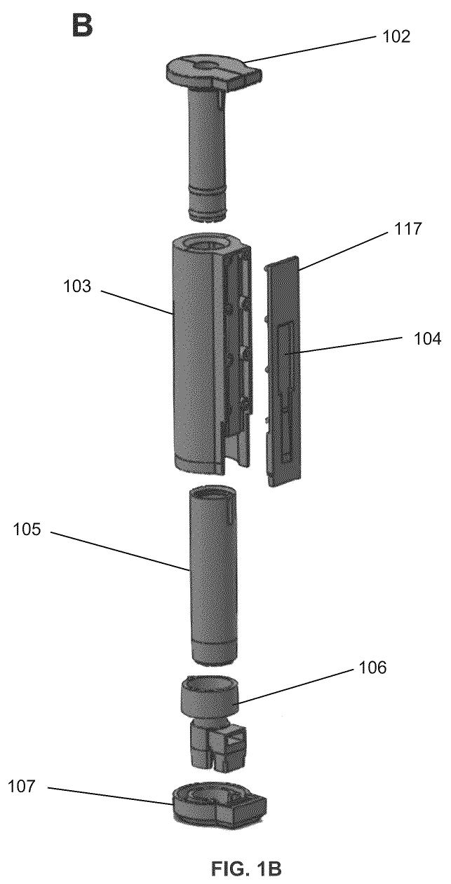

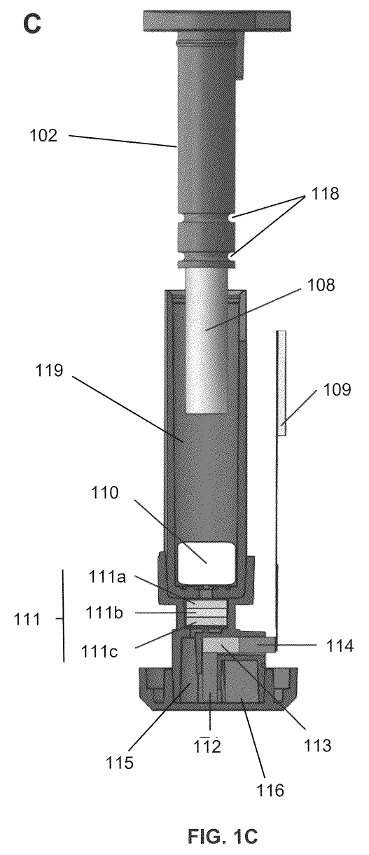

In a preferred embodiment, the diagnostic device (100) of the invention, also generally referred to herein as the device (100), or device of the invention (100), is adapted to collect a sample, such as an environmental or biological sample, and preferably a saliva sample from a subject, which may be further processed and filtered to release the nucleic acids from the sample, which then undergoes isothermal amplification followed by detection on a lateral flow strip. Generally referring to the preferred embodiment shown in FIG. 1, the diagnostic device (100) of the invention includes a collection handle (102). In this preferred embodiment, the collection handle (102) may include a handle portion securing a collection pad (108) adapted to allow a subject to self-collect a biological specimen, and preferably a saliva sample. As noted below, the collection pad (108) of the invention includes an absorbent material adapted to be inserted into a subject's mouth and capture a saliva sample sufficient for processing and later isothermal amplification and detection by a lateral flow strip (109) as further detailed below. Specifically referring to FIG. 1C, in this embodiment the collection handle (102) of the invention is configured to form a plunger such that it can be inserted into the internal compartment (119) of the device (100) and deposit a biological, or other sample therewith for initial processing. As further shown in FIG. 1C, the collection handle (102) may include one or more seal positions (118) that can form a hermetic seal when the handle is inserted and further prevent the sample from flowing back out of the internal compartment (119) of the device (100). In still further embodiments, the collection handle (102) may be secured the device (100) of the invention such that the biological specimen is secured with its in internal compartment (119). Example locks may be selected from: a slide locking position, a twist locking position, a slotted locking position, a snap locking position, or a quick release locking position, and the like.

The diagnostic device (100) of the invention includes a barrel (105). As shown in the embodiment highlighted in FIG. 1, the barrel (105) of the invention is configured to receive the sample, for example though a collection pad (108) or directly depositing the sample therewith. As showing in FIG. 1A, the barrel (105) may be positioned within a housing (103) forming an internal compartment (119). In this embodiment, the collection handle (102) and collection pad (108) can be positioned within the barrel (105) and/or housing and sealed to prevent contamination prior to use. Moreover, the collection handle (102) and collection pad (108) can be removed from the barrel (105) and/or housing (103) assembly and used to collect a sample as described above and once inserted back into the device, generate a seal such that the downward movement of the collection handle (102) acts as a plunger generating an internal pressure differential that forces the biological specimen through a lysis pad (110) and filter stack (111) as described below. Notably, while this embodiment shows the barrel (105) and housing (103) as separable components, in certain alternative embodiments the barrel (105) and housing (103), among other elements described in more detail below, may comprise integral components forming a unitary or semi-unitary device.

The diagnostic device (100) of the invention includes a lysis pad (110). As shown in the embodiment highlighted in FIG. 1, the lysis pad (110) of the invention is positioned within the barrel (103) such that it can be in fluid communication with the biological specimen transmitted from the collection pad (108) or deposited directly into the internal compartment (119). In this embodiment, the lysis pad (110) of the invention contains a lyophilized buffer that is adapted to cause the lysis of cells and optionally the inactivation of RNases in the sample. In a preferred embodiment, the lyophilized buffer of the invention may include the lysis buffer formulation identified as Buffer 21 (5 mM TCEP-HCl, 7.5% Tween-20, 0.00167% Digitonin), and optionally a portion or lyophilized murine RNase inhibitor (mRI). Exemplary alternative lysis buffer formulations are provided in Table 10 below.

As detailed in the Examples below, the lysis pad (110) is adapted to lyse only a portion of, preferably a biological sample, preferably the first approximate 0.5 mL of saliva expressed from the collection pad (108). In this configuration, the lysed sample is then followed by additional un-lysed saliva, creating a “front” of lysed sample that can be maintained until arriving at the amplification assembly. As detailed below, in alternative embodiments, the inactivation of RNases in the biological sample can occur post cell lysis as part of the invention.

The diagnostic device (100) of the invention includes an amplification assembly (106). As shown in the embodiment highlighted in FIG. 1, the amplification assembly (106) of the invention may be configured to receive, and be in fluid communication with the barrel (105) such that the sample may be passed from the lysis pad (110) into the amplification assembly (106), for example through a channel (115). Again, referring to FIG. 1, the amplification assembly (106) of the invention can be adapted to house a filter stack (111), a transfer channel (115) in fluid communication with a reservoir (116) formed by a base plate (107), as well as one or more transfer pads (112, 113), and at least one amplification pad (114), each being further described below.

As noted above, a diagnostic device (100) of the invention includes a filter stack (111), which may be positioned within the amplification assembly (106). As shown in the embodiment highlighted in FIG. 1, a filter stack (111) of the invention may include one or more, filters positioned adjacent to a column portion (111c) containing a chelating agent configured to prevent positively charged molecules in the sample, such as divalent cations and positively charged macromolecules from inhibiting DNA polymerase and reverse transcriptase enzymes used in later isothermal amplification steps. As further described below, flow of the sample, and in particular a biological saliva sample through the filter stack (111) of the invention reduces viscosity and improves the overall flow of sample through the device (100).

Again, referring to FIG. 1, the filter stack (111) of the invention may include a first and second filter (111a, 111b) sandwiched between a column portion (111c) containing an agent, such as a chelating agent configured to inhibit divalent cations and positively charged molecules in the sample from inhibiting downstream isothermal amplification. In a preferred embodiment, the column portion (111c) may include a quantity of Chelex-100, which may further be in the form of a resin. As used herein, Chelex 100 is a chelating material from used to purify other compounds via ion exchange. It is noteworthy for its ability to bind transition metal ions. It is a styrene-divinylbenzene co-polymer containing iminodiacetic acid groups.

As shown in the preferred embodiment of FIG. 1C, the first and second filters (111a, 111b) of the filter stack (111) may include different filtering sizes, while the column portion (111c) may include a quantity of Chelex-100. In this preferred embodiment, the first upper filter (111a) may include a larger filter size than the lower second filter (111b). For example, in a preferred embodiment shown in the figures, the first upper filter (111a) may include a filter size of approximately 10 μm, while the lower second filter (111b) may include a filter size of approximately 1 μm. In this configuration, the Chelex-100 resin is prevented from passing through the second filter (111b), which prevents it, or other chelating agents from interacting with the magnesium required for downstream isothermal amplification, preferably by RT-RPA. Moreover, the column portion (111c), containing a chelating agent such as Chelex-100, can be desiccated prior to packing into the filter stack (111). This step minimizes the creation of air pockets with the filter stack (111).

Notably, in still further embodiments, a third filter (111d) may be included in the filter stack (111). In this embodiment, the third filter (111d) of the invention may be positioned below the second filter (111c), and my further have a filter size that is smaller than the second filter (111c). In a preferred embodiment, the third filter (111d) of the invention can have a filter size of approximately a 0.4 μm or less. Placement of the third filter (111d) below the second filter (111c) allows trapped air to vent through the dried column portion (111c), preferably containing a chelating agent such as Chelex-100, prior to the flow of the sample and further encourages a more efficient rehydration of the resin.

The diagnostic device (100) of the invention includes an amplification assembly (106) that forms a transfer channel (115) positioned below the filter stack (111) and adapted to transmit the processed and filtered sample, in this case being a saliva sample, to a reservoir (116) formed by a baseplate (107). In this embodiment, a sample, passing through the collection pad (108), lysis pad (110), and filter stack (111) enters the baseplate (107) where it is deposited into reservoir (116) and wicked up by one or more transfer pads (112 or 113) and transferred to an amplification pad (114) positioned within the amplification assembly (106), which as described below contain lyophilized reagents necessary for isothermal amplification of the sample. As described below, the reservoir (116) allow excess sample to be collected thereby allowing the “front” of lysed sample to be more efficiently wicked by the un-processed sample into the transfer pad(s) (112,113) and then pushed forward into the amplification pad and ultimately the lateral flow strip (109). In this manner, the excess sample collected in the reservoir provides sufficient liquid volume to drive fluid transfer through the device, and indeed drives the capillary action of the amplified sample across the lateral flow strip (109).

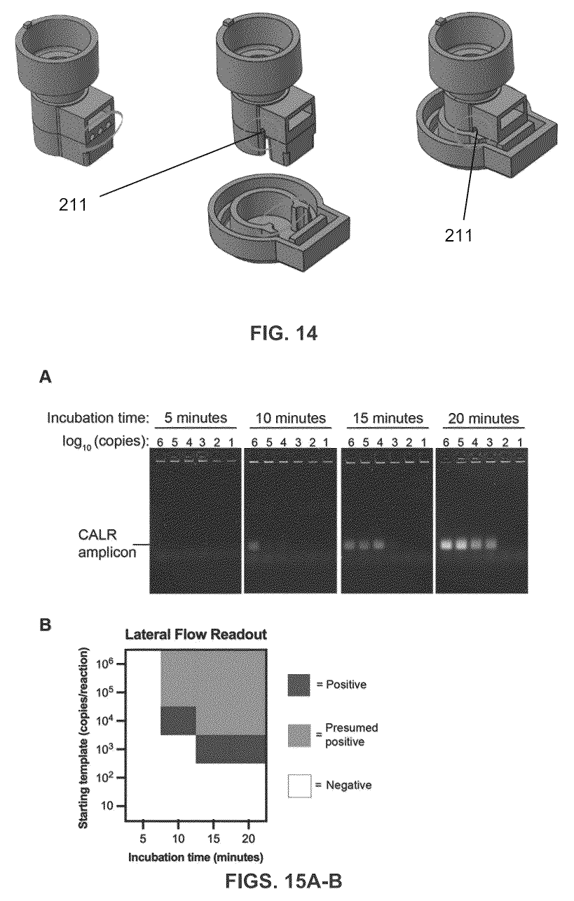

As shown in FIG. 14, to avoid excessive pressure created within the amplification assembly (106) from compression of the collection pad (110), the baseplate (107) of the invention may include one or more pressure relief positions (121). Again, while the baseplate (107) is shown as separable part of the device (100), in alternative embodiments the baseplate (107) may be integral with one or more components of the device (100) described herein.

As noted above, the diagnostic device (100) of the invention includes one or more transfer pads (112 or 113) adapted to wick the sample from the baseplate (107), towards an amplification pad (114) embedded with isothermal amplification reagents. In this embodiment, the transfer pads (112 or 113) and amplification pad (114) are formed from a sufficiently porous material so as to rapidly absorb the sample and prevent mixing of the lysed and un-lysed sample to maintain a “front” of lysed sample along the processing path toward the lateral flow strip (109). In a preferred embodiment, the amplification pad (114) of the invention contains a lyophilized reaction buffer and enzymes for the amplification of human biomarkers of infection utilizing RT-RPA or other isothermal amplification methods described herein. Notably, descriptions and methods of performing RT-RPA, including components necessary for RT-RPA including various primers, and RNA biomarkers, and other isothermal amplification systems are described by Sawyer et al, in U.S. patent application Ser. No. 17/686,387 and are herein incorporated by reference.) The components needed to perform RT-RPA or other methods of isothermal amplification can be further lyophilized on the distal end of the amplification pad (114) to reduce required reagent volumes and generate a reserve of sample flow behind the reaction to enable dilution for flow onto the lateral flow strip (109). In other embodiments, the amplification pad (114) can be formed of a porous materials impregnated and dried with RT-RPA reagents and optimized excipients, such as 0.1% Tween-20, 2% sucrose, 1% mannitol, as well as optionally RNase inhibitors, such as mRI.

As noted above, the diagnostic device (100) of the invention includes a lateral flow strip (109) that may be secured within a strip cover (104). In this embodiment, the strip cover (104) of the invention secures the lateral flow strip (109) in place and protects it from environmental exposure, while containing a transparent window for visual observation of the test results. Moreover, the strip cover (104) generates a pressure gradient for consistent flow of amplification products from the sample across the lateral flow strip (109), regardless of orientation. The lateral flow strip (109) of the invention may further be protected by removable barrier, such as a pull tab (117) that contains the sample within the amplification pad (114) during incubation, and which can be removed to enable readout of the amplified products from the sample transmitted from the amplification pad (114) to the lateral flow strip (109).

Exemplary methods, systems, and apparatus for the use and detection of amplified products on a lateral flow strip (109) resulting from an isothermal reaction, such as RT-RPA are also described by Sawyer et al, in U.S. patent application Ser. No. 17/686,387 and are herein incorporated by reference.) As shown in FIG. 20, the invention may include a lateral flow strip (109) having an antibody-based capture mechanism. In this embodiment, the result of an isothermal RT-RPA reaction may include an amplified RPA product that may act as a control biomarker, and another amplified RPA product that may act as an infection biomarker. Once the RT-RPA reaction within the amplification pad (114) is completed, the pull tab (117) can be removed allowing fluid communication from the pad to the strip such that the amplified products may be introduced to one or more conjugated antibody reporter probes, which in a preferred embodiment may act as visual reporters by producing an observable indication of, for example the presence of a target RNA biomarker transcript in a sample. More specifically, as shown in FIG. 20, the isothermal RT-RPA reaction may generate at least two amplified RPA products, or amplicons, namely a control biomarker and infection biomarker respectively having modified 5′ ssDNA overhang regions forming a probe capture region and a target capture region respectively. In this embodiment, a control biomarker may include a dsDNA transcript region coupled with a 5′ FITC forward ssDNA oligo (GREEN) and 5′ biotin reverse ssDNA oligo (ORANGE). The infection biomarker of this embodiment may include a dsDNA transcript region coupled with a 5′ FITC forward ssDNA oligo (GREEN and PINK) and a 5′ DIG ssDNA reverse oligo (BLUE). As further shown in FIG. 20, GNP may be conjugated with an anti-FITC (fluorescein isothiocyanate) antibody, and preferably an anti-FITC antibody produced in a rabbit. As also shown in FIG. 20, streptavidin may also be stripped onto the lateral flow strip (109) membrane to capture control biomarker amplicons present in the amplified RPA product. In this embodiment, an anti-DIG (Digoxigenin) antibody, and preferably an anti-DIG antibody raised in mouse, may also be stripped onto the lateral flow strip (109) membrane to capture infection biomarker amplicons present in the amplified RPA product.

As further shown in FIG. 20, the hybrid dsDNA control and infection amplicon probes generated in the amplifying reaction within the amplification pad (114) may be combined with an anti-FITC antibody-conjugated GNP reporter probe. In this embodiment, the anti-FITC antibody may bind to the 5′ FITC-forward oligo of the control and infection biomarker forming an aggregated complex. In this embodiment, the aggregated complexes may further be introduced to the lateral flow strip (109) of the invention. The amplified products, driven by the saliva present in the reservoir (116) may flow via capillary action through a lateral flow strip (109) membrane, such as a nitrocellulose fiber membrane, towards an absorbent pad region on the lateral flow strip (109) that may include a detection zone having one or more capture probes embedded to the surface of the lateral flow strip, and preferably the surface of a nitrocellulose membrane of a lateral flow strip (109). The position and orientation of the capture probes embedded in a lateral flow strip (109) may be adjusted to optimize signal generation or sample-probe interactions.

As noted above, a capture probe may include an immobilized streptavidin base tetramer embedded in the nitrocellulose surface of a lateral flow strip (109). This immobilized streptavidin base may be coupled with a biotin-TEG linker that may further be coupled with a ssDNA target capture probe sequence that may be complementary to a target capture region on a hybrid dsDNA probe, and preferably the 5′ biotin-reverse oligo. Further, a capture probe may include an immobilized anti-DIG antibody that may be configured to bind to the 5′ DIG-reverse oligo. In this configuration, control and infection biomarker amplicons may be bound to their respective locations by their respective capture probes. As noted above, the GNP reporter probes of the invention produce a red color signal in solution or when immobilized on the lateral flow strip. As such, when a certain concentration of complex aggregates are captured in close proximity to one another a visible signal within the detection zone may be generated. This visible signal within the detection zone may indicate a positive result indicating the presence of a target pathogen, or an early-indication of infection in a subject. Naturally, the above is merely an exemplary embodiments, as many uses and configurations of lateral flow assays can be adapted to the present invention.

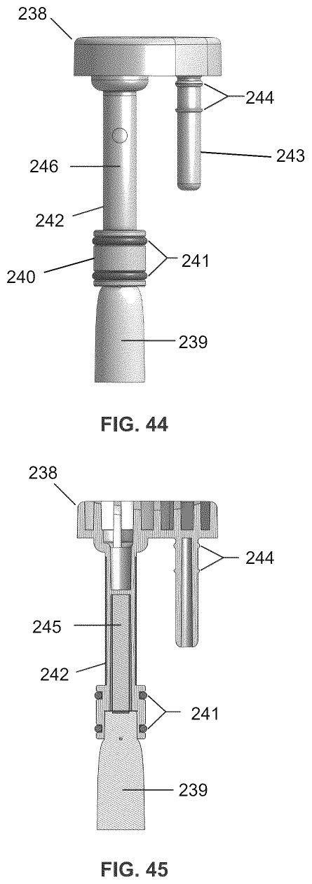

In another preferred embodiment, the invention includes a nucleic acid amplification device (200), also generally referred to herein as the amplification device (200), or device of the invention (200), configured to process a sample containing a quantity of nucleic acids, which can further be amplified and detected, for example via lateral flow assay. Generally referring to the preferred embodiment shown in FIGS. 44-46, the amplification device (200) of the invention includes a collection handle (238) configured to collect a sample containing a quantity of nucleic acids. In the embodiment shown in FIG. 44, the collection handle (238) includes an extended collection arm (242) securing a collection pad (239) adapted to allow a subject to self-collect a biological or environmental specimen, such as preferably a saliva sample.

As noted above, the collection pad (239) of the invention includes an absorbent material adapted to collect a biological or environmental sample, For example, in one embodiment, the collection pad (239) can be inserted into a subject's mouth and capture a saliva sample sufficient for processing and later isothermal amplification and detection by a lateral flow assay (225) as further detailed below. Specifically referring to FIG. 44, in this embodiment the collection handle (238) of the invention is configured to form a plunger such that it can be inserted into the processing chamber (204) of the device (200) and deposit a biological, or other sample therewith for initial processing. As further shown in FIG. 44-45, the collection handle (238) may include one or more extended surfaces securing, in this example one or more O-rings (241) forming a seal (240) that generates a hermetic seal when the collection handle (238) is inserted into the processing chamber (204) and further prevents the sample from flowing back out of the processing chamber (204) of the amplification device (200). Moreover, the seal (240) further generates a pressure force from the downward movement of the collection handle (238) which can assist in the introduction of the sample into the device, and in particular the sample processing and amplification assemblies (250, 251) as highlighted below.

Again, referring to FIGS. 44-46, the collection handle (238) can further include one or more secondary arms (242), which in this preferred embodiment is positioned adjacent and approximately parallel to the collection arm (242). The secondary arms (242) of the invention can further include one or more coupler positions (244) which in this preferred embodiment include a plurality of raised surfaces that can mate with a corresponding indentation for example in the reagent syringe (206) of a heater activation assembly (252) as described below.

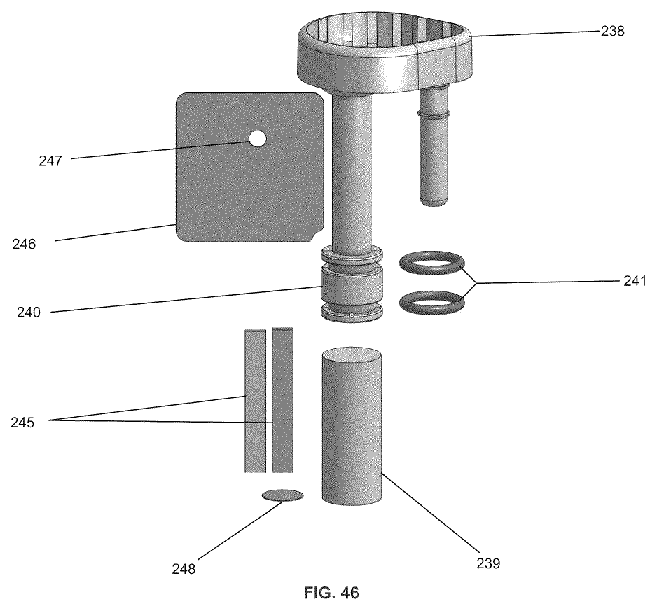

The collection handle (238) of the invention can further include a sample sufficiency indicator (245). Referring to the embodiment shown in FIG. 45-46, the sample sufficiency indicator (245) can include one or more strips of material that are configured to provide a visual indication, such as the release of a dye or other chemical indicator in response to the presence of a sample, such as a saliva sample. In this embodiment, a user can contact the collection pad (239) with the source of the sample, such as by inserting it into the mouth of a user. As the collection pad (239) becomes saturated with the sample, a portion of it can come into contact with the sample sufficiency indicator (245) causing a corresponding color change.

In this example, the sample sufficiency indicator (245) can be calibrated such that the time it takes for the sample to travel, for example via capillary action, through the sample sufficiency indicator (245) can correspond with a sufficient amount of time needed to provide a sufficient quantity of the sample, such as saliva or other environmental or biological sample. Again, referring to FIG. 46, the sample sufficiency indicator (245) can be calibrated by positioning it beneath a cover (246) having a viewing aperture (247). In this embodiment, the viewing aperture (247) is positioned at a point distal to the collection pad (239) such that the length of time for the color change to reach the viewing aperture (247) and thereby become visible to a user, is calibrated to the amount of time needed to collected an adequately sized sample for processing and later amplification as described below. Naturally, the type of sample being collected, as well as the characteristics of the same, such as viscosity, and concentration of nucleic acids can be considered when calibrating the position of the sample sufficiency indicator (245). In another embodiment, the sample sufficiency indicator (245) of the invention can be separated from the collection pad (239) by a sample contact interface (248) that can facilitate the flow of the sample to the sample sufficiency indicator (245).

The amplification device (200) of the invention further includes a collection handle (238) having a capillary collection assembly (300). As shown in FIG. 55, in a preferred embodiment a capillary collection assembly (300) of the invention includes a capillary collection channel (301) in fluid communication with one or more air vents (302) that are configured to define the quantity of sample captured in the channel (301). In this configuration, a fluid sample, and preferably a blood sample can be collected by touching a quantity of blood or other fluid with the terminal end of the capillary collection channel (301) causing the blood to be taken up by the channel by capillary action. As further shown in FIG. 55, the capillary collection assembly (300) can further include a solution, such as a buffer solution, responsive to a plunger (303) configured to pass the solution through the channel and transfer the fluid sample containing a quantity of nucleic acids to the processing chamber (204) of the sample processing assembly (250).

The amplification device (200) of the invention further includes a collection handle (238) having a fluid injection assembly (400). As shown in FIG. 57, in a preferred embodiment a fluid injection assembly (400) can include a collection handle (238) having fluid reservoir (401) containing, preferably, a buffer solution (402) responsive to an injector (403). In this configuration, a sample containing a quantity of nucleic acids can be deposited on the collection pad (239). Next the injector (403) can be actuated such that the buffer solution (402) is ejected from the reservoir and passes through the collection pad (239) transporting the sample in the solution to the processing chamber (204) of the sample processing assembly (250).

In another embodiment, the amplification device (200) of the invention further includes a fluid injection assembly (400) configured to transmit a fluid, and preferably a buffer solution (402) in response to the first action of the collection handle (238) as described below. As shown in FIG. 57, in this preferred embodiment a buffer solution (402) or other fluid is positioned within a fluid reservoir (401) and separated from the processing chamber (204) by a fluid seal (405). A lancet (407) is positioned adjacent to the fluid seal (405) that when punctured allows the buffer solution (402) to be transmitted to the processing chamber (204) to be mixed with the sample prior to transmission to the reaction chamber (213). The fluid reservoir (401) of the invention further includes a buffer plug (404) positioned above the buffer solution (402)) configured to prevent fluid from leaking out of the reservoir (401), for example in the event the amplification device (200) is inverted or otherwise moved from an approximately upright position. Further, in some embodiment a fluid plunger (not shown) can be positioned above the buffer plug (404).

As further shown in FIG. 57, the fluid reservoir (401) of the invention is coupled with a gasket (406), which is preferably made of a compressible material allowing the fluid reservoir (401) to be depressed in response to the first action of the collection handle (238) as described herein. In this embodiment, the secondary arm (243) of the collection handle (238) is positioned so as to be inserted into the fluid reservoir (401) causing the plug (207), and optionally a plunger (not shown) to be depressed as a result of this first action of the collection handle (238). This first action generates a downward force on the fluid reservoir (401) thereby compressing the gasket (406) such that the fluid seal (405) is punctured by a lancet (407) positioned below the seal and allowing the buffer solution (402), or other solution to be transmitted to the processing chamber (204) to be mixed with the sample prior to transmission to the reaction chamber (213).

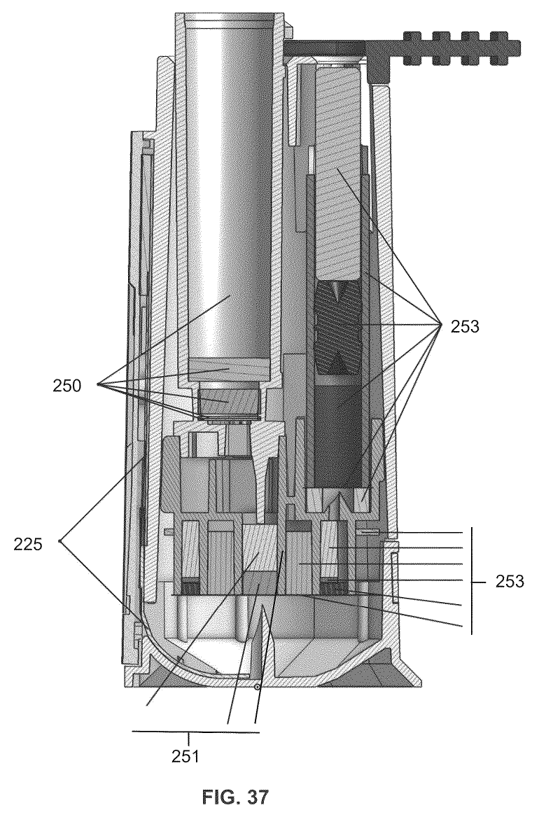

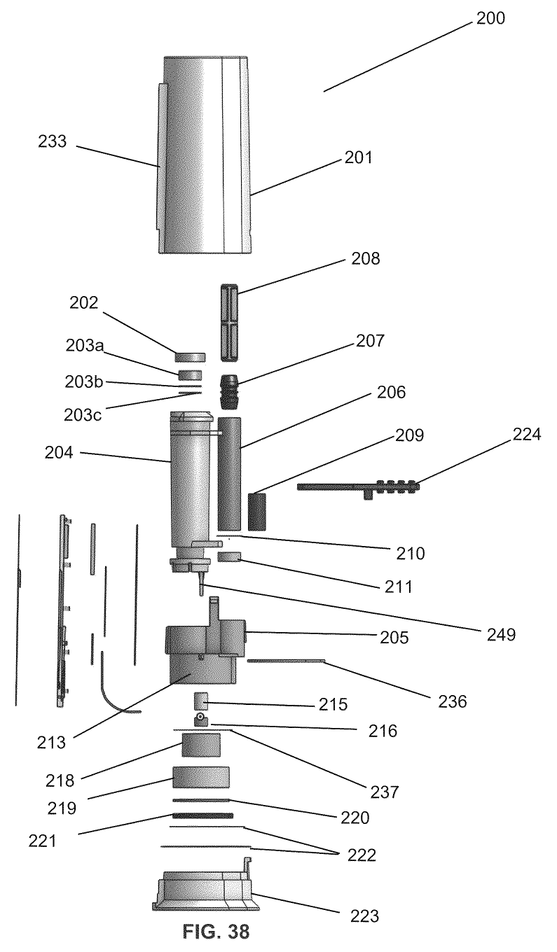

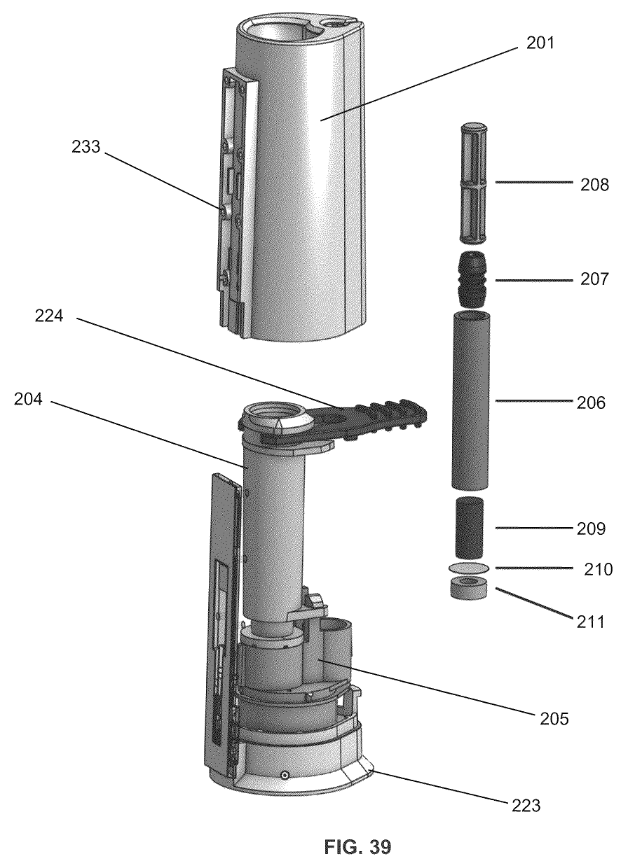

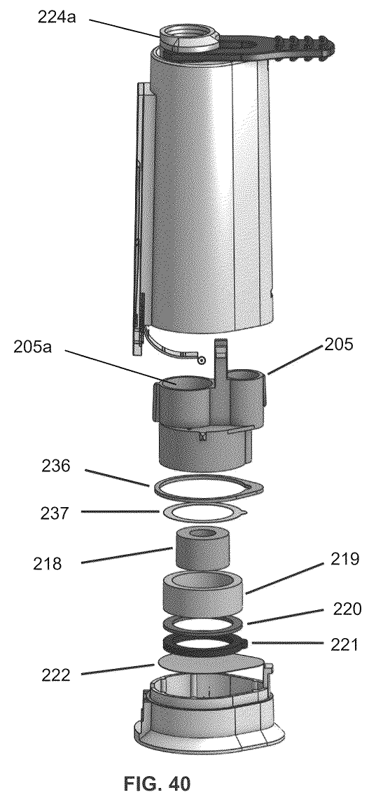

The amplification device (200) of the invention includes a processing chamber (204). As shown in the embodiment highlighted in FIG. 37, the processing chamber (204) of the invention is configured to receive the sample, for example through a collection handle (238) or by directly depositing the sample therewith. As showing in FIG. 1A, the processing chamber (204) is positioned within a housing (201) forming an internal compartment. In this embodiment, the collection handle (238) can be stored within the processing chamber (204) and sealed as described above to prevent contamination prior to use. Moreover, the collection handle (238) can be removed from the processing chamber (204) and used to collect a sample, for example via the collection pad (239) as described above and once inserted back into the device, generate a seal such that the downward movement of the collection handle (238) and seal (240) acts as a plunger generating an internal pressure differential that forces the sample through a processing assembly (250) and into the amplification assembly (251) as detailed below. Notably, while this embodiment shows the processing chamber (204) and housing (201) as separable components, in certain alternative embodiments the processing chamber (204) and housing (201), among other elements described herein, may comprise integral components forming a unitary or semi-unitary device.

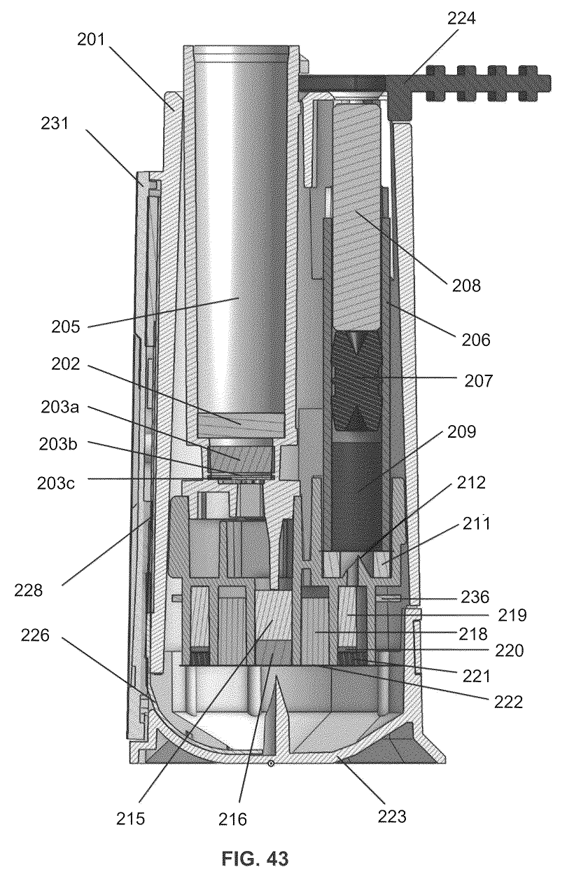

The amplification device (200) of the invention includes a lysis pad (202) in one preferred embodiment. As shown in FIG. 43, the lysis pad (202) of the invention is positioned within the processing chamber (204) such that it can be in fluid communication with the specimen transmitted from the collection pad (239) or deposited directly into the internal compartment of the processing chamber (204). In this embodiment, the lysis pad (202) of the invention contains a lyophilized buffer that is adapted to cause the lysis of cells and optionally the inactivation of RNases in the sample. In a preferred embodiment, the lyophilized buffer of the invention may include the lysis buffer formulation identified as Buffer 21 (5 mM TCEP-HCl, 7.5% Tween-20, 0.00167% Digitonin), and optionally a portion or lyophilized murine RNase inhibitor (mRI). In a preferred embodiment, the lysis buffer can include a solution containing 1.5% Tween-20 and 3.0% sucrose. Additional exemplary alternative lysis buffer formulations are provided in Table 10 below. Notably, for samples that do not contain, or do not require cell lysis, the lysis pad of the invention can be omitted. Moreover, lysis buffers for the lysis of various cell, whether eukaryotic, prokaryotic, fungi, or plant cells would be known by those of ordinary skill in the art.

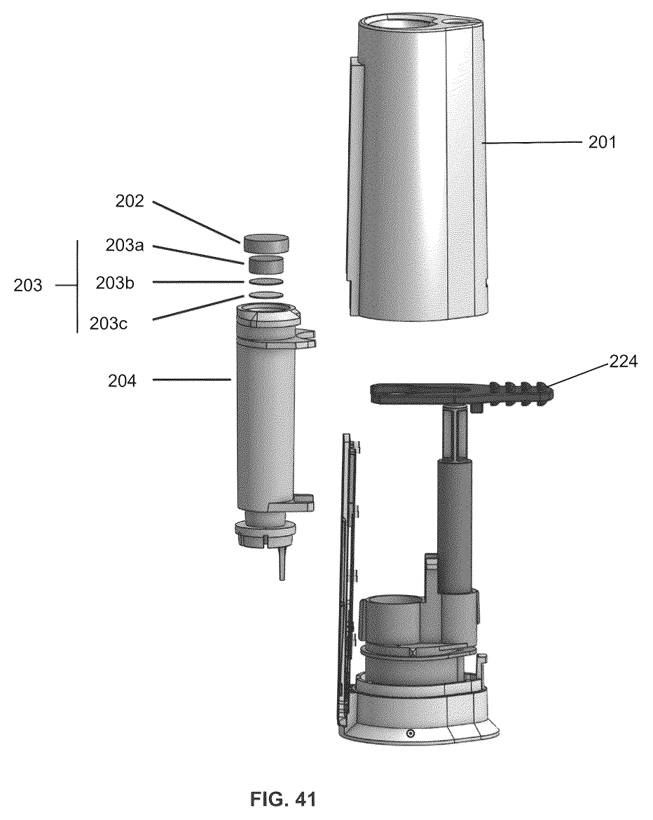

The amplification device (200) of the invention includes one or a plurality of filters (203a, 203b, 203c), which may be positioned within the processing chamber (204) adjacent to the lysis pad (202). As shown in the embodiment highlighted in FIG. 41, the filter (111) of the invention may include one or more, filters, generally being referred to as a filter stack, positioned adjacent to a column portion (not shown) containing a chelating agent configured to prevent positively charged molecules in the sample, such as divalent cations and positively charged macromolecules from inhibiting DNA polymerase and reverse transcriptase enzymes used in later isothermal amplification steps. As further described below, flow of the sample, and in particular a saliva sample through the filter (203) of the invention reduces viscosity and improves the overall flow of sample through the device (100).

Again, referring to FIG. 41, the filter (203) of the invention may include a first and second filter (203a, 203b) sandwiched between a column portion (not shown) containing an agent, such as a chelating agent configured to inhibit divalent cations and positively charged molecules in the sample from inhibiting downstream isothermal amplification. In a preferred embodiment, the column portion (not shown) may include a quantity of Chelex-100, which may further be in the form of a resin. As used herein, Chelex 100 is a chelating material from used to purify other compounds via ion exchange. It is noteworthy for its ability to bind transition metal ions. It is a styrene-divinylbenzene co-polymer containing iminodiacetic acid groups.

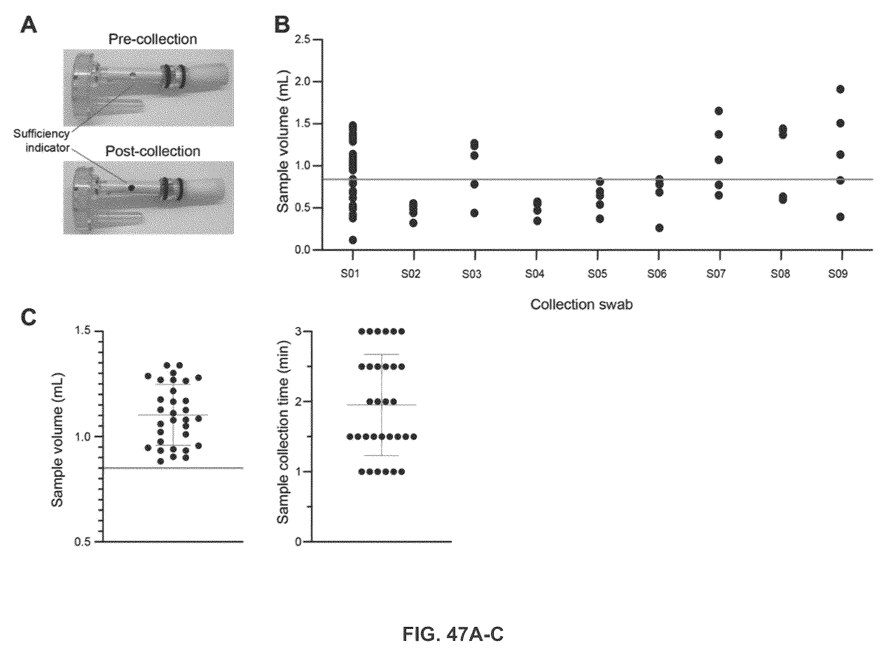

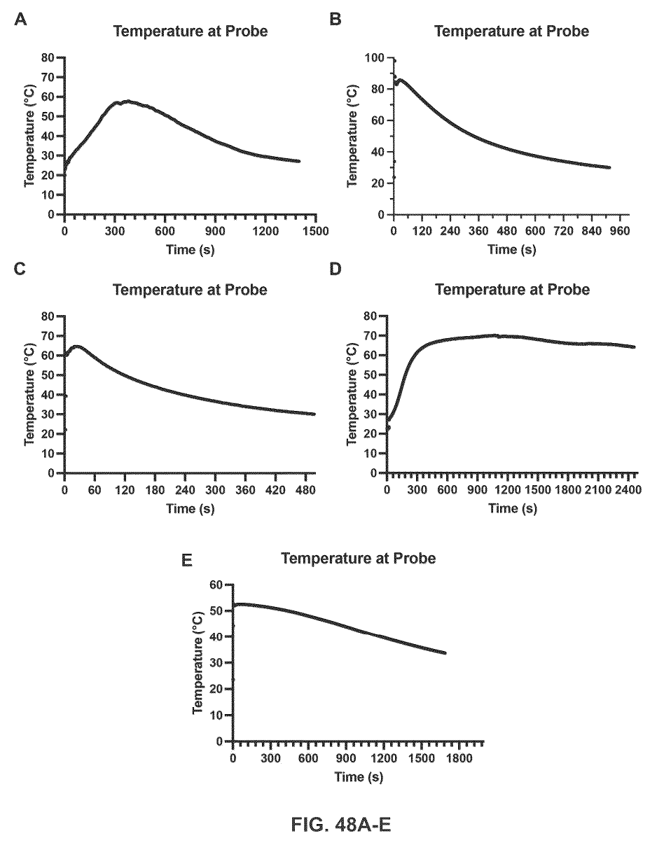

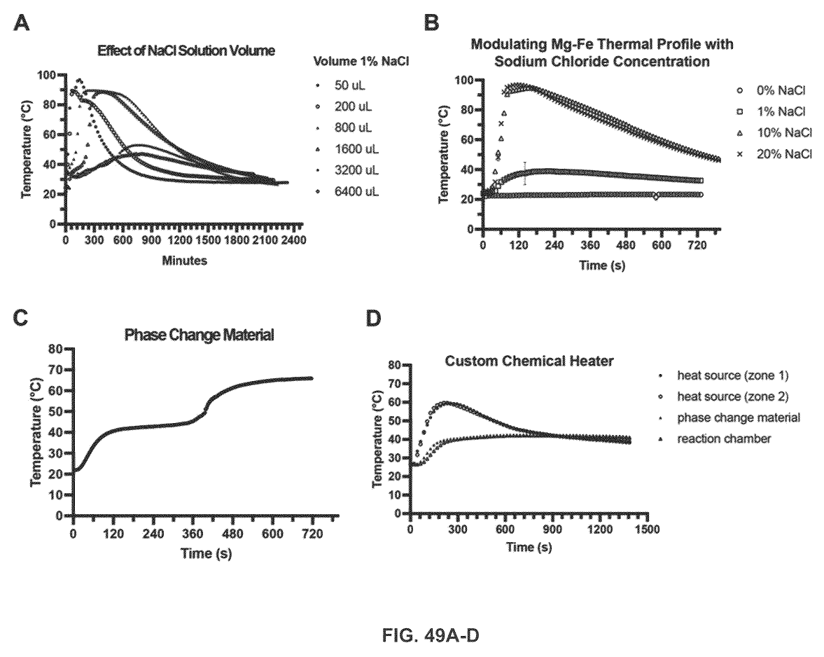

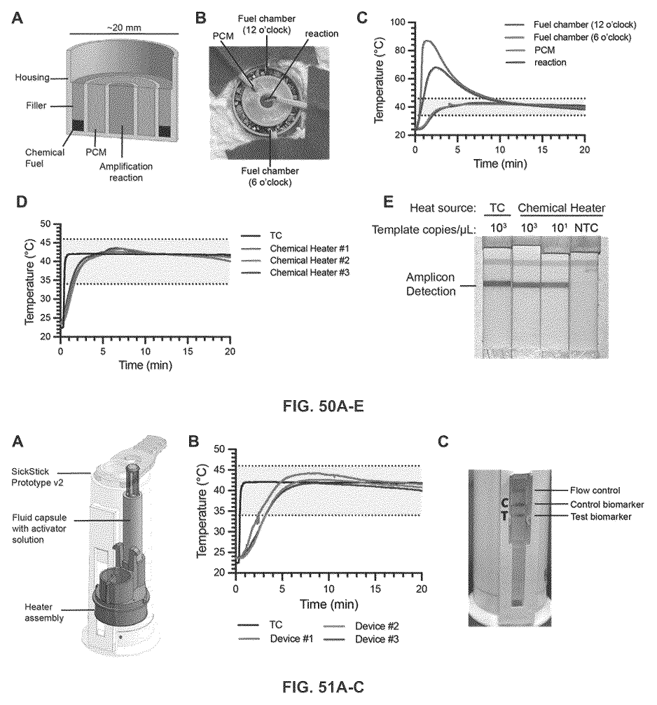

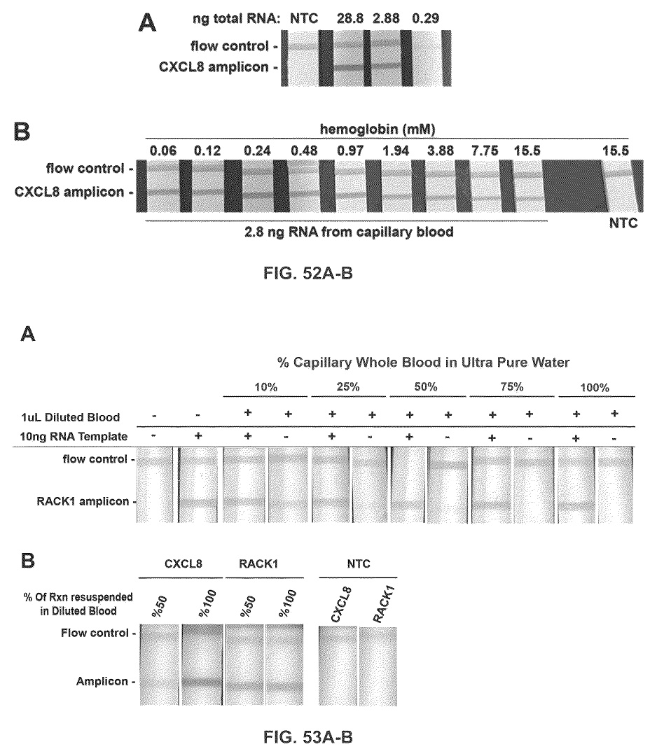

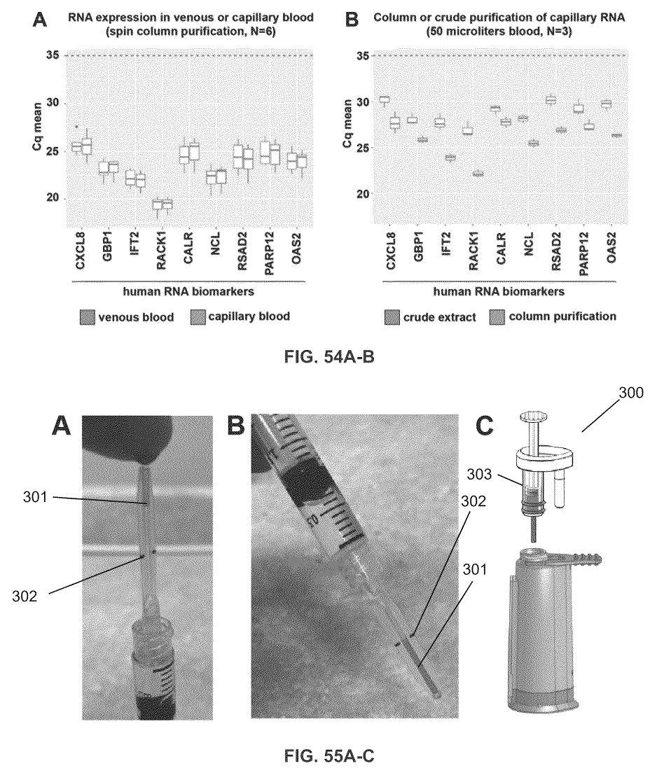

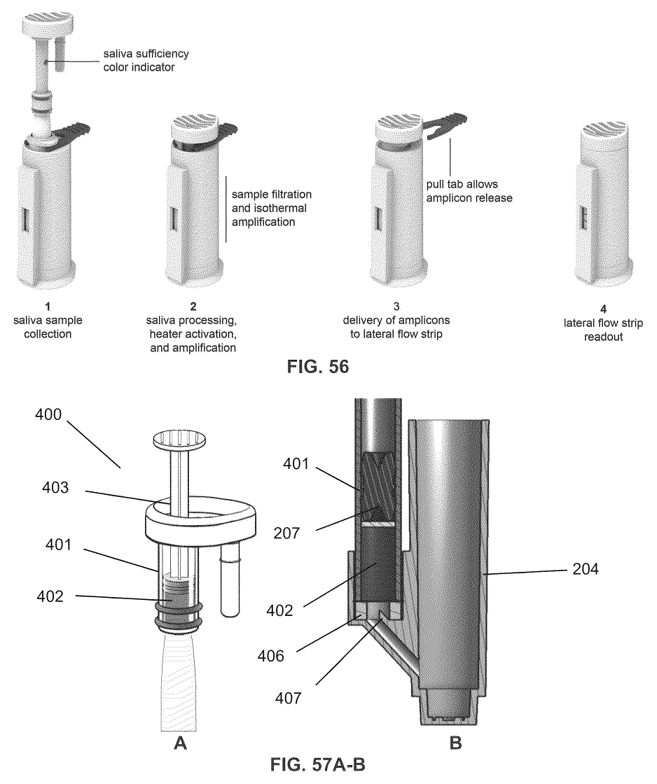

As further shown in the preferred embodiment of FIG. 47, the first and second filters (203a, 203b) of the filter stack may include different filtering sizes. In this preferred embodiment, the first upper filter (203a) may include a larger filter size than the lower second filter (203b). For example, in a preferred embodiment shown in the figures, the first upper filter (203a) may include a filter size of approximately 10 μm, while the lower second filter (203b) may include a filter size of approximately 1 μm. In this configuration, the Chelex-100 resin positioned between the two filters (203a, 203b) is prevented from passing through the second filter (203c), which prevents it, or other chelating agents from interacting with the magnesium required for downstream isothermal amplification, preferably by RT-RPA or RPA. Moreover, the column portion (not shown), containing a chelating agent such as Chelex-100, can be desiccated prior to packing into the filter stack. This step minimizes the creation of air pockets with the filter stack.

Notably, in still further embodiments, a third filter (203c) may be included in the filter stack. In this embodiment, the third filter (203c) of the invention is positioned below the second filter (203b), and my further have a filter size that is smaller than the second filter (203b). In a preferred embodiment, the third filter (203c) of the invention can have a filter size of approximately a 0.4 μm or less. Placement of the third filter (203c) below the second filter (203b) allows trapped air to vent through the dried column portion prior to the flow of the sample and further encourages a more efficient rehydration of the resin.

The amplification device (200) of the invention includes an amplification assembly (251). In a preferred embodiment, a transfer channel positioned below the filter (203) is adapted to transmit the processed and filtered sample to a reaction housing (205) having a reaction chamber (213) containing a transfer pad (215) positioned adjacent to an amplification pad (216). In this embodiment, a sample passes from the collection pad (239) through the lysis pad (202), and filter (203) and enters the reaction chamber (213) where it is transmitted, for example via a wicking action to the transfer pad (215). The sample is next transferred to an amplification pad (216) that is positioned adjacent to, and in fluid communication with the transfer pad (215). As noted in the figures, in this configuration the force of gravity, as well as the internal pressure generated by the collection handle (238) cause the sample to be collected thereby allowing a “front” of lysed sample to be more efficiently wicked by the un-processed sample into the transfer pad(s) (215) and then pushed forward into the amplification pad (216) and ultimately the lateral flow assay (225) as shown below. In one embodiment, the reaction housing (205) can contain an overflow reservoir (205a) configured to allow excess sample or other fluid, such as a buffer solution, to flow to excessive pressure created within the amplification assembly (251).

As noted above, the amplification device (200) of the invention includes a transfer pad (215) adapted to accept the sample from the sample processing assembly (250) and transmit it towards an amplification pad (216) embedded with amplification reagents, and preferably lyophilized isothermal amplification reagents. In this embodiment, the transfer pad (215) and amplification pad (216) are formed from a sufficiently porous material so as to rapidly absorb the sample and prevent mixing of the lysed and un-lysed sample to maintain a “front” of lysed sample along the processing path toward the lateral flow assay (225) described below. In a preferred embodiment, the amplification pad (215) of the invention contains a lyophilized reaction buffer and enzymes for the amplification of nucleic acids, such as human biomarkers of infection utilizing RT-RPA or other isothermal amplification methods such as RPA described herein.

In a preferred embodiment, the transfer pad (215) of the invention is further embedded with a quantity of magnesium, preferably in the form of magnesium acetate (MgOAc). This magnesium is taken up by the sample and such that the magnesium acetate prevents the inactivation of the isothermal amplification reaction. Notably, descriptions and methods of performing isothermal amplification, including components necessary for isothermal amplification including various primers, and RNA biomarkers, and other isothermal amplification systems are described by Sawyer et al, in U.S. patent application Ser. No. 17/686,387 and are herein incorporated by reference.) The components needed to perform RT-RPA, RPA, or other methods of isothermal amplification can be further lyophilized on the distal end of the amplification pad (216) to reduce required reagent volumes and generate a reserve of sample flow behind the reaction to enable dilution for flow to the lateral flow assay (225).

In other embodiments, the amplification pad (216) can be formed of a porous materials impregnated and dried with amplification reagents and optimized excipients, such as 0.1% Tween-20, 2% sucrose, 1% mannitol, one or more primers for the amplification of control and a target nucleic acid as well as optionally RNase inhibitors, such as mRI. as well as optionally RNase inhibitors, such as mRI.

In another embodiment, the amplification pad (216) can be pretreated to prevent non-specific, or undesired binding. In this preferred embodiment, prior to the addition of nucleic acid amplification reagents and excipients as well as control and target primers, the amplification pad (216) can be treated with a blocking solution to inhibit non-specific binding. In one preferred embodiment, the blocking solution (not shown) of the invention includes a solution containing a quantity of Bovine Serum Albumin (BSA), Tween-20, and Tris-HCL. In a specific embodiment, the blocking solution (not shown) of the invention includes: a solution of containing 0.2% BSA, 0.1% Tween-20, and 100 mM Tris-HCL pH 8.3.

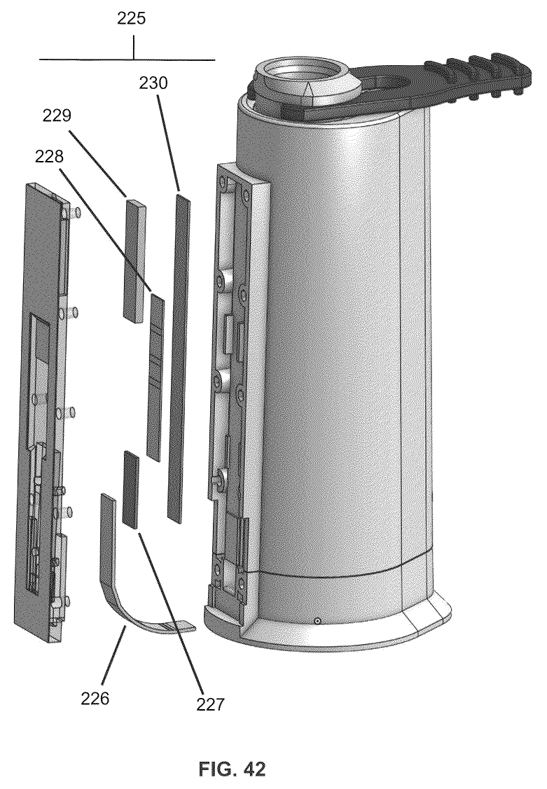

Referring again to FIG. 42, the amplification device (200) of the invention includes a lateral flow assay (225) that can be placed in fluid communication with an amplification assembly (251), as noted above in response to the second action of the collection handle (238). The isothermal amplification reaction of the amplification pad (216) may require a specified reaction time to generate sufficient amplified nucleic acids, also referred to as amplification products or amplicons, for later detection. As shown in the preferred embodiment of FIG. 43, depression of the collection handle (238) is calibrated to a first action being the length of traverse sufficient to deposit the sample in the sample processing and amplification assemblies (250, 251). As described above, the first action of the collection handle (238) caused to be depressed its movement is blocked by a pull tab (224). In a preferred embodiment, the pull tab (224) of the invention is positioned below the collection handle (238) having an extended lip (224a) and secured to the processing chamber (204) such that it blocks the downward traverse of the collection handle (238), also referred to as the first action of the collection handle (238). In this manner, the sample of the invention can be transmitted from sample processing and amplification assemblies (250, 251) by the first action of the collection handle (238) where the isothermal amplification reaction is allowed to progress until the second action of the collection handle (238).

As shown in FIG. 47, an amplicon seal (222) is positioned between the reaction chamber (213) and the lateral flow assay (225) thereby physically separating the amplification products generated in the amplification pad (216) from coming into contact with the lateral flow assay (225) until the second action (238) of the collection handle is performed. In this embodiment, the pull tab (224) of the invention is decoupled or otherwise removed thereby allowing the collection handle (238) to be further depressed. This further depression of the collection handle (238) causes the sample processing and amplification assemblies (250, 251) to be pushed downward causing a lancet (235) to engage and puncture the amplicon seal (222) thereby allowing the amplification products to be transmitted to a baseplate reservoir (223) wherein it can be contacted by an assay transfer pad (226). Notably, in one embodiment, a compression foot (249) can be positioned adjacent to the reaction chamber (213) to provide a backstop for compression of the transfer and amplification pads (215, 216).

Referring again to FIG. 42, the assay transfer pad (226) of the invention can be formed by a glass fiber, or other material that allow the wicking transfer of amplification products released by the lancet (235) from the amplification pad (216). In this preferred embodiment, the assay transfer pad (226) of the invention can be positioned such that a portion of the pad is placed on the bottom surface of the baseplate reservoir (223). In this configuration, the assay transfer pad (226) is in fluid communication with a lateral flow assay (225) such that capillary action transfers the amplification products from said assay transfer pad (226) to a lateral flow assay (225). In preferred embodiment, the lateral flow assay (225) includes a conjugate pad in fluid communication with a membrane (228) which is further in fluid communication with an absorbent pad (229), all of which can be secured to a backing (230) support. In this embodiment, a cover (230) can secure the lateral flow assay (225) components in whole or in part in place and protects it from environmental exposure, while containing a transparent window (232) for visual observation of the test results. Moreover, the cover (230) can generate a pressure gradient for consistent flow of amplification products from the sample across the lateral flow assay (225), regardless of orientation. In another embodiment, the lateral flow assay (225) of the invention can be mounted to the housing (201), such that the assay, including the membrane (228) showing the assay results can be removed for further processing or recordation.

Exemplary methods, systems, and apparatus for the use and detection of amplified products using a lateral flow assay (225) resulting from an isothermal reaction, such as RT-RPA or RPA are described above, and further described by Sawyer et al, in U.S. patent application Ser. No. 17/686,387 and are herein incorporates by reference.)

The amplification device (200) of the invention includes a heater assembly (253) thermally coupled to the amplification assembly (251). In one embodiment, the heater assembly (253) of the invention generates heat at a constant temperature as a consequence of the liquid form of the exothermic phase change material (218) being in equilibrium with the solid form of the exothermic phase change material (218). In this embodiment, a quantity of a phase change material (218) and exothermal fuel (220) are placed in reaction chamber (213) so as to be thermally coupled with the amplification pad (216). As shown in FIG. 43, the transfer and amplification pads (215, 216) are positioned in the central portion of the reaction chamber (213). A quantity of a phase change material (218), such as Rubitherm RT44HC, is positioned adjacent to the transfer and amplification pads (215, 216) so as to be thermally coupled. A quantity of exothermic fuel (220), such as dry magnesium-iron (Mg—Fe) alloy can be supported by a cap (221) and further positioned adjacent to the phase change material (218) so as to also be thermally coupled. In a preferred embodiment a quantity of filler (219), such as sand, vermiculite or other similar compounds is positioned adjacent to or mixed with the exothermic fuel (220) to generate a fuel component for the exothermic reagent (209), such as a salt solution as described below.

When the exothermic fuel (220) comes into contact with an exothermic reagent (209) an exothermic reaction is initiated, the heat from which causes the phase change material (218) to reach a pre-determined temperature thereby heating the isothermal amplification of the amplification pad (216). More specifically, phase change material (218) is configured to provide a controlled, substantially constant temperature to the reaction chamber (213) for the amplification reaction by being at least partially converted from its solid form to its liquid form when heated by an exothermic chemical reaction generated by the exothermic fuel (220) and the exothermic reagent (209). In one embodiment the phase change material (218) includes a quantity of a paraffin, while in other embodiments the phase change material (218) can be selected from a metal, an inorganic compound, an inorganic eutectic and an organic compound. Additional phase change materials and exothermic fuels and exothermal reagents are described in U.S. Pat. No. 8,431,387, which is incorporated herein by reference.

The heater assembly (212) of the invention is responsive to a heater activation assembly (252). In the preferred embodiment, the heater activation assembly (252) of the invention includes comprising an exothermic reagent (209) positioned within a reagent syringe (206) and separated from the heater assembly by a reagent seal (210), that when punctured allows the exothermic reagent (209) to be transmitted to the heater assembly (212) where it contacts the exothermic fuel (220) causing an exothermic reaction. In a preferred embodiment, the exothermic reagent (209) is released and transmitted to the heater assembly (212) in response to the first action of the collection handle (238). As shown in FIGS. 42-42, the reagent syringe (206) of the invention includes an exothermic reagent (209), such as a sodium salt solution, that is secured in the body of the syringe by a reagent seal (210) preventing it from being transmitted to the heater assembly (212). The reagent syringe (206) of the invention further includes a plug (207) positioned above the exothermic reagent (209) configured to prevent the exothermic reagent (209) from leaking out of the syringe, for example in the event the amplification device (200) is inverted or otherwise moved from an approximately upright position. Further, in some embodiment a plunger (208) can be positioned above the plug (207).

As further shown in FIG. 42, the reagent syringe (206) of the invention is coupled with a gasket (211), which is preferably made of a compressible material allowing the reagent syringe (206) to be depressed in response to the first action of the collection handle (238). In this embodiment, the secondary arm (243) of the collection handle (238) is positioned so as to be inserted into the reagent syringe (206) causing the plug (207), and optionally a plunger (208) to be depressed as a result of this first action of the collection handle (238). This first action generates a downward force on the reagent syringe (206) thereby compressing the gasket (211) such that the reagent seal (210) is punctured by a lancet (212) positioned below the seal and allowing the exothermic reagent (209) to be transmitted to the heater assembly (253).

As further shown in FIG. 42, the amplification device (200) of the invention includes an absorbent collar (236) positioned adjacent to the reaction housing (205) and configured to absorb any exothermic reagent that that may escape the heater assembly (253). As also shown in FIG. 42, the amplification device (200) of the invention includes a frit (237) positioned over the heater assembly (253), and in particular above the exothermic fuel (220), and preferably adjacent to the filler (219) and can contain heater assembly (253) components necessary to generate an exothermic reaction, such as sand and magnesium iron while still allowing the exothermic reagent (209) (sodium chloride solution) to enter the assembly and conversely allow gas generated by the exothermic reaction to escape.

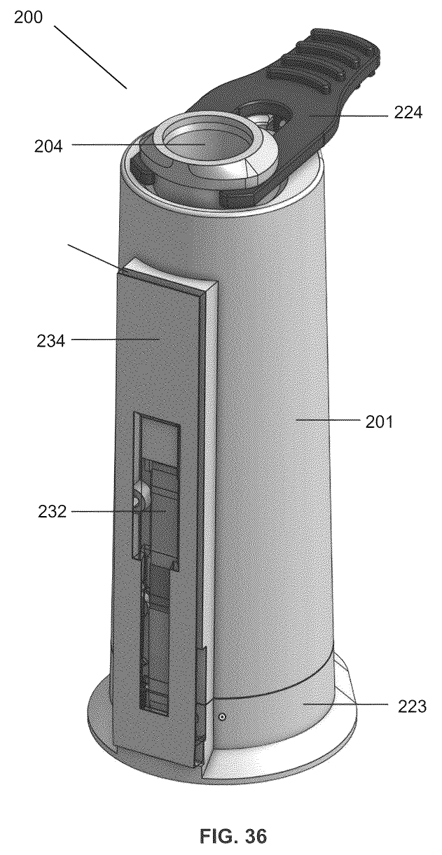

Notably, as shown in FIG. 36, the pull tab (224) of the invention includes an aperture configured to allow the secondary arm (243) of the collection handle (238) to pass through the tab and be inserted into the reaction syringe such that it can compete the first sequential depression step of the collection handle (238) as generally described herein.

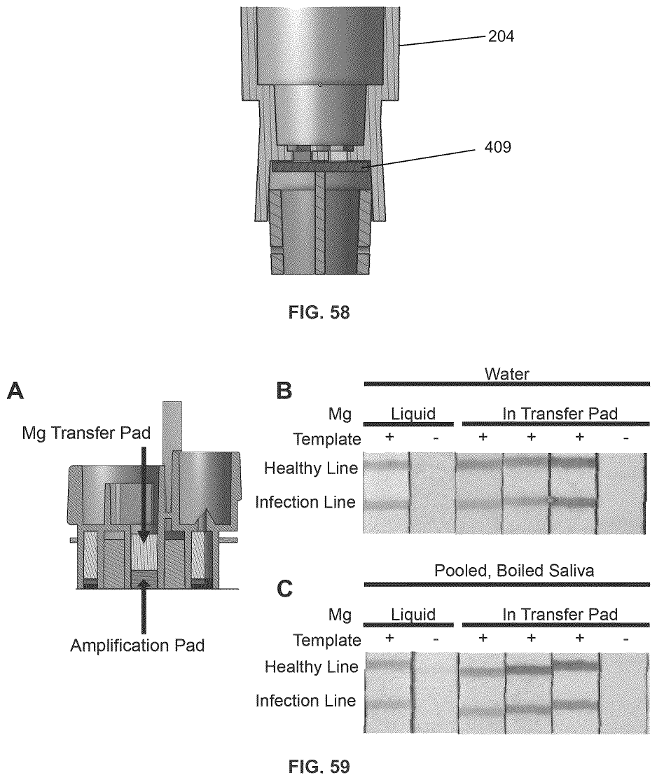

As shown in FIG. 58, the amplification device (200) of the invention includes a check valve (409). In this embodiment, the check valve (409) is positioned between the filter (203) and reaction chamber (213) containing the transfer and amplification pads (215, 216). In this configuration, the check valve (409) of the invention contains any liquid in the sample once it has passed through to the filter into the reaction chamber (213). This allows the amplification device (200) to be inverted or tipped during use without causing a leakage, losing material, or invalidating the assay due to backflow contamination of the sample.

The terminology used herein is for describing embodiments and is not intended to be limiting. As used herein, the singular forms “a,” “and” and “the” include plural referents, unless the content and context clearly dictate otherwise. Thus, for example, a reference to “a biomarker” may include a combination of two or more such biomarkers. Unless defined otherwise, all scientific and technical terms are to be understood as having the same meaning as commonly used in the art to which they pertain. As used herein, “about” or “approximately” means within 10% of a stated concentration range or within 10% of a stated time frame.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Nucleic acids and/or other moieties of the invention may be isolated or “extracted.” As used herein, “isolated” means separate from at least some of the components with which it is usually associated whether it is derived from a naturally occurring source or made synthetically, in whole or in part. Nucleic acids and/or other moieties of the invention may be purified. As used herein, purified means separate from the majority of other compounds or entities. A compound or moiety may be partially purified or substantially purified. Purity may be denoted by weight measure and may be determined using a variety of analytical techniques such as but not limited to mass spectrometry, HPLC, etc.

The term “primer,” as used herein, refers to an oligonucleotide capable of acting as a point of initiation of DNA synthesis under suitable conditions. Such conditions include those in which synthesis of a primer extension product complementary to a nucleic acid strand is induced in the presence of four different nucleoside triphosphates and an agent for extension (for example, a DNA polymerase or reverse transcriptase) in an appropriate buffer and at a suitable temperature.

A primer is preferably a single-stranded DNA. The appropriate length of a primer depends on the intended use of the primer but typically ranges from about 6 to about 225 nucleotides, including intermediate ranges, such as from 15 to 35 nucleotides, from 18 to 75 nucleotides and from 25 to 150 nucleotides. Short primer molecules generally require cooler temperatures to form sufficiently stable hybrid complexes with the template. A primer need not reflect the exact sequence of the template nucleic acid but must be sufficiently complementary to hybridize with the template. The design of suitable primers for the amplification of a given target sequence is well known in the art and described in the literature cited herein.

As used herein, a biological marker (“biomarker” or “marker”) is a characteristic that is objectively measured and evaluated as an indicator of normal biologic processes, pathogenic processes, or pharmacological responses to therapeutic interventions, consistent with NIH Biomarker Definitions Working Group (1998). Markers can also include patterns or ensembles of characteristics indicative of particular biological processes. The biomarker measurement can increase or decrease to indicate a particular biological event or process. In addition, if the biomarker measurement typically changes in the absence of a particular biological process, a constant measurement can indicate occurrence of that process. In a preferred embodiment a biomarker includes one or more RNA transcripts that may be indicative of infection or other normal or abnormal physiological process.

As referred to herein, the terms “nucleic acid”, “nucleic acid molecules” “oligonucleotide”, “polynucleotide”, and “nucleotides” may interchangeably be used. The terms are directed to polymers of deoxyribonucleotides (DNA), ribonucleotides (RNA), and modified forms thereof in the form of a separate fragment or as a component of a larger construct, linear or branched, single stranded, double stranded, triple stranded, or hybrids thereof. The term also encompasses RNA/DNA hybrids. The polynucleotides may include sense and antisense oligonucleotide or polynucleotide sequences of DNA or RNA. The DNA molecules may be, for example, but not limited to complementary DNA (cDNA), genomic DNA, synthesized DNA, recombinant DNA, or a hybrid thereof. The RNA molecules may be, for example, but not limited to: ssRNA or dsRNA and the like. The terms further include oligonucleotides composed of naturally occurring bases, sugars, and covalent internucleoside linkages, as well as oligonucleotides having non-naturally occurring portions, which function similarly to respective naturally occurring portions. The terms “nucleic acid segment” and “nucleotide sequence segment,” or more generally “segment,” will be understood by those in the art as a functional term that includes both genomic sequences, ribosomal RNA sequences, transfer RNA sequences, messenger RNA sequences, operon sequences, and smaller engineered nucleotide sequences that are encoded or may be adapted to encode, peptides, polypeptides, or proteins. All nucleic acid primers, such as SEQ IN NOs. 445-468, are presented in the 5′ to 3′ prime direction unless otherwise noted.

As used herein, “complementary” refers to the ability of a single strand of a polynucleotide (or portion thereof) to hybridize to an anti-parallel polynucleotide strand (or portion thereof) by contiguous base-pairing between the nucleotides (that is not interrupted by any unpaired nucleotides) of the anti-parallel polynucleotide single strands, thereby forming a double-stranded polynucleotide between the complementary strands. A first polynucleotide is said to be “completely complementary” to a second polynucleotide strand if each and every nucleotide of the first polynucleotide forms base-paring with nucleotides within the complementary region of the second polynucleotide. A first polynucleotide is not completely complementary (i.e., partially complementary) to the second polynucleotide if one nucleotide in the first polynucleotide does not base pair with the corresponding nucleotide in the second polynucleotide. The degree of complementarity between polynucleotide strands has significant effects on the efficiency and strength of annealing or hybridization between polynucleotide strands. This is of particular importance in amplification reactions, which depend upon binding between polynucleotide strands. An oligonucleotide primer is “complementary” to a target polynucleotide if at least 50% (preferably, 60%, more preferably 70%, 80%, still more preferably 90% or more) nucleotides of the primer form base-pairs with nucleotides on the target polynucleotide.

As used herein, the term “detection” refers to the qualitative determination of the presence or absence of a microorganism in a sample. The term “detection” also includes the “identification” of a microorganism, i.e., determining the genus, species, or strain of a microorganism according to recognized taxonomy in the art and as described in the present specification. The term “detection” further includes the quantitation of a microorganism in a sample, e.g., the copy number of the microorganism in a microliter (or a milliliter or a liter) or a microgram (or a milligram or a gram or a kilogram) of a sample. The term “detection” also includes the identification of an infection in a subject or sample.

As used herein the term “pathogen” refers to an organism, including a microorganism, which causes disease in another organism (e.g., animals and plants) by directly infecting the other organism, or by producing agents that causes disease in another organism (e.g., bacteria that produce pathogenic toxins and the like). As used herein, pathogens include, but are not limited to bacteria, protozoa, fungi, nematodes, viroids and viruses, or any combination thereof, wherein each pathogen is capable, either by itself or in concert with another pathogen, of eliciting disease in vertebrates including but not limited to mammals, and including but not limited to humans. As used herein, the term “pathogen” also encompasses microorganisms which may not ordinarily be pathogenic in a non-immunocompromised host.

The term “infection,” or “infect” as used herein is directed to the presence of a microorganism within a subject body and/or a subject cell. For example, a virus may be infecting a subject cell. A parasite (such as, for example, a nematode) may be infecting a subject cell/body. In some embodiments, the microorganism may comprise a virus, a bacteria, a fungi, a parasite, or combinations thereof. According to some embodiments the microorganism is a virus, such as, for example, dsDNA viruses (such as, for example, Adenoviruses, Herpesviruses, Poxviruses), ssDNA viruses (such as, for example, Parvoviruses), dsRNA viruses (such as, for example, Reoviruses), (+) ssRNA viruses (+) sense RNA (such as, for example, Picornaviruses, Togaviruses), (−) ssRNA viruses (−) sense RNA (such as, for example, Orthomyxoviruses, Rhabdoviruses), ssRNA-RT viruses (+) sense RNA with DNA intermediate in life-cycle (such as, for example, Retroviruses), dsDNA-RT viruses (such as, for example, Hepadnaviruses). In some embodiments, the microorganism is a bacteria, such as, for example, a gram negative bacteria, a gram positive bacteria, and the like. In some embodiments, the microorganism is a fungi, such as yeast, mold, and the like. In some embodiments, the microorganism is a parasite, such as, for example, protozoa and helminths or the like. In some embodiments, the infection by the microorganism may inflict a disease and/or a clinically detectable symptom to the subject. In some embodiments, infection by the microorganism may not cause a clinically detectable symptom. In some embodiments, the microorganism is a symbiotic microorganism. In additional embodiments, the microorganism may comprise archaea, protists; microscopic plants (green algae), plankton, and the planarian. In some embodiments, the microorganism is unicellular (single-celled). In some embodiments, the microorganism is multicellular.

As used herein, the term “asymptomatic” refers to an individual who does not exhibit physical symptoms characteristic of being infected with a given pathogen, or a given combinations of pathogens.

Some embodiments of the invention comprise amplifying nucleic acids from a sample. As used herein, a “sample” can be any quantity of material that includes one or more nucleic acids, and preferably a liquid, semi-liquid or otherwise flowable sample that includes one or more nucleic acids. Examples include environmental samples, such as water, soil, and industrial samples as well as waste streams and the like. In additional embodiments, the sample may be a pharmaceutical sample containing an isolated or complex mixture of nucleic acids, and in particular therapeutic nucleic acids and the like. Further samples include biological samples, which may include prokaryotic as well as eukaryotic samples, as well as plant, fungi and/or isolated nucleic acids of the same.

As used herein, the term “biological sample” includes a sample from any bodily fluid or tissue. Biological samples or samples appropriate for use according to the methods provided herein include, without limitation, blood, serum, urine, saliva, tissues, cells, and organs, or portions thereof, as well as isolated nucleic acid samples derived from a subject, or other organism, such as a bacterium, plant, fungi or other cell. A “subject” is any organism of interest, generally a mammalian subject, and preferably a human subject. Some embodiments of the invention comprise detecting in a sample from a patient, a level of a biomarker, wherein the presence or expression levels of the biomarker are indicative of infection or possible infection by one or more pathogens.

Any isothermal amplification protocol can be used according to the methods provided herein. Exemplary types of isothermal amplification include, without limitation, Reverse-Transcription Recombinase Polymerase Amplification (RT-RPA); nucleic acid sequence-based amplification (NASBA), loop-mediated isothermal amplification (LAMP), Reverse transcription loop-mediated isothermal amplification (RT-LAMP), strand displacement amplification (SDA), helicase-dependent amplification (HDA), nicking enzyme amplification reaction (NEAR), signal mediated amplification of RNA technology (SMART), rolling circle amplification (RCA), isothermal multiple displacement amplification (EVIDA), single primer isothermal amplification (SPIA), recombinase polymerase amplification (RPA), and polymerase spiral reaction (PSR), available at nature.com/articles/srep12723 on the World Wide Web). In some cases, a forward primer is used to introduce a T7 promoter site into the resulting DNA template to enable transcription of amplified RNA products via T7 RNA polymerase. In other cases, a reverse primer is used to add a trigger sequence of a toehold sequence domain.

As used herein, the term “amplified” refers to polynucleotides that are copies of a particular polynucleotide, produced in an amplification reaction. An amplified product, according to the invention, may be DNA or RNA, and it may be double-stranded or single-stranded. An amplified product is also referred to herein as an “amplicon”. As used herein, the term “amplicon” refers to an amplification product from a nucleic acid amplification reaction. The term generally refers to an anticipated, specific amplification product of known size, generated using a given set of amplification primers.

As used herein, the term “lateral flow assay” means an assay where the sample flow takes place at least partly parallel to a surface through which the sample and/or chemical or physical phenomena contributed by the sample can be optically imaged.

The invention now being generally described will be more readily understood by reference to the following examples, which are included merely for the purposes of illustration of certain aspects of the embodiments of the present invention. The examples are not intended to limit the invention, as one of skill in the art would recognize from the above teachings and the following examples that other techniques and methods can satisfy the claims and can be employed without departing from the scope of the claimed invention. Indeed, while this invention has been particularly shown and described with references to preferred embodiments thereof, it will be understood by those skilled in the art that various changes in form and details may be made therein without departing from the scope of the invention encompassed by the appended claims.

### EXAMPLES

### Example 1: Diagnostic Device Overview

As noted above, in a preferred embodiment, the diagnostic device of the invention describes a self-contained device that uses a minimalistic approach to process saliva for biomarker amplification, as well as an amplification method that operates at a single, low temperature (near body temperature), and an integrated lateral flow assay for readout of amplification. In a preferred embodiment, the diagnostic device of the invention can include a plurality of injection molded parts, porous pad materials embedded with lyophilized sample processing reagents, a filter stack, and a lateral flow assay (LFA) (FIGS. 1B and 1C).

### Example 2: Saliva Sample Collection and Initial Processing

As described in FIG. 1, in a preferred embodiment, a biological sample, such as preferably a saliva sample is collected by holding an absorbent material in the mouth of a subject for a defined amount of time, then expressing the biological sample from the material by inserting and compressing it within the device of the invention. Initial evaluations defined the saliva collection volume requirements to be at least 1.0 mL of saliva. Sample collection less than 1.0 mL results in an undersaturation of the amplification pad material and therefore an insufficient volume to run the lateral flow strip. The present inventors initially selected a 30 mm×8 mm collection pad sourced from Porex, made from a porous high release media (HRM) polypropylene/polyethylene (PP/PE) blend. This material was tested by performing a direct oral saliva collection (the swab was held in the mouth with mass measured after each minute of collection to calculate volume absorbed). This material collected less than 1.0 mL of saliva across multiple individuals; therefore, it was determined that saliva collection pad materials and dimensions would need to be further optimized to accommodate the volume requirements of the device.

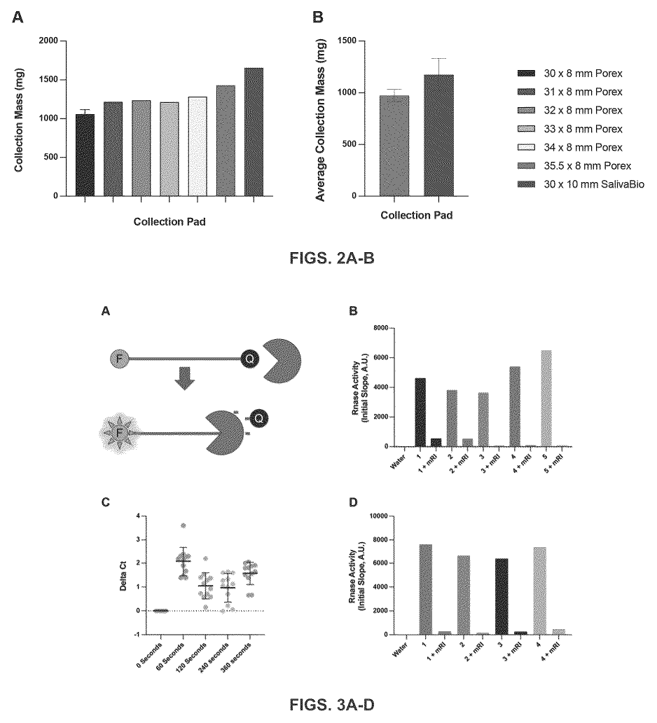

Seven additional collection pad materials of varying dimensions, densities, and compositions were screened for reliable direct oral saliva collection of volumes greater than 1.0 mL (Table 1). The maximum collection capacity of each material was determined by submerging the collection material into phosphate buffered saline (PBS) and measuring volume absorbed (FIG. 2A). In addition, maximum oral collection volume across individuals was tested by holding swabs directly in the mouth until fully saturated and measuring volume absorbed. (FIG. 2B).

Of the materials tested, the Salimetrics SalivaBio Oral Swab (SOS) material had the greatest capacity for volume collection, with a maximum absorption volume of 1.6 mL. Additionally, this material consistently absorbed greater than 1.0 mL during direct oral saliva collection. The 35.5 mm×8 mm Porex HRM fiber media collected sufficient volume during PBS dip testing but was unable to reliably collect greater than 1.0 mL during direct oral collections. Because the 35.5 mm×8 mm size failed to absorb sufficient saliva, smaller dimensions of the same material were not tested. Of the seven materials screened, the 30 mm×10 mm Salimetrics SOS met all the requirements and was therefore selected for integration into an initial embodiment of the diagnostic device of the invention.

### Example 3: Monitoring RNase Activity and Optimizing Inhibition

The present inventor sought to monitor RNase activity in exemplary saliva samples and optimize RNase inhibition of the same. Notably, saliva contains an abundance of RNases and restricting the activity of these enzymes is critical, as they degrade the RNA templates targeted by the device of the invention. Limiting RNase activity allows time for reverse transcriptase to synthesize complementary DNA (cDNA) from RNA, thereby providing a template for the RPA reaction. While all saliva samples contain abundant RNases, there is significant variability in the RNase activity across individuals. To measure RNase activity in saliva samples we use the RNase Alert Assay from Invitrogen (cat #AM1964). This assay contains a short, single-stranded RNA (ssRNA) probe with a fluorophore on one end and a quencher on the other. RNases will degrade the ssRNA probe, releasing the quencher and allowing the fluorophore to fluoresce (FIG. 3A).

To determine variability of RNase activity across individuals, the present inventors tested saliva samples from five donors in the RNase Alert Assay with or without the addition of 4 U/μL of murine RNase Inhibitor (mRI, NEB cat #M0314) (FIG. 3B). While there is indeed variability in the RNase activity amongst the five saliva samples, there is less than a 2-fold difference between the highest and lowest activity samples. Importantly, the addition 4 U/μL of mRI reduced the RNase activity in all five samples to negligible amounts, providing an approach to protect saliva RNAs in the device.

In one embodiment, the mRI would be introduced to a saliva sample before lysis to inhibit RNases prior to the release of RNA from cells. In an alternate format, the mRI can be lyophilized in the amplification pad to focus the mRI treatment only on the 100 μl lysis front that is used for amplification, however this approach leaves RNA unprotected for a short period of time between lysis and rehydration of the amplification pad. To determine if the RNA can remain unprotected during this time, we performed reverse transcription-quantitative polymerase chain reaction (RT-qPCR) on a panel of relevant biomarkers to measure the degradation of RNA in the moments after lysis (FIG. 3C). Each timepoint used the same pooled saliva sample but was passed through separate devices of the invention, which introduced some variability across timepoints. We observed a small increase of 1-2 Cycle Threshold (Ct) values in the minutes after lysis, indicating some RNA degradation occurred; however, this is a relatively small loss of RNA and should not affect the ability to amplify target biomarkers.

To confirm that lyophilized mRI in the amplification pad can rehydrate and inhibit saliva RNases, four amplification pads were rehydrated with saliva and the contents of the rehydrated pads were measured in the RNase Alert Assay (FIG. 3D). Nearly complete inhibition of RNase activity was observed from amplification pads rehydrated with saliva, demonstrating an efficient approach to inhibit saliva RNases in the device.

### Example 4: Addressing Additional Amplification Inhibitors in Saliva

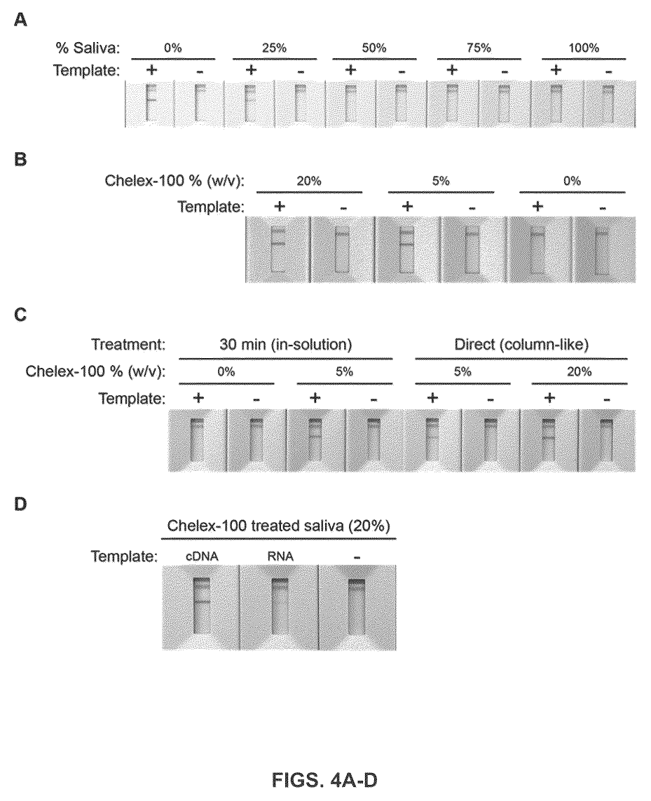

In a preferred embodiment, the collected saliva sample supplies the entire liquid portion needed for reconstitution of reaction components. To identify challenges of using saliva to reconstitute RPA reagents, we monitored RPA efficiency at increasing concentrations of processed saliva. Saliva was expressed from a collection pad, treated with lyophilized lysis buffer, then passed through a 10 μm and 1 μm filter stack. RPA efficiency was monitored using a cDNA template to focus on amplification inhibitors without the compounding impacts of RNase activity. RPA efficiency was maintained with up to 25% (v/v) processed saliva in the reaction, however above 25%, RPA reactions were completely inhibited by the saliva (FIG. 4A).

To identify the amplification inhibitors in saliva, we first ruled out a protein-based inhibitor by heat-treating saliva samples prior to addition into the RPA reactions and saw similar inhibition at increased concentrations of saliva. We additionally ruled out the high abundance of nucleic acids in saliva as the source of inhibition by demonstrating that inclusion of 3 μg of cell line DNA does not inhibit RPA. After ruling out protein and nucleic acid inhibitors, we performed a literature search for additional compounds in saliva that inhibit amplification reactions. We found reports that positively charged molecules in saliva, such as divalent cations and positively charged macromolecules, can be inhibitory to DNA polymerase and reverse transcriptase enzymes, both of which are necessary for amplification in the device of the invention. Previous reports identified Chelex-100 (BioRad cat #1421253) as an effective agent to remove positively charged inhibitors from saliva to yield a sample compatible with amplification. Chelex-100 is a styrene divinylbenzene copolymer resin (wet bead size of 75-150 μm), modified with paired iminodiacetate ions to chelate positively charged molecules.

Chelex-100 was tested for its ability to remove salivary inhibitors of RPA. When saliva was treated with 5% or 20% Chelex-100 (w/v) in solution for 30 minutes, RPA reactions comprised of 95% saliva maintain efficient amplification, while untreated saliva inhibits amplification (FIG. 4B). Chelex-100 remained effective with a brief, direct treatment in which saliva was passed through a packed column of Chelex-100 (FIG. 4C). When treating saliva directly, 20% Chelex-100 (w/v) was advantageous over 5%. We further investigated the efficiency of reverse transcription-RPA (RT-RPA) in saliva treated with 20% Chelex-100. We found that our current selection of reverse transcriptase remained susceptible to inhibitors even after treatment with Chelex-100 (FIG. 4D). Increasing the concentration of reverse transcriptase showed promise to overcome this issue, and we further addressed it by screening for a more inhibitor-tolerant reverse transcriptase, which is described in detail below.

To incorporate a Chelex-100 column into the device of the invention, we packed the beads in-between the 10 μm and 1 μm filters in the filter stack. The large size of the resin prevents Chelex-100 from passing through the 1 μm filter, which is necessary to prevent Chelex-100 from interacting with the magnesium required for the RT-RPA reaction downstream in the device. In a preferred embodiment, the diagnostic device can be packaged dry with desiccant for maximum stability, however the Chelex-100 is supplied in a hydrated form. If allowed to dry within the device, the resin creates air pockets which need to be expelled to remain effective. This can be addressed in two ways: 1) desiccating the Chelex-100 prior to packing into the filter stack minimizes the creation of air pockets, and 2) an additional 0.4 μm filter placed after the 1 μm filter encourages trapped air to vent through the dried Chelex-100 prior to the flow of saliva and encourages a more efficient rehydration of the resin by saliva.

### Example 5: Identification and Optimization of Lysis Pad Material

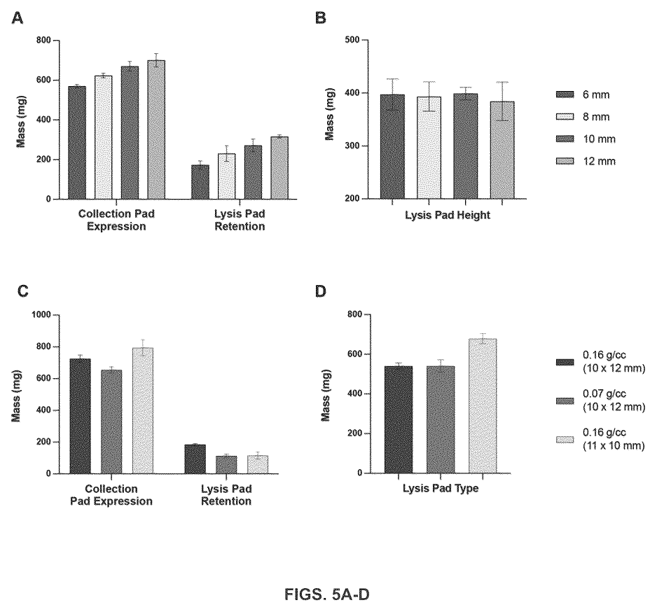

In one embodiment, a lysis buffer is lyophilized into a PP/PE blended fiber pad. Upon insertion of the saliva collection pad into the device, contact is made between the collection pad and the lysis pad, allowing the saliva to pass through and rehydrate the lysis buffer (FIG. 1). To reduce the device volume requirements, multiple lysis pad sizes and fiber densities were tested. We tested 10 mm diameter lysis pads at heights of 6, 8, 10, and 12 mm for sample retention. Shorter lysis pads retained less volume than taller pads yet reduced the overall collection pad compression and sample expression in a height dependent manner (FIG. 5A). These two opposing effects resulted in a volume of sample entering the downstream components of the device that did not change when the height of the lysis pad was modified (FIG. 5B).

Volume retention tests were also performed across pad densities (0.07 g/cc vs 0.16 g/cc) and a wider diameter (FIGS. 5C and 5D). As observed when adjusting pad heights, lower density materials retained less volume but also resulted in lower sample expression from the collection pad. Increasing the diameter to 11 mm resulted in reduced sample retention with an increased expression from the collection pad, and ultimately an optimal delivery volume to the remainder of the device. The 11 mm diameter also prevents sample from flowing around the lysis pad, ensuring that all sample must contact the lysis pad as it moves through the device. Thus, the 11 mm×10 mm, 0.16 g/cc density lysis pad displayed optimal expression and retention characteristics while ensuring sample passage through the material and was therefore selected for integration into the device.

### Example 6: Maintenance of a Lysed Sample Front

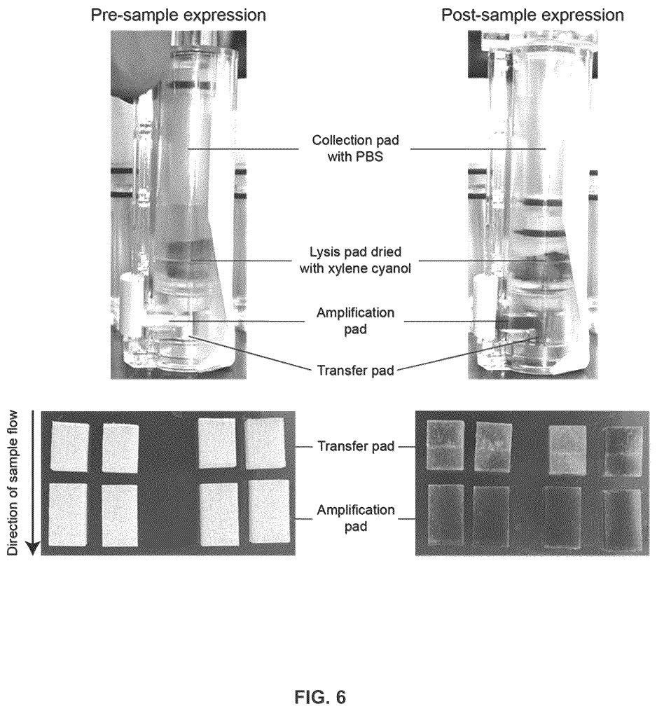

To minimize the volume of pad material used in the device as well as the overall device dimensions, the lysis pad is designed to lyse only the first 0.5 mL of saliva expressed from the collection pad. The lysed sample is then followed by additional un-lysed saliva, creating a “front” of lysed sample that must be maintained until arriving at the amplification reaction in the device. To determine feasibility of maintaining a lysis front in the device, xylene cyanol dye was dried into lysis pads and the location of dye after sample processing was monitored (FIG. 6). Using this proxy for a sample lysis front, we demonstrated that sample expressed through the lysis pad reconstitutes reagents dried into the pad, and these reagents are pushed downstream through the device with additional sample from the collection pad. The transfer pad and amplification pad absorb sample rapidly and prevent mixing of the lysed and un-lysed sample to maintain a front of lysed sample, as demonstrated by a higher concentration of dye absorbed into the amplification pad compared to the transfer pad (FIG. 6).

### Example 7: Lysis Buffer Optimization and Incorporation of Optimized Sample Treatment

A minimal approach to processing saliva for amplification and detection of biomarkers may be employed by the device of the invention. For example, in one embodiment a lysis buffer formulation including, Buffer 20 (100 mM guanidine hydrochloride, 5 mM TCEP-HCl, 7.5% Tween-20, 0.00167% Digitonin, and 4 U/μl RNase Inhibitor), can be used to achieve three core functions: 1) inactivation of saliva RNases, 2) compatibility with RT-RPA, and 3) release of RNA biomarkers from cells in saliva without the use of heat.

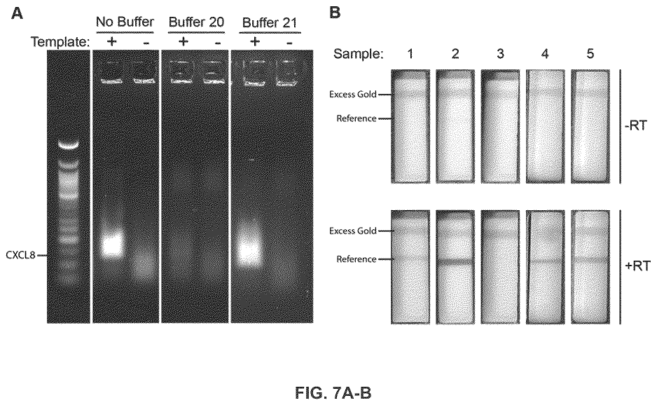

In continued testing the present inventors found that 100 mM guanidine reduces the overall efficiency of the RT-RPA reaction (FIG. 7A). Additionally, as discussed above, we found that we could use a smaller amount of RNase Inhibitor and reduce cost by moving the RNase Inhibitor from the lysis buffer to the amplification reaction. We therefore modified the lysis buffer formulation to Buffer 21 (5 mM TCEP-HCl, 7.5% Tween-20, 0.00167% Digitonin), which removed the guanidine hydrochloride and RNase Inhibitor. This optimized formulation resulted in an improved overall reaction efficiency (FIG. 7A). The present inventors lyophilized Buffer 21 into the selected lysis pad material and processed saliva from five donors through the device (FIG. 7B). This processing included expression of the sample from a collection pad, which pushed the sample through the lysis pad embedded with Buffer 21 and 4 U/μl of mRI, followed by the 10 μm filter, 100 mg of Chelex-100, and 1 μm filter. The resulting sample was used to reconstitute RPA reagents (Twist rehydration buffer and Twist enzymes), and reverse transcriptase and modified RPA primers were added to the reaction.

### Example 8: Optimization and Integration of Pad-Driven RT-RPA Amplification

Saliva processed through the filters and buffers of the device of the invention was shown to remove amplification inhibitors and reduce viscosity, allowing for efficient RPA amplification using a cDNA template. While cDNA template reactions amplified robustly across samples, in a preferred embodiment, the device of the invention would incorporate a reverse transcriptase (RT) enzyme to first convert saliva RNA biomarkers into cDNA. During initial RT-RPA experiments that used Transcriptor RT at 0.0625 U/μl, we observed persistent RT-specific inhibition by saliva. To mitigate this issue, we screened eight RT enzymes, each at multiple concentrations, with a focus on resistance to inhibitors found in saliva (Table 2).

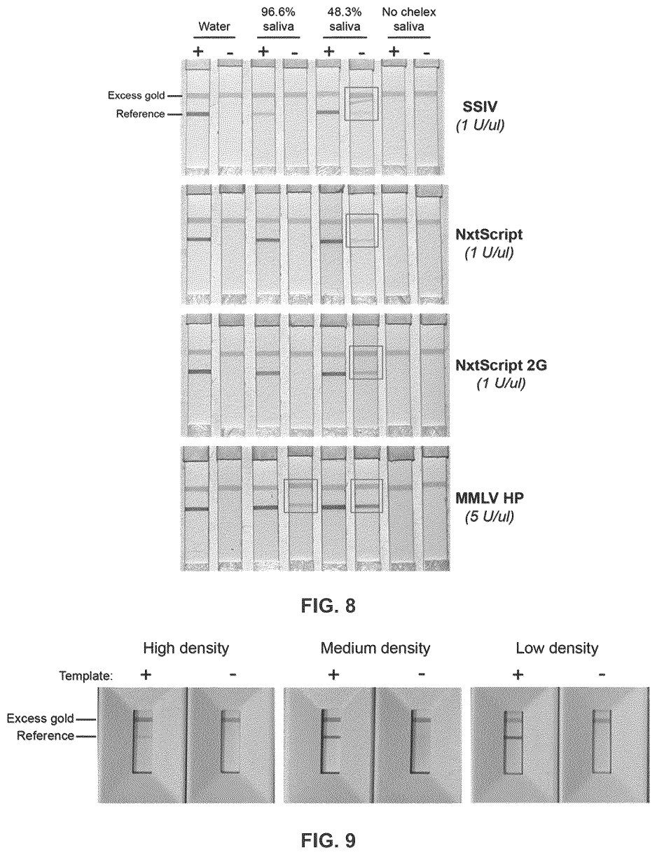

Initial RT screening was performed for compatibility with RPA reaction conditions, such as a low incubation temperature and buffer conditions that are different than PCR. Additionally, formation of primer dimers was monitored in the presence of each RT. Of the four most promising RT enzymes, our final selection was based on the ability to overcome saliva inhibition across samples and maintain high amplification efficiency with exogenous (A549 cell line RNA) and endogenous RNA (CXCL8 RNA from saliva) at high saliva concentrations. RT enzymes were lyophilized with RPA reagents into amplification pad material and RT performance was assessed with water, 96.6% saliva, 48.3% saliva, and saliva that was not treated with Chelex-100. All conditions were tested with and without additional RNA template spiked-in (FIG. 8). With RNA spike-in reactions, all RTs produced LFA positive results in water and 48.3% saliva and did not have observable primer dimers. No RT enzyme was able to amplify RNA in the presence of saliva that had not been treated with Chelex-100. Differences in amplification efficiency between RT enzymes are best seen at 96.6% saliva, with MMLV HP producing the strongest LFA signal and being the only RT to amplify endogenous saliva RNA at a high saliva concentration in this experiment. The conditions shown in FIG. 8 were repeated in multiple experiments and serves as representative data. All four RTs were able to amplify endogenous RNA to varying degrees.

### Example 9: Optimization of Pad Materials and Excipients

Initial attempts at pad-driven amplification showed poor efficiency and indicated further optimization was required for sufficient amplification. Amplification pad material was explored as one avenue to optimize performance. Twelve materials were evaluated, of which three were selected for wet-lab testing (FIG. 9). All three materials were a HRM PP/PE blend produced by Porex and ranged in densities from 0.25 g/cc (highest density) to 0.07 g/cc (lowest). The high-density material resulted in the lowest amplification signal and the lowest density material produced the highest signal, albeit only minimally stronger than the medium-density material. While the low-density material resulted in strong amplification, it proved to be difficult to include in device manufacturing due to its lack of rigidity. The medium density pad was selected for further optimization due to its ease of use.

Although the medium-density pad offered the best balance between amplification efficiency and rigidity, a significant reduction in reaction efficiency was observed compared to a liquid reaction. To improve performance, we conducted a screen to optimize lyophilization excipients as a means of improving reaction efficiency (Table 3). We found that addition of 0.1% Tween-20, in addition to the 2% sucrose and 1% mannitol already used for lyophilization, significantly improved pad-amplification efficiency. Henceforth all amplification pads were dried with the addition of 0.1% Tween-20.

To further improve reaction efficiency and prevent template loss in the pad material upstream of amplification, we blocked these materials with 0.2% Tween-20 and 1% PEG 20K. The combined effect of the addition of excipients and blocking of upstream materials significantly improved reaction efficiency in pad-driven amplification.

### Example 10: Integration of Pad-Driven RT-RPA Amplification

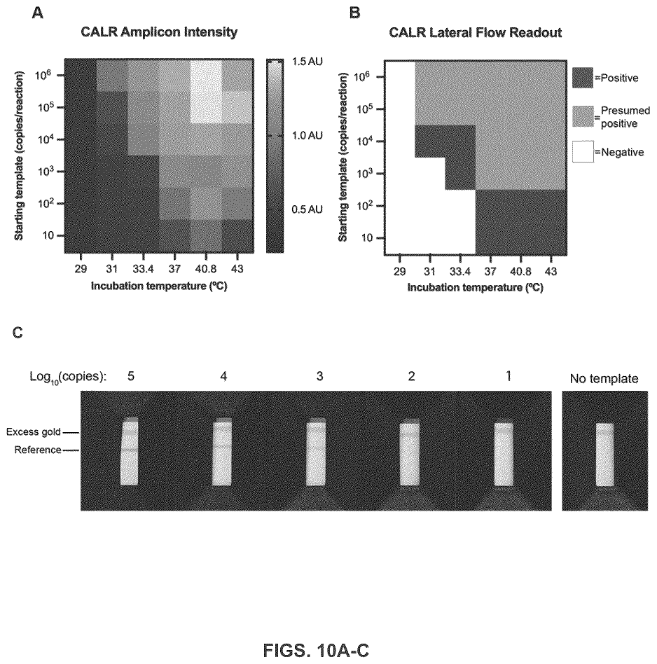

Previous data showed a limit of detection (LoD) of 10 copies of template in a liquid RPA reaction for a reference biomarker (FIG. 10A). These data were determined using a dilution series of double stranded DNA products spanning the desired amplification region of the biomarker of interest, with templates ranging from approximately 10⁶ to 10 copies per reaction. In this liquid RPA LoD study, CALR DNA was used as the reference biomarker, however a similar LoD has been observed using CXCL8 RNA as the reference.

We replicated the LoD study in pad driven amplification, with the assumption that amplification efficiency would likely be decreased. A new dilution series of double stranded DNA products was produced, again ranging from approximately 10⁶ to 10 copies per reaction. This dilution series was run through pad driven RPA, resulting in a LoD of approximately 10³ copies of template in a 100 μl reaction (FIG. 10B). Preliminary experiments with RNA templates suggest an additional 10 to 100-fold loss in efficiency in RT-RPA, resulting in an LoD of 10⁴-10⁵ copies in a 100 μl pad-driven RT-RPA reaction. After incorporating the improvements described above into pad-driven amplification, we integrated amplification pads into the device of the invention. After passing through the collection pad, lysis pad, and filter stack in the device, sample enters the baseplate where it is wicked up by the transfer pad (Porex HRM PP/PE blended fiber at 0.16 g/cc density). Sample passes from the transfer pad through a second transfer pad of the same material, then into the same pad material with lyophilized RT-RPA reagents.

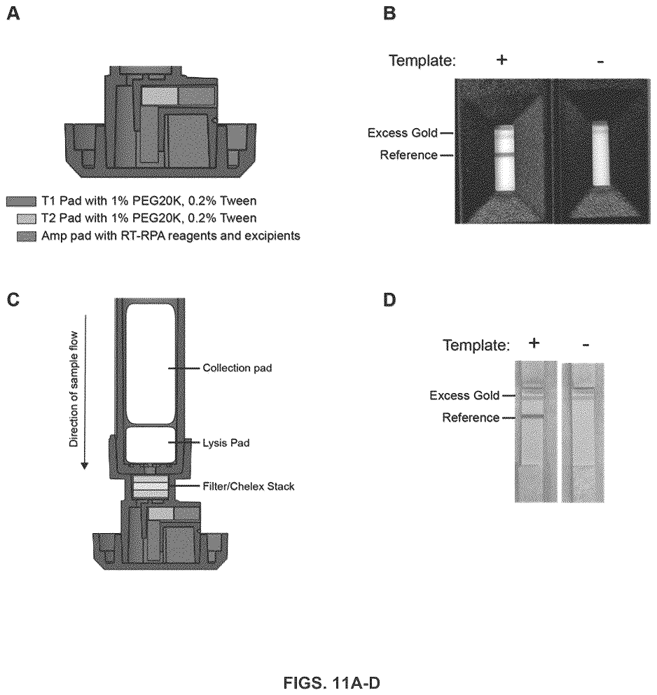

Amplification assemblies were generated with blocked transfer pads (1% PEG20K, 0.2% Tween-20), followed by an amplification pad embedded with lyophilized RT-RPA reagents and optimized excipients (0.1% Tween-20, 2% sucrose, 1% mannitol) (FIG. 11A). Template (in vitro transcribed CXCL8 RNA) was pipetted into the baseplate to allow passive wicking through the material towards the amplification pad. Magnesium was supplied with the template to activate the RT-RPA enzymes, however ultimately the magnesium will be dried into the transfer pad material for this purpose. Enough RNA template was added into the baseplate such that 107 copies reached the amplification pad. The apparatuses were then incubated for 20 min in an incubator set to 44° C., after which amplification within this setup was successfully observed on a lateral flow strip (FIG. 11B).

We next expanded the integration into the full device. In this setup, template was absorbed into a collection pad then expressed into the device to pass the template through the lysis pad, filter/chelex stack, and through to the baseplate (FIG. 11C). The template was then wicked up through the pad material towards the amplification pad as in the previous setup. After incubation of the device in the incubator, successful amplification was observed on a lateral flow strip with only 104 copies of template supplied to the amplification pad (FIG. 11D). In this experiment, double-stranded DNA covering the amplification region of CXCL8 was used as a template, however in follow-up experiments RNA templates similarly demonstrated successful amplification in the device of the invention.

Notably, in a preferred embodiment, the amplification assembly and baseplate include an independent compartment to contain excess saliva and eliminate alternate paths to the LFA other than through the amplification pad. Moreover, it was determined that excessive pressure was created at the amplification assembly from compression of the sample pad. This pressure buildup resulted in escape of the pressure through the amplification pad, leading sample to be expelled out the distal end of the amplification pad and resulting in loss of reagents and premature LFA flow. This issue was resolved by adding a pressure relief position, which in this embodiment included three pressure relief holes, 1 mm in diameter, to the front of the amplification assembly. In addition, To better regulate a flow front within the device, the amplification assembly the device is configured to direct the sample first to the baseplate, from which the front of lysed sample is wicked into the transfer pad and then pushed forward into the amplification pad.

### Example 11: Optimization of Sample Volume Tolerance

During function testing, we evaluated the range of volume tolerated in the device. The minimum required volume of the device of the invention is defined by the retention volumes of the pad material positioned throughout the device as well as the volume required to run the LFA. While testing the range of volumes collected across individuals using our selected collection pad material, we observed variable collection volumes across users ranging from 1.0 mL to 1.5 mL. When testing this range of volumes, we found that the device could only tolerate 1.0-1.1 mL of sample. Volumes greater than 1.1 mL would cause device flooding, with excess sample exiting through the pressure relief holes at the front of the amplification assembly, leading to premature flow onto the LFA.

To widen the volume tolerance of the device, we modified the mechanism by which excess sample is handled. First, we repositioned the pressure relief holes to the sides of the amplification assembly by re-designing the amplification apparatus and baseplate mating surfaces (FIG. 14). Second, we added absorbent material near the pressure relief holes to capture any expelled sample and reduce the chance of premature LFA running. Modifications to the amplification assembly and baseplate successfully expanded the volume tolerance of the device. In function testing using the revised injection molded parts with both PBS and saliva sample, a wide range of volumes were tolerated with a 100% (24/24) success rate.

### Example 12: Evaluation of Isothermal Chemistries

In total over 15 isothermal amplification technologies were evaluated for suitability in the device of the invention. From this preliminary list, four isothermal chemistries were selected to be tested in-house: Helicase Dependent Amplification (HDA), Strand Displacement Amplification (SDA), Nucleic Acid Sequence-Based Amplification (NASBA), and Recombinase Polymerase Amplification (RPA).

All four amplification chemistries were run as end-point reactions using primers designed specifically for each chemistry, followed by visualization using agarose gel electrophoresis. The isothermal chemistries all showed varying degrees of success, however, all were outperformed by RPA. HDA and NASBA both resulted in high levels of non-specific amplification and little target product was amplified using either reaction chemistry. SDA did not result in any target amplification, even after multiple attempts at primer and enzyme optimization. As HDA and NASBA did amplify their intended targets, albeit minimally, real-time quantitative protocols were established for each isothermal chemistry. Both chemistries resulted in remarkably similar Ct values between the template and no template reactions. The high levels of nonspecific amplification indicated by the Ct values could lead to difficulties distinguishing between positive and negative samples.

### Example 13: Recombinase Polymerase Amplification (RPA) Reaction Conditions

To evaluate Recombinase Polymerase Amplification (RPA) reaction conditions that enable discrimination across biomarker concentrations, double-stranded DNA products were made to span the desired region of amplification for three of our biomarkers of interest. These products were assayed as a dilution series in qPCR targeting a Ct range of 17-35 and corresponding to approximately 106 to approximately 10 copies per reaction, respectively. These dilution series were then used as starting templates for RPA reactions at temperatures surrounding 37° C. as a means of correlating RPA readout on an LFA with a Ct value from qPCR.

To determine an expected baseline for our template studies at varying temperatures, the dilution series was initially run using one of our reference biomarkers, CALR, as a template. The CALR template copies tested corresponded to Cts of 17.53 to 35.0 (approximately 106 copies to 10 copies per reaction). This dilution series was run at temperatures ranging from 29-43° C. for 20 minutes using the TwistAmp® Basic kit (TABAS03KIT; TwistDx) followed by visualization of amplified products on an agarose gel. Band intensities from the gel were quantified using ImageJ and normalized across experiments (FIG. 10A). All tested concentrations of the CALR template, including only 10 copies, were detectable using incubation temperatures at and above 37° C. Reactions with the two lowest amplicon intensities for each temperature were also assayed on lateral flow strips (FIG. 10B). If positive, reactions with higher copy number templates incubated at the same temperature were presumed to be positive but were not run on lateral flow strips to conserve reagents. The limit of detection (LoD) increased as the reaction temperature decreased; at an incubation temperature of 31° C., the LoD of the assay was 104 copies, and no tested CALR input amounts were detectable at 29° C., including the highest input of 106 copies per reaction.

Once it was determined that the standard RPA reaction can detect as little as 10 template copies when incubated around body temperature, we determined if the reaction time could be decreased. Using the same template and dilution series described above, identical reactions were incubated for 5, 10, 15, or 20 minutes at 34° C. (FIG. 15). After a 5-minute incubation time, no detectable amplification had occurred for any of the tested template concentrations. By 10 minutes, amplification had occurred at a detectable level down to a template number of 104 and increased to 103 after 15 minutes of incubation. There was no difference between the 15- and 20-minute timepoints of detectable amplification on a lateral flow strip. Thus, it was determined that a 15-minute incubation period is sufficient for amplification, and shorter incubations may be used to distinguish between biomarker copy numbers.

### Example 14: Consistency of LoD Across Biomarkers

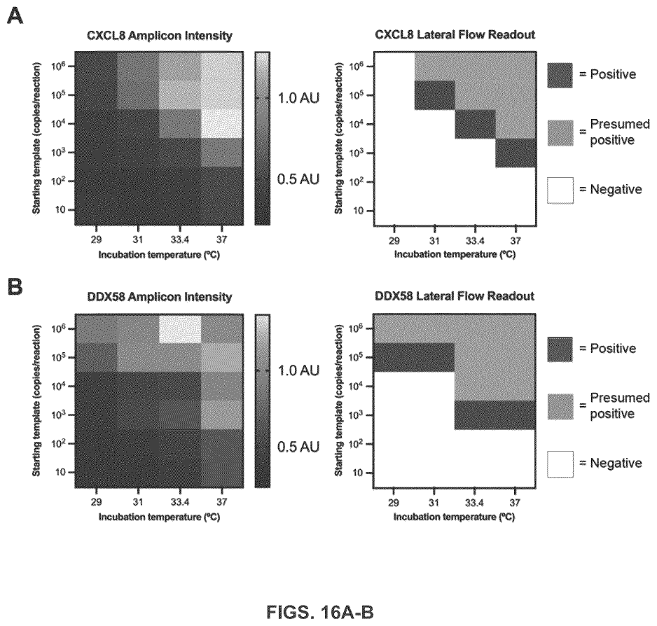

Once a baseline LoD across time and temperature had been established with the exemplary CALR reference biomarker, LoD studies were replicated using two infection biomarkers, CXCL8 and DDX58. Dilution series were created for each biomarker as described for CALR, and then were used as reaction templates at temperatures ranging from 29° C.-37° C., as all CALR dilutions were detectable at 37° C. and above. LoD studies for these two biomarkers use incubation times of 15 minutes. Some differences were observed comparing LoDs across the biomarkers, including detection of 105 copies of DDX58 at 29° C. while CXCL8 and CALR were undetected at this temperature, and increased LoDs for both infection biomarkers (10³ copies) at 37° C. compared to an LoD of 10 copies of CALR at 37° C. (FIG. 16). These differences in detection may be attributed to a decreased sensitivity of the infection line on the lateral flow strip, differences in incubation parameters across the reference and infection biomarkers, and primer efficiency with respect to each amplified target.

### Example 15: Expanded Time Course Study

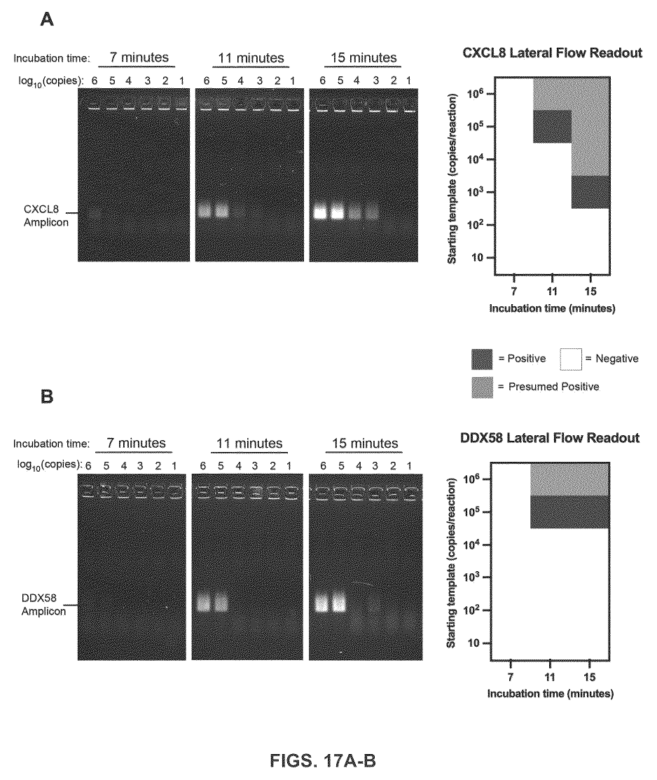

To further characterize the RPA reaction, the exemplary infection biomarkers were also run through a time course evaluation at 34° C. Because there was no detectable amplification occurring at 5 minutes with the CALR template, the time course experiment was modified to incubation times of 7, 11, and 15 minutes for the two infection biomarkers. Both biomarkers produced visible bands after 7 minutes when visualized on an agarose gel, however the amplification did not reach a detectable level on a lateral flow strip (FIG. 17). By 11 minutes, 105 copies of template were detectable on a lateral flow strip for the DDX58 biomarker. Between the 7 and 11-minute time points, the limit of detection on the agarose gel improved to 103 copies of template per reaction, however the amount of amplicon produced was not sufficient for detection on a lateral flow strip. Between the 11 and 15-minute timepoints, the LoD on the lateral flow strip did not improve, showing a LoD of 105 copies after 15 minutes, however previous experiments have shown an LoD of 103 copies of DDX58 starting template when incubated at 33.4° C. For CXCL8, detection on an agarose gel occurred at 103 copies after 11 minutes and did not improve at the 15-minute timepoint. On the lateral flow strip, CXCL8 was detected down to 105 copies of template after 11 minutes and improved to 103 copies at the 15-minute time point. The differences in limits of detection between biomarkers indicates that amplification rate is likely biomarker and primer dependent.

### Example 16: Reverse-Transcription Recombinase Polymerase Amplification (RT-RPA) and Integrated Device

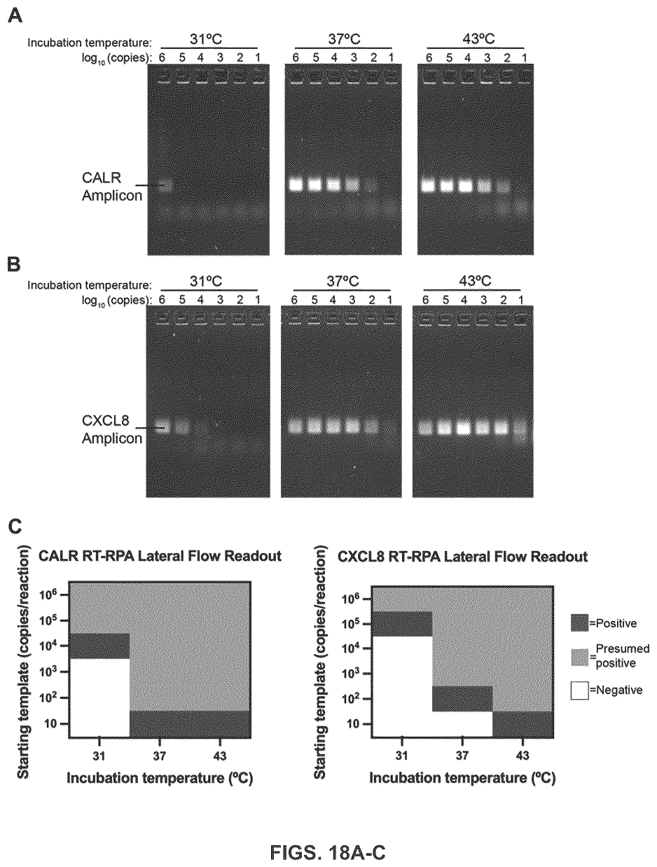

After establishing a baseline LoD for RPA at various time and temperature points using DNA templates, preliminary RT-RPA studies were conducted using RNA in-vitro transcripts (IVTs) created for each previously characterized biomarker. Dilution series of IVTs synthesized specifically for our three biomarkers were run in RT-qPCR, also targeting a Ct range of 17-35. The DDX58 biomarkers dilution series was not within the target range of Cts, so it was excluded from initial RT-RPA studies. 15-minute RT-RPA reactions were run for CALR and CXCL8 at incubation temperatures of 31° C., 37° C., and 43° C., and then were visualized using agarose gel electrophoresis (FIG. 18). RT-RPA does not appear to significantly impact reaction efficiency in most cases. In cases where the reaction efficiency is reduced, the LoD is not decreased by more than one order of magnitude of RPA using a DNA template. Furthermore, the reduction in LoD is template dependent.

At incubation temperatures of 37° C. and 43° C., all dilutions of the CALR IVT were detectable on a lateral flow strip. All CALR DNA dilutions were also detectable at these temperatures. Surprisingly, all dilutions of the CXCL8 IVTs were also detectable at 43° C. and down to 100 copies of starting template were detectable at 37° C., which is an improvement from the 1000 copy LoD seen when using CXCL8 DNA product as a template at 37° C. CXCL8 was not run in RPA with a DNA template at 43° C., so we cannot determine how a reverse transcriptase reaction impacts efficiency at this temperature. At lower incubation temperatures, we begin to see a reduction in RT-RPA efficiency. At 31° C., the CALR DNA template was detectable down to 104 copies, however we were only able to detect down to 105 copies of starting template in RT-RPA using an IVT template. The change in efficiency at low temperatures may be due to the temperature sensitivity of the reverse transcriptase utilized in RT-RPA. Furthermore, the difference in LoD between biomarkers may be due to differences in the secondary structure of each RNA template.

### Example 17: Limit of Detection for Isothermally Amplified Products on a Lateral Flow Strip

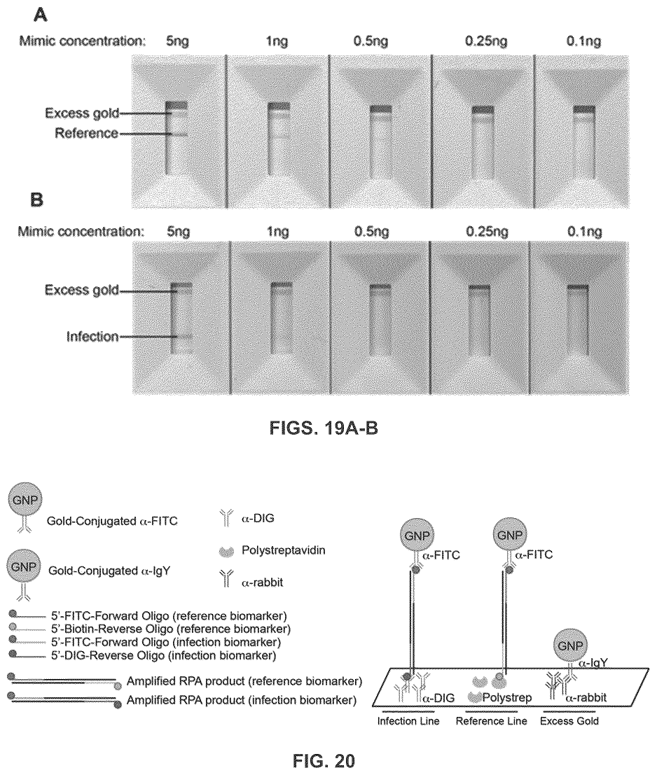

To determine the LoD of each band on the strip, double-stranded DNA products with modifications for readout on a lateral flow strip, referred to as mimics, were created for both the reference and infection line. The concentration of both mimics was quantified, and a dilution series was created for each mimic. Lateral flow strips were run with 5 ng, 1 ng, 0.5 ng, 0.25 ng, or 0.1 ng of either the infection or reference mimic in a final volume of 80 μl of PBS (FIG. 19). After allowing the strips to run for 15 minutes, a LoD of 0.5 ng was observed for the reference line, while a LoD of 1 ng was observed for the infection line.

### Example 18: Conditions for a Multiplexed Isothermal Amplification Reaction

The present inventors developed protocols to design and select primers to be used in RT-RPA that amplify mRNA at the exclusion of genomic DNA (gDNA) or off-target DNA/RNA and limit formation of primer dimers. Primers for RPA are synthesized with 5′ modifications to allow detection on a lateral flow strip, with a 5′ Fluorescein (FITC) modification on the forward primers, 5′ Biotin (Bio) on the reverse primer of a reference biomarker, and 5′ digoxigenin (Dig) on the reverse primer of an infection biomarker (FIG. 20). Thus, amplification of a reference (control) biomarker in the device can be detected on the reference control line of the LFA in all samples, while amplification of an infection biomarker will be detected on the infection line only in individuals harboring an infection.

To design primers for RT-RPA we used the NCBI primer design software following parameter guidelines from the TwistDx assay design manual as well as optimized parameters based on our own empirical data. Key parameters to enable selective and efficient amplification of the target template include the following:
Max Product Size: 200 bp
Primer Size: 27-36 bp
Primer GC content (%): 35-70
Primer Melting Temperatures: 59-70° C. with a max Tₘ difference of 10° C.
Primers must be separated by at least one intron (length>800 bp) on corresponding genomic DNA

From the output produced using search parameters outlined above, primers are screened against possible off-target amplification using the following references: refseq mRNA (Homo sapiens) and refseq representative genomes (Homo sapiens and bacteria). We select primers for which any off-target amplification has mismatches in the 3′ region of the primer and/or has at least 7 mismatches distributed throughout the length of the primer. Primers that pass the above selection criteria undergo a thermodynamics analysis to select for primers that are less likely to form primer-dimers and lead to a non-specific readout on an LFA. We use the Oligo Analyzer Tool (Hetero-Dimer analysis) from IDT to evaluate predicted interactions between the forward and reverse primers. From this output we select primers that have predicted interactions with delta G values closer to zero (interactions that are less likely to occur) or have predicted interactions with internal 5′ ends (an interaction in which the polymerase will not be able to extend).

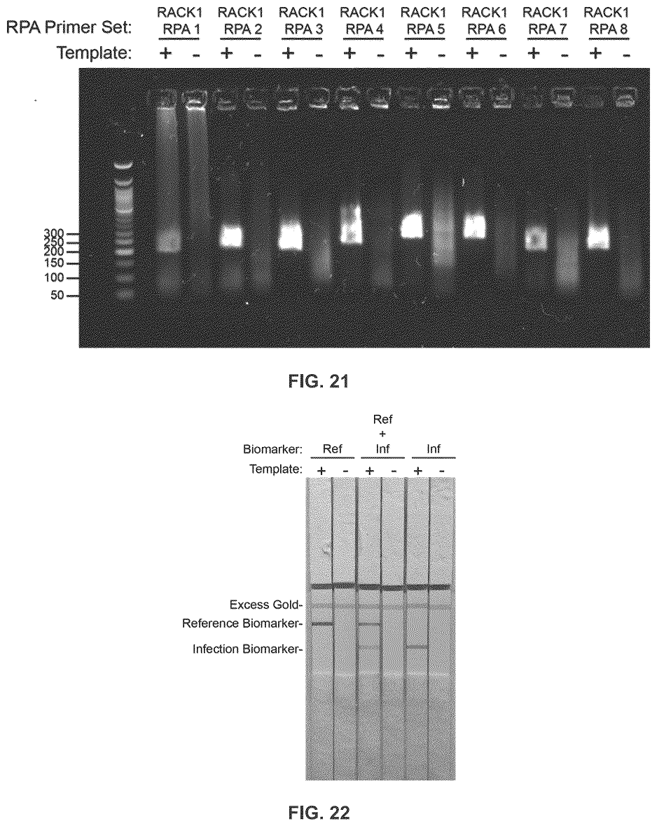

After selected primers are received into the lab, they are screened in RPA using cell line cDNA as a template as well as a no template control to assess the level of primer noise. (FIG. 21) shows an example of such a screen. In this example, two RACK1 primer sets, RPA 2 and RPA 6, were selected for further use based on a strong signal in the template reaction and minimal amounts of primer noise in the no template controls.

In total, the present inventors performed wet-lab screening of over 130 primer sets for 25 targets using the methods described above. Of these primer sets tested, almost all could efficiently amplify target cDNA or RNA. Primers that passed selection criteria for the absence of primer noise in no template control reactions were ordered with LFA-compatible 5′ modifications. We evaluated modified primers for false positive results on a lateral flow strip in no template control reactions. Only primer dimers that include both a forward and reverse primer will produce a false positive signal on the lateral flow strip.

### Example 19: Multiplexing of RT-RPA Primers

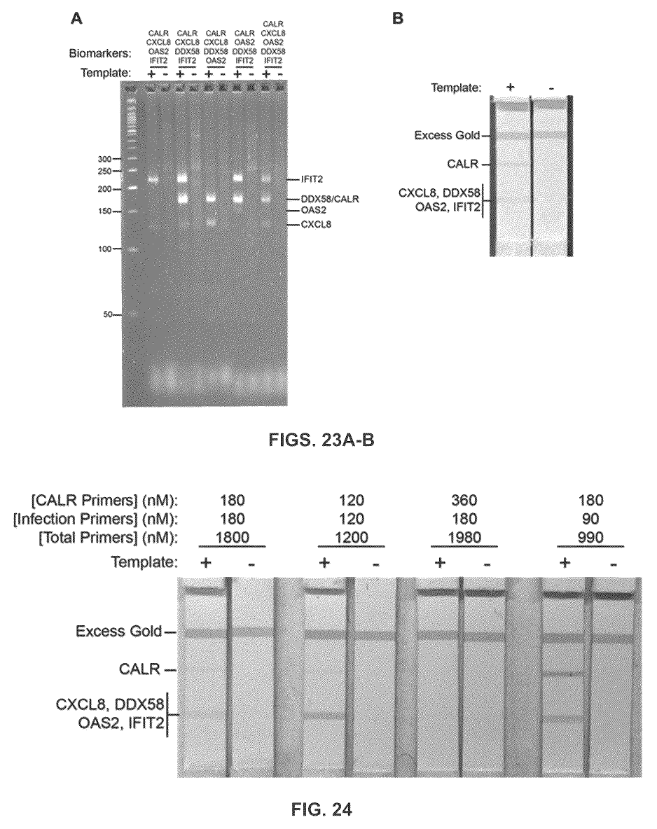

After an extensive primer design and screening process, particular primer pairs were used in multiplexed RT-RPA reactions. FIG. 22 demonstrates two exemplary primer sets, CALR and IFIT2, multiplexed and analyzed on a lateral flow strip. After identifying optimal conditions to multiplex two targets, we explored higher levels of multiplexing in a single RT-RPA reaction. Our selective primer design along with the robustness of RPA has made it possible to observe amplification of five products on a gel (FIG. 23). The capability of multiplexing up to 5 targets will enable us to strategically detect biomarkers in the device in a manner that improves the sensitivity and specificity for pre-symptomatic infection. We next explored how primer concentration can be used to modulate the signal from multiple biomarkers (FIG. 24). We found that total primer concentration along with the ratio of concentrations of reference and infection biomarker primers can affect the specificity and intensity of the readout.

A challenge of multiplexed RT-RPA is an increased tendency to form primer dimers that impact the readout on a lateral flow strip. We have explored the use of betaine as an additive to reduce the occurrence of primer dimers. Betaine can prevent the formation of primer dimers in isothermal amplification by effectively lowering the melting temperature of an oligo sequence. In preliminary experiments, we found that betaine can reduce primer noise in multiplexed RT-RPA reactions, however some primer sets lose efficiency in the presence of higher concentrations of betaine. Thus, betaine may be an effective additive to reduce primer dimers in RT-RPA reactions in certain embodiments.

### Example 20: Buffers and Filters to Minimally Process Saliva for Compatibility with a Multiplexed Isothermal Amplification Reaction

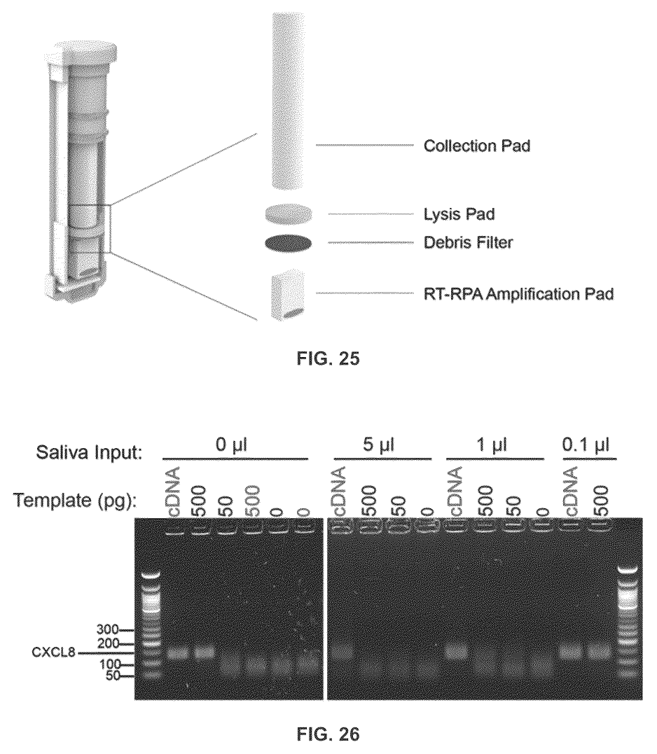

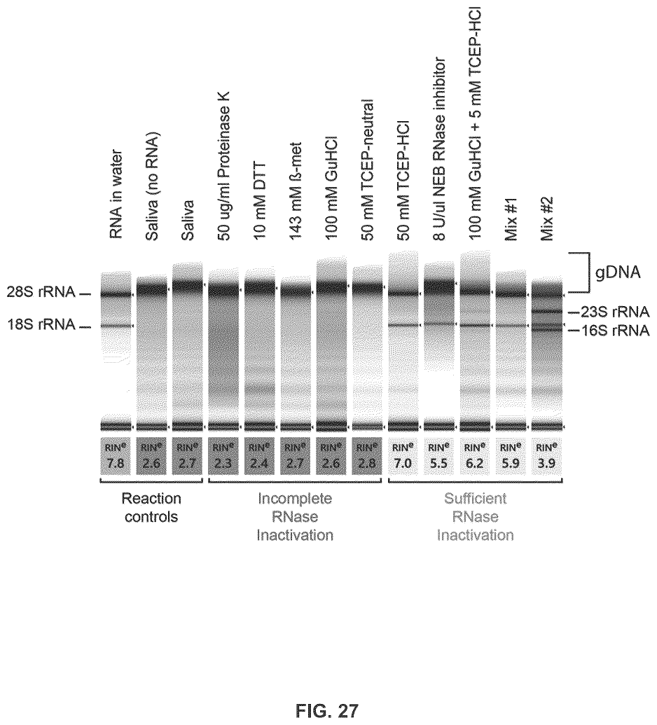

In one embodiment, saliva processing using the device of the invention can incorporate three physical filters (a collection pad, lysis pad, and debris filter), and a lyophilized lysis buffer to release and protect RNA molecules for amplification by RT-RPA (FIG. 25). The collection pad must reduce sample viscosity, collect and release a sufficient volume of sample for the device, and remove large particles, like food and mucins (high molecular weight glycoproteins present in saliva). The lysis pad has an embedded, lyophilized lysis buffer to release and protect intracellular RNA biomarkers. Finally, the debris filter is responsible for removing cellular debris post-lysis and any remaining large, interfering particles before the sample flows into the RT-RPA amplification pad. The selection of the collection pad, lysis pad, and debris filters is described in further detail below

As noted above, the device of the invention is designed such that the saliva sample to be tested provides the full volume of liquid required to reconstitute all lyophilized reagents (including the lysis buffer and RT-RPA reagents) and to enable flow throughout the device. This approach reduces device complexity, cost, and ease of use but creates the challenge that the upstream lysis buffer must be fully compatible with downstream reactions without dilution. Additionally, because the device is non-powered, the simplest approach to processing saliva samples would involve a buffer that does not require heat to lyse samples and inactivate saliva RNases. Thus, the following three functions are required of the lysis buffer: 1) Inactivation of saliva RNases, 2) maintain compatibility with RT-RPA, and 3) lysis of cells in saliva to release RNA targets without heat.

RNases are abundant, robust, RNA degrading enzymes readily found in human saliva. RNases must be inactivated to prevent immediate degradation of the RNA biomarkers targeted by the device. To demonstrate the impact of saliva RNases on RT-RPA reactions, we spiked untreated saliva into RPA reactions with either cDNA or RNA template from a human lung cell line. Reactions containing greater than 0.1 μl of saliva displayed interference when targeting RNA, but not cDNA templates (FIG. 2.5.2), indicating that RNases found in saliva degraded the RNA template prior to amplification but that saliva does not otherwise interfere with RPA reactions.

To screen for chemical and protein-based reagents that inhibit saliva RNases, we developed an RNase activity assay in which purified cell line RNA was incubated for 30 min at 37° C. with saliva samples after treatment with potential reagents for RNase inhibition (FIG. 2.5.3). After incubation, RNA was purified and analyzed on an Agilent TapeStation. Sharpness of the eukaryotic ribosomal RNA bands (28S and 18S) were compared to determine RNase activity in the presence of various inhibitors. In addition, the Agilent TapeStation calculates an RNA Integrity Score (RIN) as a measure of RNA quality (RIN of 10-fully intact RNA, RIN of 1=fully degraded RNA), however contaminating nucleic acid (e.g., 16S and 23S rRNA from bacteria) interferes with this calculation.

To screen for chemical and protein-based reagents that inhibit saliva RNases, we developed an RNase activity assay in which purified cell line RNA was incubated for 30 min at 37° C. with saliva samples after treatment with potential reagents for RNase inhibition (FIG. 2.5.3). After incubation, RNA was purified and analyzed on an Agilent TapeStation. Sharpness of the eukaryotic ribosomal RNA bands (28S and 18S) were compared to determine RNase activity in the presence of various inhibitors. In addition, the Agilent TapeStation calculates an RNA Integrity Score (RIN) as a measure of RNA quality (RIN of 10=fully intact RNA, RIN of 1=fully degraded RNA), however contaminating nucleic acid (e.g., 16S and 23S rRNA from bacteria) interferes with this calculation. In total, 54 unique reagents, concentrations, and buffer formulations were tested for their ability to inactivate RNases. Table 6 is a non-exhaustive list of reagents tested for RNase inactivation.

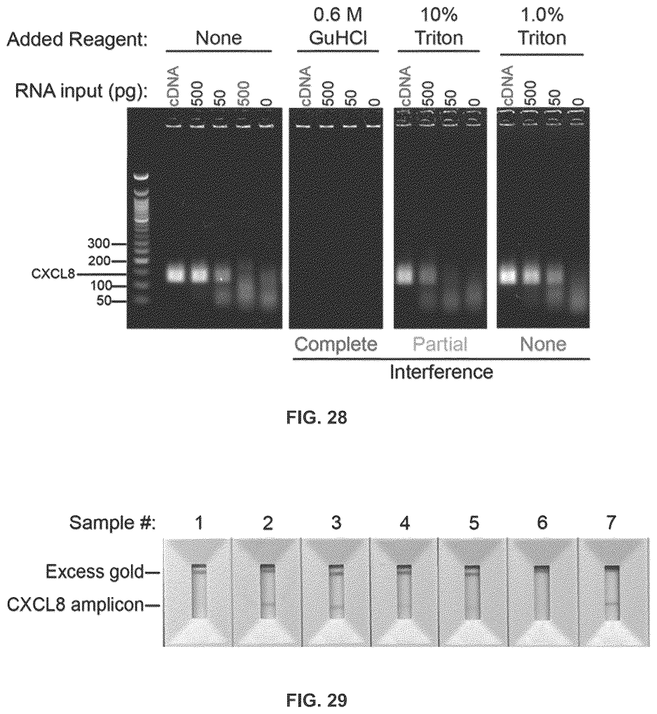

Reagents under consideration for the device were tested for compatibility with RT-RPA at the concentrations expected to be required for lysis. To test for interference, lysis or RNase inhibitor reagents were spiked into RT-RPA reactions with purified cell line RNA or cDNA as a template. Reactions were analyzed by agarose gel for the presence or absence of amplified products. An example of an RT-RPA interference assay is shown in FIG. 28. In total, greater than 20 lysis buffers and 17 lysis and RNase inhibitor reagents were tested at a range of concentrations for interference in RT-RPA. Table 7 is a non-exhaustive list of reagents tested. Expected outcomes of RT-RPA compatibility testing are listed below.
Complete interference: No amplification bands present.
Partial interference: Reduced band intensity compared to control reactions; tested reagent reduces overall reaction efficiency.
No interference: Amplification bands have the same intensity as control reactions.
Reverse transcriptase interference or degradation of RNA targets: Bands present in cDNA reaction, no bands in RNA template reactions.

The present inventors further screened lysis reagents at varying concentrations for the ability to lyse cells present in saliva. Commonly used reagents for lysis include chaotropic salts (e.g., guanidine hydrochloride), anionic surfactants (e.g., sodium dodecyl sulfate), and non-ionic detergents (e.g., Triton X-100). After confirming that selected lysis buffers did not interfere with RT-RPA and were effective at inhibiting RNase activity, lysis efficiency was determined by directly testing crude saliva extracts in RT-RPA. Initial screens of candidate lysis buffers were performed by treating saliva samples with the selected buffers then adding saliva directly into RT-RPA reactions. Amplification band intensities on an agarose gel and lateral flow strip were compared to a positive control (purified cell line RNA) to determine efficiency of lysis. Three candidate buffers passed this screen. The following buffer (Buffer #20) was selected for further evaluation: 100 mM guanidine hydrochloride, 5 mM TCEP-HCl, 7.5% tween-20, 0.0016% digitonin, and 4 U/μl RNase inhibitor.

To determine the robustness of this lysis buffer, seven raw saliva samples were collected using the selected collection pad and saliva was released from the collection pad using a 3 ml syringe. The saliva samples were treated with Buffer #20, then 5 μl of treated saliva was used as a template in a 20 μl RT-RPA reactions. RT-RPA reactions were incubated for 20 minutes at 42° C., heat killed for 10 min at 95° C. and analyzed on lateral flow strips. Amplification of the CXCL8 biomarker (a highly abundant transcript in saliva of healthy individuals) was observed in 5 of 7 saliva samples tested (FIG. 29).

### Example 21: Characterization of Fluid Dynamics

Characterization of fluid dynamics for human saliva was critical to ensure the proper mechanical processes and sample treatment are included in the device design. This ensures successful collection, transportation, processing, mixing, and ultimately amplification of biomarkers from a saliva sample. In this embodiment, simulated sample collection with sublingual oral insertion of a pad compared to a passive drool into a vial offered an improved saliva collection experience for the user. It also acted as an initial means for metering to ensure adequate sample volume is collected. An example of this is shown in Table 8, where coefficient variations (CV) for both saliva and water have a CV below 3.5% for total volume saturated across three replicates. Additionally, the expression of solution from the saturated collection pad is adequate for the product with CVs of residual sample volumes for water below 3% and saliva below 10% (Table 8). The higher variation seen with saliva expression is likely due to variation in mucin concentrations between samples. The final collection volume required for amplification in the device must account for the variance seen with saliva expression from the collection pad.

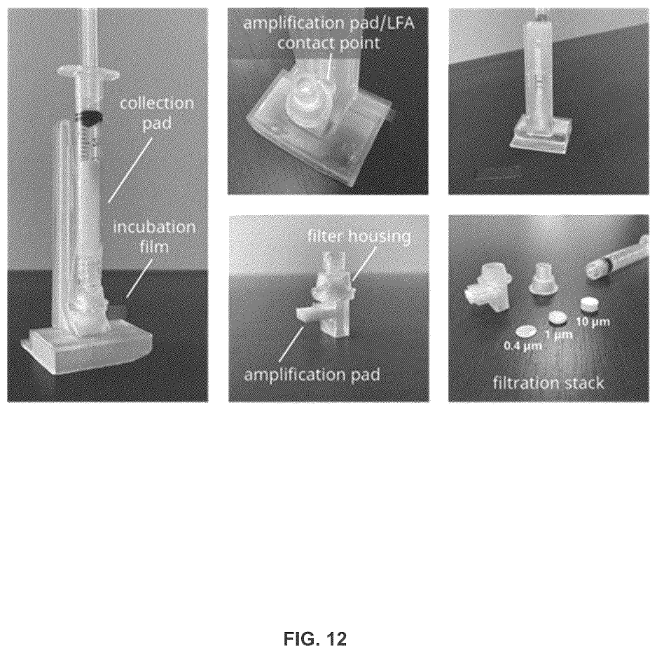

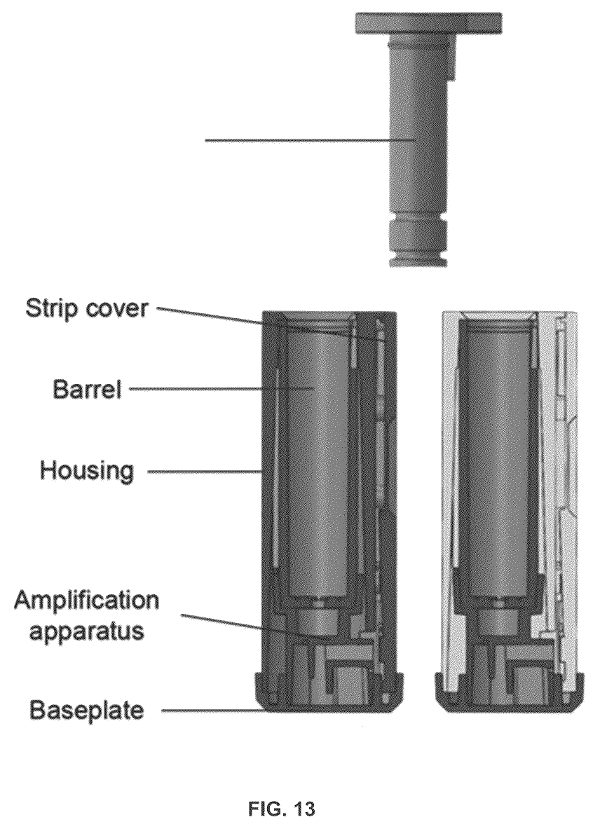

Alternative embodiment were created and tested, culminating in an exemplary device with an integrated 3 mL syringe and several subcomponents. We verified that a saliva sample can be successfully driven through a contained device that integrates several sample processing steps, including sample collection, reagent mixing, incubation, and delivery to the lateral flow strip (FIG. 12).

### Example 22: Optimization of Filtration Compression Force

Due to limitations inherent to lateral flow technology, filtering saliva is required to reduce and normalize the viscosity of saliva samples. A set of experiments were carried out to identify the filtration requirements needed to mitigate signal inhibition and flow irregularities caused by saliva mucins. Specifically, to determine the impact of mucins, saliva was collected from three subjects at three timepoints to obtain samples with a variety of mucin concentrations. Each sample was then tested in four filter conditions: 1) Unfiltered, 2) filtered with a 10 μm filter, 3) filtered with a gradient stack including a 10 μm filter, 1 μm filter, and a 0.45 μm filter, and 4) absorption and expression from a collection pad before passage through a gradient filter stack (Table 9). Sample viscosity was measured by adding blue dye to each sample at the time of collection and recording two visual measurements from the samples run on test strips: 1) The time elapsed for the sample to wick to the control line, and 2) the percent of solution absorbed up the absorbent pad.

We found that saliva significantly reduces flow rates and sample volumes wicked through the lateral flow test strip (Table 9). Passing the samples through a 10 μm filter greatly improved these issues with additional stacking of 1 μm and 0.45 μm filters offering a slight additional improvement. Thus, the device in a preferred embodiment can incorporate a method for compression force filtration through a membrane with a porosity of at least 10 μm prior to sample delivery to the test strip.

### Example 22: Evaluation of Pad-Driven Amplification

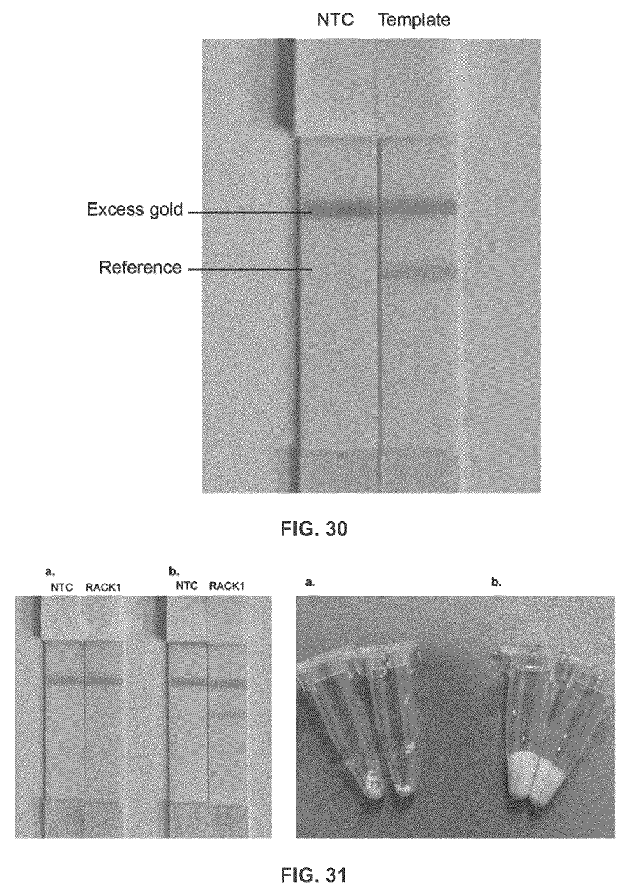

Pad-driven amplification uses porous materials impregnated and dried with RPA reagents. Preliminary testing yielded lower than desired amplification, requiring additional work to understand liquid reaction efficiency in vials compared to pad materials. As shown in FIG. 30, pad materials fully saturated with wet RPA reagents maintain equivalent amplification efficiency when compared to vial reactions.

Since amplification failed in pads with lyophilized RPA reagents but not liquid reagents, we focused optimization efforts on lyophilization conditions. We reformulated the RPA mix by incorporating additional excipients pre-lyophilization to improve the efficiency of the RPA reaction post-lyophilization. Several excipients including trehalose, glycine, mannitol, sorbitol, and sucrose were added to the RPA formulation. The lyophilized cake of the original RPA tubes was very poor (FIG. 31), however with the addition of trehalose and glycine, the cake did not collapse and retained its structure post drying (FIG. 31B). The dried reactions for both conditions were then used for amplification. There was a significant difference in amplification efficiency between the two, with the original RPA formulation resulting in no detectable amplification and the reformulated reaction resulting in successful amplification. Subsequent formulations and drying parameters were developed and tested with the selection of a final formulation that includes 2% sucrose and 1% mannitol. The lyophilization procedure was further optimized to increase primary and secondary drying cycle time by ~25% and to lower initial thermal treatment to −44° C. before vacuum evacuation.

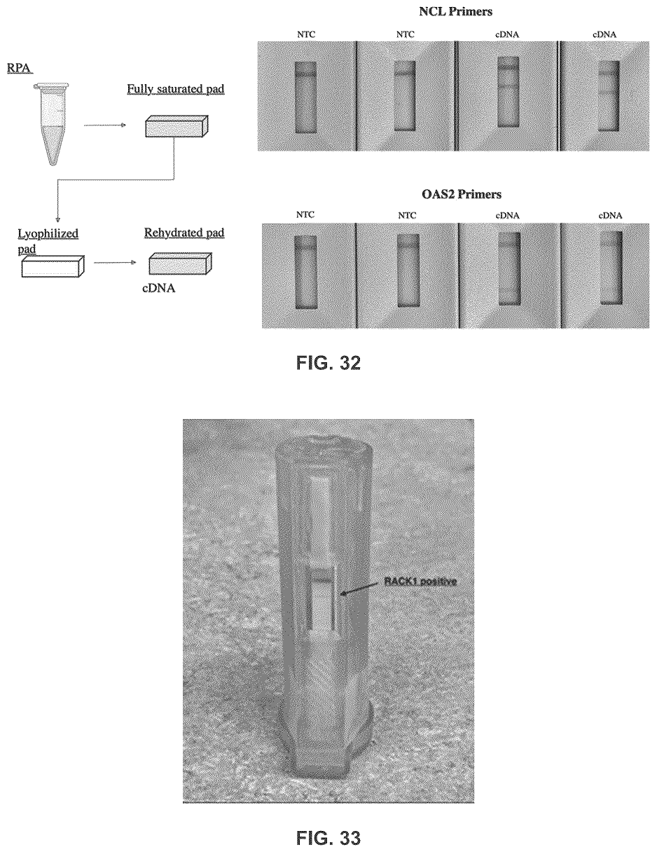

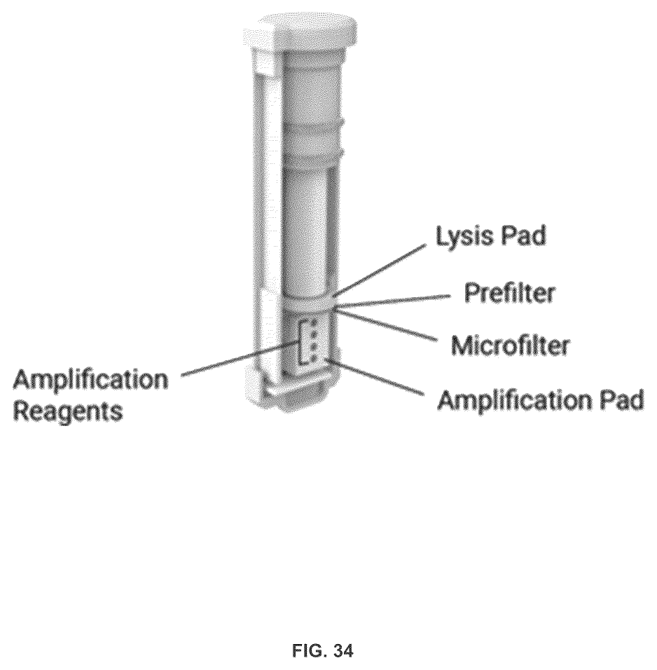

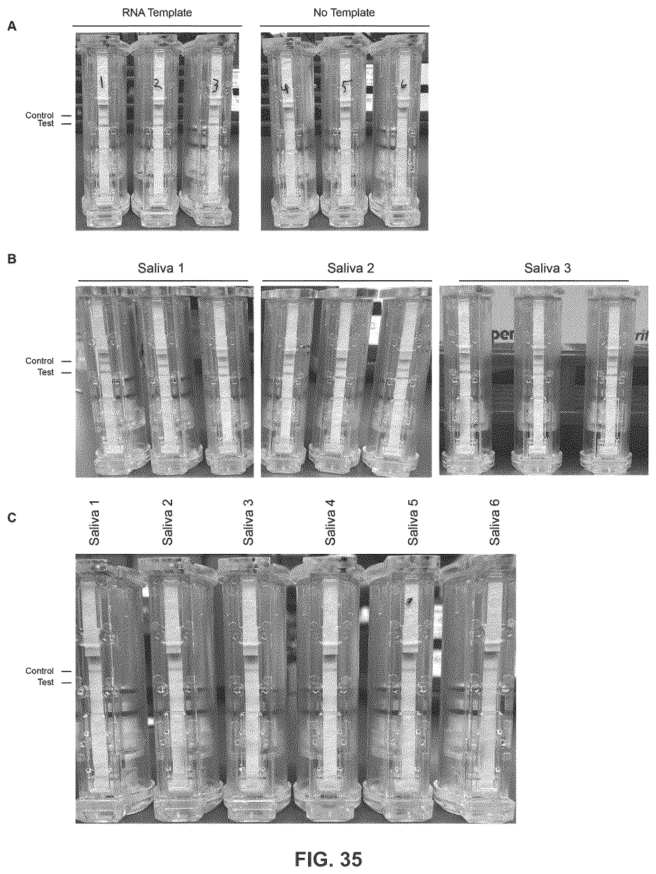

With the reformulated RPA mix having success with amplification, additional primers were tested using pad amplification. FIG. 32 describes the method for drying of reagents into pads and shows the successful amplification of both NCL (a reference biomarker) and OAS2 (an infection biomarker) primer sets. In a preferred embodiment, a portion of RPA mix can be lyophilized on the distal end of the pad to reduce required reagent volumes and have a reserve of sample flow behind the reaction to enable dilution for flow onto the lateral flow strip. Feasibility of this approach is demonstrated in FIG. 33. Here, an amplification was performed within an embodiment of the invention, in which all subcomponents have been customized and integrated into a singular device. The device was assembled with an amplification pad that had been cut to be ¼ the length of the original amplification pad. This pad was saturated and dried with primers and RPA reagents and then supported in the device with a blank amplification pad at ¾ the original length. A solution containing cDNA template and magnesium acetate was added to the test device and allowed to incubate at 39° C. for 20 minutes. Amplification occurred in the prototype device. Thus, we demonstrated that amplification using decreased RPA reagent volumes within the distal end of the pad is feasible.

### Tables

TABLE 1
Saliva collection pads evaluated for Diagnostic device

| | | Dimensions | |
|---|---|---|---|
| Manufacturer | Material composition | (length × diameter) | |
| Porex | HRM fiber media | 35.5 × 8 | mm |
| Porex | HRM fiber media | 34 × 8 | mm |
| Porex | HRM fiber media | 33 × 8 | mm |
| Porex | HRM fiber media | 32 × 8 | mm |
| Porex | HRM fiber media | 31 × 8 | mm |
| Porex | HRM fiber media | 30 × 8 | mm |
| Salimetrics | Synthetic material | 30 × 10 | mm |
| Richmond Dental | 100% cotton | 38.1 × 9.5 | mm |

TABLE 2
Reverse transcriptase enzymes screened for use in RT-RPA

| Reverse Transcriptase | Manufacturer | Notes |
|---|---|---|
| Transcriptor | Roche | Unreliable supply |
| SuperScript II (SSII) | ThermoFisher | Poor sensitivity |
| SuperScript IV (SSIV) | ThermoFisher | Inhibition by saliva at |
| | | tested concentrations |
| ProtoScript II | NEB | Outperformed by other RTs |
| NxtScript | Roche | Inhibition by saliva at |
| | | tested concentrations |
| NxtScript 2G | Roche | Outperformed by MMLV HP |
| MMLV HP | LGC | Selected for first prototype |
| EpiScript | LGC | Poor sensitivity |

TABLE 3
Excipients tested for improved pad driven amplification

| Excipients | Template¹ | Signal intensity² |
|---|---|---|
| 2% Sucrose/1% Mannitol | − | − |
| 2% Sucrose/1% Mannitol | + | + |
| 2% Sucrose/1% Mannitol/0.1% Tween-20 | − | − |
| 2% Sucrose/1% Mannitol/0.1% Tween-20 | + | ++ |
| 2% Sucrose/1% Trehalose | − | − |
| 2% Sucrose/1% Trehalose | + | + |
| 2% Sucrose/1% Trehalose/0.1% Tween-20 | − | − |
| 2% Sucrose/1% Trehalose/0.1% Tween-20 | + | ++ |

¹Reactions containing template were run in duplicate and had identical results.
²Lateral flow strip band intensity was ranked as no band (−), medium intensity band (+), and strong intensity band (++).

TABLE 4
Device subcomponents and functions in one embodiment thereof

| Subcomponent | Required Functions |
|---|---|
| Collection | Provides handle for user to self-collect saliva sample |
| handle | Holds collection pad during sample collection and addition to device |
| | Contains plunging apparatus to compress collection pad within device |
| | Creates a hermetic seal when inserted into the barrel |
| | Include a locking mechanism to contain biospecimen within device |
| Barrel | Houses lysis pad at its base |
| | Accepts collection pad and seals with collection handle to generate |
| | pressure that forces biospecimen through lysis pad and filter stack |
| Housing | Houses and restricts access to device chemistries, |
| | subcomponents, and biospecimen |
| | Connect with locking mechanism on collection handle |
| | Protects components from environmental exposure |
| Amplification | Houses saliva filter stack |
| assembly | Houses amplification pad containing lyophilized RT-RPA reaction |
| | Houses transfer pad to deliver sample to amplification pad and |
| | deliver excess sample from baseplate to run lateral flow strip |
| Baseplate | Creates excess sample reservoir in concert with amplification assembly |
| | Contains excess saliva sample during RT-RPA incubation, required for |
| | running of LFA |
| Strip cover | Holds lateral flow strip in place, in contact with amplification pad |
| | Protects LFA strip from environmental exposure |
| | Incorporates window for visual readout of LFA strip |
| | Provides pressure gradient for consistent LFA flow, regardless of |
| | orientation |
| Pull tab | Creates physical barrier between amplification pad and LFA |
| | Prevents premature running of LFA during sample addition and RT-RPA |
| | incubation |

TABLE 6
Reagents screened for inactivation of saliva RNases. Results are
compiled from multiple RNase inactivation screens as described
in FIG. 2.5.3, with Pass (green) indicating sufficient RNase inactivation,
Partial Pass (yellow) indicating partial RNase inactivation, and
Fail (red) indicating incomplete RNase inactivation.

| | |
|---|---|
| Reagent or solution | Result |

Reducing Agents

| | |
|---|---|
| 50 mM TCEP-HCl | Pass |
| 5 mM and 12.5 mM TCEP-HCl | Fail |
| 5 mM and 50 mM TCEP-neutral | Fail |
| 10 mM DTT | Fail |
| 143 mM beta-mercaptoethanol | Fail |

Protein RNase Inhibitors

| | |
|---|---|
| 4 U/μl, 8 U/μl Promega RI, recombinant (N2511; Promega) | Pass |
| 8 U/μl NEB RI, murine (M0314; New England BioLabs) | Pass |
| 4 U/μl NEB RI, murine | Partial |
| | Pass |
| 50 μg/ml and 2.5 mg/ml Proteinase K | Fail |

Combined Solutions

| | |
|---|---|
| 4 U/μl NEB RI, murine + 5 mM TCEP-HCl | Pass |
| 4 U/μl Promega RI, recombinant + 5 mM TCEP-HCl | Pass |
| 100 mM GuHCl + 5 mM TCEP-HCl | Pass |
| 100 mM GuHCl + 5 mM TCEP-HCl + 4 U/μl NEB RI, murine | Pass |
| Buffer #10 | Pass |
| Saliva Stabilization Solution | Pass |
| Lucigen Quick-Extract RNA + 4 U/μl NEB RI, murine | Partial |
| | Pass |
| 100 mM GuHCl + 5 mM TCEP-neutral | Fail |
| 4 U/μl NEB RI, murine + 5 mM TCEP-neutral | Fail |
| Quick-Extract RNA (QER090150; Lucigen) | Fail |

TABLE 7
Reagents screened for compatibility in RT-RPA. Pass (green) indicates
that reagents did not interfere with RT-RPA. Partial pass (yellow)
indicates that reagents had partial interference in RT-RPA. Fail
(red) indicates reagents completely interfered with RT-RPA reactions.
Reagent concentrations are final in RT-RPA reaction.

| | |
|---|---|
| Reagent or solution | Result |

Detergents and Denaturants

| | |
|---|---|
| 1% Triton X-100 | Pass |
| 15% Tween20 | Pass |
| 100 mM GuHCl | Pass |
| 1% digitonin | Pass |
| 0.01%-0.25% IGEPAL | Partial Pass |
| 5%-10% Triton X-100 | Partial Pass |
| 0.01% sarkosyl | Partial Pass |
| 0.005% SDS | Fail |
| 200 mM GuHCl | Fail |
| 100 mM GTC | Fail |
| 0.1% sarkosyl | Fail |

Reducing Agents and RNase Inhibitors

| | |
|---|---|
| 2 mM EDTA | Pass |
| 4 U/μl NEB RI, murine | Pass |
| 5 mM HCl | Pass |
| 5 mM TCEP-HCl | Partial Pass |
| 6 mM EDTA | Partial Pass |
| 4 U/μl Promega RI, recombinant | Partial Pass |
| 10 mM TCEP-HCl | Fail |
| 18 mM EDTA | Fail |

Combined Solutions

| | |
|---|---|
| Buffer #7 | Pass |
| Lucigen Quick-Extract RNA | Pass |
| Buffer #5 | Partial Pass |
| Buffer #6 | Partial Pass |
| Buffer #10 | Partial Pass |
| Buffer #11 | Partial Pass |
| Buffer #19 | Partial Pass |
| Digitonin buffer | Partial Pass |
| IGEPAL buffer | Partial Pass |
| SDS buffer | Fail |
| RIPA buffer | Fail |

TABLE 8
Collection pad absorption and expression volume assessment

| | Dry Mass of | Wet Mass of | Total | Expression | Residual |
|---|---|---|---|---|---|
| | Collection | Collection | Volume | Volume | Volume |
| | Pad (g) | Pad (g) | (μl) | (μl) | (μl) |
| Sample | | | | | |
| (Water) | | | | | |
| 1 | 0.123 | 1.27 | 1147 | 965 | 182 |
| 2 | 0.134 | 1.297 | 1163 | 977 | 186 |
| 3 | 0.136 | 1.356 | 1220 | 1027 | 193 |
| | | Mean: | 1176.7 | 989.7 | 187.0 |
| | | StDev: | 38.4 | 32.9 | 5.6 |
| | | ¾ CV: | 3.26 | 3.32 | 2.98 |
| Sample | | | | | |
| (Saliva) | | | | | |
| 1 | 0.128 | 1.189 | 1061 | 895 | 166 |
| 2 | 0.138 | 1.23 | 1092 | 893 | 199 |
| 3 | 0.129 | 1.236 | 1107 | 933 | 174 |
| | | Mean: | 1086.7 | 894.0 | 179.7 |
| | | StDev: | 23.5 | 1.4 | 17.2 |
| | | ¾ CV: | 2.16 | 0.16 | 9.58 |

TABLE 9
Assessing flow characteristics on lateral flow
test strips with raw and filtered saliva

| | | Expressed | Time to Control | % Flow up |
|---|---|---|---|---|
| Sample | Filter Conditions | (μl) | Line (min:sec) | Absorbent |
| | Control - 1 | | 0:35 | 85 |
| | Control - 2 | | 0:35 | 90 |
| A1 | No Filter | | 0:50 | 25 |
| | 10 um Filter | 294 | 0:32 | 40 |
| | 1 um/0.45 um/10 um Filter | 293 | 0:28 | 50 |
| | 1 um/0.45 um/10 um Filter + | 277 | 0:27 | 70 |
| | Collection Pad | | | |
| A2 | No filter | | 1:10 | 20 |
| | 10 um Filter | 292 | 0:31 | 40 |
| | 1 um/0.45 um/10 um Filter | 281 | 0:30 | 55 |
| | 1 um/0.45 um/10 um Filter + | 305 | 0:28 | 60 |
| | Collection Pad | | | |
| A3 | No filter | | 0: [symbol] 0 | 25 |
| | 10 um Filter | 300 | 0:32 | 40 |
| | 1 um/0.45 um/10 um Filter | 284 | 0:2 [symbol] | 50 |
| | 1 um/0.45 um/10 um Filter + | 295 | 0:28 | 65 |
| | Collection Pad | | | |
| B1 | No filter | | 1:10 | 10 |
| | 10 um Filter | 327 | 0:32 | 60 |
| | 1 um/0.45 um/10 um Filter | 283 | 0:30 | 75 |
| | 1 um/0.45 um/10 um Filter + | 291 | 0:2 [symbol] | 80 |
| | Collection Pad | | | |
| B1 | No filter | | 1:40 | 20 |
| | 10 um Filter | 305 | 0:31 | 45 |
| | 1 um/0.45 um/10 um Filter | 264 | 0:29 | 65 |
| | 1 um/0.45 um/10 um Filter + | 280 | 0:31 | 70 |
| | Collection Pad | | | |
| B1 | No filter | | 2:05 | 10 |
| | 10 um Filter | 275 | 0:33 | 55 |
| | 1 um/0.45 um/10 um Filter | 275 | 0:32 | 70 |
| | 1 um/0.45 um/10 um Filter + | 273 | 0:28 | [symbol] 0 |
| | Collection Pad | | | |
| C1 | No filter | | 0:42 | 20 |
| | 10 um Filter | 310 | 0:29 | 75 |
| | 1 um/0.45 um/10 um Filter | 295 | 0:28 | 70 |
| | 1 um/0.45 um/10 um Filter + | 317 | 0:31 | 60 |
| | Collection Pad | | | |
| C1 | No filter | | 0: [symbol] 0 | 30 |
| | 10 um Filter | 245 | 0:29 | 65 |
| | 1 um/0.45 um/10 um Filter | 289 | 0:28 | 65 |
| | 1 um/0.45 um/10 um Filter + | 313 | 0:29 | 65 |
| | Collection Pad | | | |
| C1 | No filter | | 0:42 | 40 |
| | 10 um Filter | 319 | 0:28 | 80 |
| | 1 um/0.45 um/10 um Filter | 245 | 0:28 | 68 |
| | 1 um/0.45 um/10 um Filter + | 277 | 0:28 | 65 |
| | Collection Pad | | | |

[symbol]

indicates data missing or illegible when filed

TABLE 10
Exemplary Lysis buffer formulations

SDS Buffer
SDS (1%)
Tris-HCl (50 mM)
EDTA (10 mM)
RIPA Buffer
Tris-HCl (25 mM)
NaCl (150 mM)
IGEPAL (1%)
Sodium deoxycholate (0.5%)
SDS (0.1%)
Digitonin Buffer
NaCl (150 mM)
Tris-HCl (50 mM)
Digitonin (25 ug/ml)
Saliva Stabilization Solution
EDTA (2 mM)
TCEP-HCl (5 mM)
Sodium hydroxide (29 mM)
Proteinase K (100 μg/ml)
Mix #1
Guanidine Hydrochloride (100 mM)
TCEP-HCl (5 mM)
NEB RNase inhibitor, murine (4 U/μl)
Mix #2
Guanidine Hydrochloride (100 mM)
TCEP-HCl (5 mM)
Triton X-100 (5%)
Tween20 (5%)
NEB RNase inhibitor, murine (4 U/μl)
Buffer #5
Tris-HCl (10 mM)
EDTA (1 mM)
Triton X-100 (1%)
Buffer #6
TCEP-HCl (5 mM)
EDTA (2 mM)
NaOH (29 mM)
Buffer #7
TCEP-HCl (12.5 mM)
EDTA (2 mM)
NaOH (29 mM)
Buffer #10
Guanidine hydrochloride (100 mM)
TCEP-HCl (5 mM)
Tween20 (5%)
Triton X-100 (5%)
NEB RNase inhibitor, murine (4 U/μl)
Buffer #11
Guanidine hydrochloride (100 mM)
TCEP-HCl (5 mM)
Tween20 (10%)
NEB RNase inhibitor, murine (4 U/μl)
Buffer #19
Hydrochloric acid (5 mM)
Tween20 (10%)
Buffer #20
Guanidine Hydrochloride (100 mM)
TCEP-HCl (5 mM)
Tween20 (7.5%)
Digitonin (0.0016%)
NEB RNase inhibitor, murine (4 U/μl)

### Preserved Embodiments

The present invention further includes the following additional preserved embodiments:
1. A nucleic acid amplification device comprising:
   a collection pad adapted to collect a sample;
   a lysis pad positioned in fluid communication with said collection pad containing a quantity of lyophilized buffer adapted to lyse cells in said sample;
   a filter stack in fluid communication with said lysis pad;
   a reservoir for receiving the sample from said filter stack;
   one or more transfer pads adapted to transmit the sample to an amplification pad containing lyophilized reagents necessary for isothermal amplification of nucleic acids present in the sample; and
   a lateral flow strip adapted to receive amplification products from said amplification pad.
2. The device of embodiment 1, wherein said sample comprises a biological sample.
3. The device of embodiment 2, wherein said biological sample is a saliva sample.
4. The device of embodiment 3, wherein said collection pad is secured to a collection handle.
5. The device of embodiment 1, wherein said lysis pad is secured within a barrel and in fluid communication with an amplification assembly securing said one or more transfer pads and said amplification pad.
6. The device of embodiment 1, wherein said filter stack comprises a column portion containing an agent, such as a chelating agent configured to inhibit divalent cations and positively charged molecules positioned between a first and second filter, and optionally a third filter positioned below said second filter.
7. The device of embodiment 6, wherein said second filter has a smaller filter size than said first filter, and optionally said third filter has a smaller filter size than said second filter.
8. The device of embodiment 6, wherein said chelating agent comprises Chelex-100.
9. The device of embodiment 1, wherein said reservoir is positioned within a baseplate.
10. The device of embodiment 9, wherein said baseplate further comprises one or more pressure relief positions.
11. The device of embodiment 1, wherein the lyophilized reaction buffer and enzymes for isothermal amplification are positioned on the distal portion of said amplification pad.
12. The device of embodiment 1, wherein said one or more transfer pads and said amplification pad are sufficiently porous to form a front of lysed sample along the processing path toward the lateral flow strip.
13. The device of embodiment 1, wherein said sample in said reservoir generates sufficient capillary action to transfer amplification products from said amplification pad to said lateral flow strip.
14. The device of embodiment 1, further comprising a strip cover securing said lateral flow strip.
15. The device of embodiment 14, wherein said strip cover is secured to a housing that is optionally positioned over said barrel and adapted to receive said collection handle.
16. The device of embodiment 15, wherein said housing comprises a locking position.
17. The device of embodiment 1, wherein said lyophilized reagents comprises reagents for RT-RPA.
18. The device of embodiment 17, wherein said reagents for RT-RPA comprises reagents having one or more additional excipients and/or RNase inhibitors.
19. The device of embodiment 1, wherein said nucleic acids present in said sample are selected from: RNA, DNA, and/or one or more RNA biomarkers of infection.
20. A diagnostic device filter comprising:
   a nucleic acid amplification device having a filter stack further comprising a column portion containing a chelating agent configured to inhibit divalent cations and positively charged molecules positioned between a first and second filter, and optionally a third filter positioned below said second filter; and
   wherein a sample passes through said filter stack prior to amplification of the nucleic acids present in the sample.
21. The device filter of embodiment 20, wherein said sample comprises a biological sample.
22. The device filter of embodiment 20, wherein said sample comprises a biological sample having cells that are lysed prior to passing through said filter stack.
23. The device filter of embodiment 20, wherein said second filter has a smaller filter size than said first filter, and said optional third filter has a smaller filter size than said second filter.
24. The device filter of embodiment 20, wherein said chelating agent comprises Chelex-100.
25. The device filter of embodiment 20, wherein said first filter has a filter size of approximately 10 μM.
26. The device filter of embodiment 20, wherein said second filter has a filter size of approximately 1 μM.
27. The device filter of embodiment 20, wherein said nucleic acids present in said are selected from: RNA, DNA, and/or one or more RNA biomarkers of infection.
28. The device filter of embodiment 20, wherein said optional third filter has a filter size of approximately 0.4 μM.
29. The device filter of embodiment 20, wherein said isothermal amplification comprises RT-RPA.
30. The device filter of embodiment 20, wherein said filter stack is in fluid communication with an amplification pad containing lyophilized reagents necessary for oligonucleotide amplification.
31. The device filter of embodiment 30, wherein said lyophilized reaction buffer and enzymes for oligonucleotide amplification are positioned on the distal portion of said amplification pad
32. The device filter of embodiment 30, wherein said filter stack is in fluid communication with an amplification pad through one or more transfer pads.
33. The device filter of embodiment 30, wherein said amplification pad is in fluid communication with a lateral flow strip adapted to receive the amplification products from said amplification pad.
34. The device filter of embodiment 30, wherein said sample passes through a lysis pad prior to contacting said filter stack.
35. An isothermal amplification device comprising:
   an amplification pad adapted to receive a sample containing lyophilized reagents necessary for isothermal amplification of one or more nucleic acids present in the sample; and
   a lateral flow strip adapted to receive the amplification products from said amplification pad.
36. The device of embodiment 35, wherein said sample comprises a biological sample.
37. The device of embodiment 35, wherein the lyophilized reaction buffer and enzymes for isothermal amplification are positioned on the distal portion of said amplification pad.
38. The device of embodiment 35, wherein said isothermal amplification comprises RT-RPA.
39. The device of embodiment 35, further comprising one or more transfer pads adapted to transmit the sample to the amplification pad containing lyophilized reagents necessary for isothermal amplification of one or more biomarkers.
40. The device of embodiment 39, wherein said one or more transfer pads and said amplification pad are sufficiently porous to form a front of the sample to be processed along the processing path toward the lateral flow strip.
41. The device of embodiment 35, further comprising a reservoir to accept said sample wherein said reservoir generates sufficient capillary action to transfer amplification products from said amplification pad to said lateral flow strip.
42. The device of embodiment 35, wherein said nucleic acids present in said sample are selected from: RNA, DNA, and RNA biomarkers of infection.
43. The device of embodiment 35, further comprising a lysis pad containing a quantity of lyophilized buffer adapted to lyse cells in said sample.
44. The device of embodiment 35, further comprising a filter stack in fluid communication with said lysis pad.
45. The device of embodiment 44, wherein said filter stack comprises a column portion containing a chelating agent configured to inhibit divalent cations and positively charged molecules positioned between a first and second filter, and optionally a third filter.
46. The device of embodiment 45, wherein cell in said sample are lysed prior to passing through said filter stack.
47. The device of embodiment 45, wherein said second filter has a smaller filter size than said first filter, and said optional third filter has a smaller filter size than said second filter.
48. The device of embodiment 45, wherein said chelating agent comprises Chelex-100.
49. The device of embodiment 45, wherein said first filter has a filter size of approximately 10 μM.
50. The device of embodiment 45, wherein said second filter has a filter size of approximately 1 μM.
51. The device of embodiment 45, wherein said optional third filter has a filter size of approximately 0.4 μM.
52. A system for nucleic acid amplification comprising:
   a sample containing a quantity of nucleic acids;
   a filter;
   a reaction chamber and/or amplification pad containing reagents necessary for amplification of said nucleic acids present in said sample; and
   a lateral flow strip adapted to receive amplification products from said amplification pad.
53. The system of embodiment 52, wherein said sample comprises a biological sample.
54. The system of embodiment 53, wherein said biological sample is a saliva sample.
55. The system of embodiment 54, wherein said filter comprises filter stack having a column portion containing an agent, such as a chelating agent configured to inhibit divalent cations and positively charged molecules positioned between a first and second filter, and optionally a third filter positioned below said second filter.
56. The system of embodiment 55, wherein said second filter has a smaller filter size than said first filter, and optionally said third filter has a smaller filter size than said second filter.
57. The system of embodiment 55, and further comprising a third filter positioned below said second filter.
58. The system of embodiment 55, wherein said chelating agent comprises Chelex-100.
59. The system of embodiment 52, a reservoir for receiving the sample;
60. The system of embodiment 59, wherein said reservoir is responsive to one or more pressure relief positions.
61. The system of embodiment 60, wherein said reagents comprise reagents necessary for isothermal amplification.
62. The system of embodiment 61, reagents necessary for isothermal amplification are lyophilized.
63. The system of embodiment 62, wherein the lyophilized reagents for isothermal amplification are positioned on the distal portion of said amplification pad.
64. The system of embodiment 53, further comprising a lysis pad containing a quantity of lyophilized buffer adapted to lyse cells in said biological sample.
65. The system of embodiment 64, wherein said buffer is lyophilized.
66. The system of embodiment 52, further comprising one or more transfer pads adapted to transmit the sample to reaction chamber and/or amplification pad.
67. The system of embodiment 64, wherein said one or more transfer pads and the amplification pad are sufficiently porous to form a front of lysed sample along the processing path toward the lateral flow strip.
68. The system of embodiment 59, wherein said sample in said reservoir generates sufficient capillary action to transfer amplification products from said amplification pad to said lateral flow strip.
69. The system of embodiment 52, further comprising a strip cover securing said lateral flow strip.
70. The system of embodiment 52, wherein said strip cover is secured to a housing.
71. The system of embodiment 52, wherein said reagents comprises reagents for RT-RPA.
72. The system of embodiment 72, wherein said reagents for RT-RPA comprise lyophilized reagents for RT-RPA.
73. The system of embodiment 72, wherein said lyophilized reagents for RT-RPA comprises lyophilized reagents having one or more additional excipients and/or RNase inhibitors.
74. The system of any of embodiments 1, 35 or 52, further comprising a removable barrier between said reaction chamber and/or amplification pad and said lateral flow strip.
75. The system of embodiment 74, wherein said removable barrier comprises a pull tab configured to separate said reaction chamber and/or amplification pad and said lateral flow strip, and wherein removal of said pull tab allow transfer of amplification products from said reaction chamber and/or amplification pad and said lateral flow strip.

1. A nucleic acid amplification device comprising:
a collection handle configured to collect a sample containing a nucleic acid;
a sample processing assembly in fluid communication with an amplification assembly;
a heater assembly thermally coupled to the amplification assembly and responsive to a heater activation assembly; and
a lateral flow assay configured to receive amplification products from amplification assembly

2-3. (canceled)

4. The device of claim 1, wherein said biological sample comprises a biological specimen.

5. The device of claim 1, wherein said sample processing assembly comprises a processing chamber that receives the collection handle and further securing one or both of:
a lysis pad; and
one or more filters.

6. The device of claim 1, wherein said amplification assembly comprises a transfer pad adapted to transmit the sample to an amplification pad containing lyophilized reagents necessary for amplification of nucleic acids present in the sample.

7. (canceled)

8. The device of claim 6, wherein said lyophilized reagents comprises reagents for an amplification reaction selected from: Reverse-Transcription Recombinase Polymerase Amplification (RT-RPA); Recombinase polymerase amplification (RPA); nucleic acid sequence-based amplification (NASBA), loop-mediated isothermal amplification (LAMP); Reverse transcription loop-mediated isothermal amplification (RT-LAMP); strand displacement amplification (SDA); helicase-dependent amplification (HDA); nicking enzyme amplification reaction (NEAR); signal mediated amplification of RNA technology (SMART); rolling circle amplification (RCA); isothermal multiple displacement amplification (EVIDA); single primer isothermal amplification (SPIA); and polymerase spiral reaction (PSR).

9. The device of claim 8, wherein the reagents comprises reagents having one or more additional excipients, RNase or DNase inhibitors.

10. The device of claim 6, wherein the nucleic acids present in said sample are selected from: RNA, DNA, one or more RNA biomarkers of infection, or a combination of the same.

11. The device of claim 6, wherein said transfer pad is embedded with a quantity of magnesium acetate (MgOAc), or Magnesium (Mg).

12. The device of claim 1, wherein said heater assembly comprises an internal housing containing a phase change material responsive to an exothermal fuel.

13. The device of claim 12, wherein said exothermal fuel comprises Mg—Fe alloy.

14. The device of claim 12, wherein said heater activation assembly comprises an exothermic reagent configured to activate the exothermal fuel causing the phase change material to reach a pre-determined temperature thereby heating the amplification pad.

15. The device of claim 14, wherein said phase change material comprises a paraffin.

16. The device of claim 14, wherein said phase change material is selected from the group consisting of: a metal, an inorganic compound, an inorganic eutectic and an organic compound.

17. The device of claim 14, wherein said exothermic reagent is positioned within a reagent syringe and separated from the heater assembly by an exothermic reagent seal.

18. The device of claim 14, wherein said exothermic reagent comprises a salt solution.

19. The device of claim 1, further comprising an amplicon seal separating the amplification assembly and the lateral flow assay.

20. The device of claim 19, wherein said assay transfer pad is in fluid communication with a lateral flow strip such that capillary action transfers the amplification products from said assay transfer pad to said lateral flow strip.

21. The device of claim 5, wherein said filter comprises a column portion containing a chelating agent configured to inhibit divalent cations and positively charged molecules positioned between a first and second filter, and optionally a third filter positioned below said second filter.

22-24. (canceled)

25. A nucleic acid amplification and detection device comprising:
a collection handle configured to collect a nucleic acid sample;
a sample processing assembly in fluid communication with an amplification assembly, wherein the nucleic acid sample is introduced to the sample processing assembly and the amplification assembly through a first action of the collection handle;
a heater assembly thermally coupled to the amplification assembly and responsive to a heater activation assembly, wherein the heater activation assembly activates the heater assembly in response to the first action of the collection handle; and
a lateral flow assay configured to receive amplification products from the amplification assembly in response to a second action of a collection handle.

26-53. (canceled)

54. A device for the sequential amplification and detection of nucleic acids comprising:
a collection handle containing a nucleic acid sample, wherein a first action of the handle causes the sample to be delivered to a processing chamber containing one or both of:
a lysis pad;
one or more filters;
a transfer pad in fluid communication with the processing chamber that transmits the sample to an amplification pad containing lyophilized reagents necessary for amplification of nucleic acids present in the sample;
a reaction housing containing a heater assembly thermal coupled to the amplification pad;
a heater activation assembly comprising an exothermic reagent positioned within a reagent syringe and separated from the heater assembly by a reagent seal, wherein said exothermic reagent is released in response to the first action of the collection handle thereby activating the heater assembly; and
a lateral flow assay separated from the amplification pad by an amplicon seal, and adapted to receive amplification products from said amplification pad in response to the second action of the collection handle.

55-96. (canceled)
